(19) United States
(12) Patent Application Publication
(10) Pub. No.: US 2026/0072384 A1
(43) Pub. Date: Mar. 12, 2026

(54) IMAGE FORMING APPARATUS

(71) Applicant: CANON KABUSHIKI KAISHA, Tokyo (JP)

(72) Inventors: KOJI AN, Saitama (JP); TSUGUHIRO YOSHIDA, Kanagawa (JP); KOHEI WAKATSU, Kanagawa (JP); KEISUKE ISHIZUMI, Kanagawa (JP); SHOHEI ISHIO, Tokyo (JP); KAZUHIRO DODA, Kanagawa (JP); SHINJI KATAGIRI, Kanagawa (JP); YASUHISA MATSUMOTO, Shizuoka (JP); SHUNSUKE MIZUKOSHI, Tokyo (JP)

(21) Appl. No.: 19/323,669

(22) Filed: Sep. 9, 2025

(30) Foreign Application Priority Data
Sep. 11, 2024 (JP) 2024-157475
Sep. 11, 2024 (JP) 2024-157547

(51) Int. Cl. G03G 15/00; G03G 15/01; G03G 15/043; G03G 15/06; G03G 15/08; G03G 15/16; G03G 21/02; G03G 21/06; G03G 21/18

(52) U.S. Cl. CPC G03G 15/5004; G03G 15/011; G03G 15/0121; G03G 15/0126; G03G 15/0131; G03G 15/0189; G03G 15/043; G03G 15/065; G03G 15/0808; G03G 15/0812; G03G 15/0848; G03G 15/161; G03G 15/1675; G03G 15/5012; G03G 15/556; G03G 21/02; G03G 21/06; G03G 21/1889

(57) ABSTRACT

The control portion of an image forming apparatus capable of executing, i) a first process in which a first region forms a transfer portion in a state where a transfer voltage is applied such that a first potential difference is formed, ii) a second process in which the first region forms a developing portion in a state where a developing voltage is applied such that a second potential difference is formed, and iii) a third process in which the first region forms the transfer portion in a state where the transfer voltage is applied such that a third potential difference is formed. The control portion controls a potential difference formed between the photosensitive drum and the developing member such that an absolute value of the second potential difference is greater than an absolute value of a fourth potential difference in the image forming operation.

### BACKGROUND

### Field of the Technology

The present disclosure relates to an image forming apparatus that forms an image on a recording material.

### Description of the Related Art

In the related art, an image forming apparatus with a configuration including a developing device that accommodates a toner therein and an intermediate transfer member is known as an image forming apparatus such as a copy machine or a laser beam printer. If images with low printing rates are continuously output, for example, in such an image forming apparatus, there is a concern that a state where the toner inside the developing device may be hardly consumed continues, and the toner inside the developing device may be degraded, which may lead to degradation of image quality and the like.

Japanese Patent Application Laid-Open No. 2006-023327 and Japanese Patent Application Laid-Open No. 2000-310909 disclose image forming apparatuses capable of executing an operation of ejecting (forcedly consuming) degraded toner inside developing devices separately from an image forming operation.

However, with the aforementioned configuration, a fresh toner that has not significantly been degraded yet is also ejected in addition to the degraded toner in the toner ejecting operation. In other words, since a toner that can be used without any problems in the image forming operation is forcedly discharged, the amount of toner consumption increases, and the lifetimes of the developing device and a cartridge of the developing device are shortened. Furthermore, since waste toner accommodating containers that accommodate the discharged toner become full quickly, the frequency of replacement of the waste toner accommodating containers increases.

### SUMMARY

Present disclosure is directed to suppress the amount of toner consumption in an image forming apparatus that executes a toner supplying operation.

According to some embodiments, an image forming apparatus of the present disclosure is characterized by features including:
a rotatable photosensitive drum;
a charging member that charges a surface of the photosensitive drum;
a developing member that comes into contact with the photosensitive drum to form a developing portion and supplies, by the developing portion, a toner charged with a normal polarity to the surface of the photosensitive drum charged by the charging member;
a developing voltage application portion that applies a developing voltage to the developing member;
an intermediate transfer member that comes into contact with the photosensitive drum to form a transfer portion, the toner supplied to the surface of the photosensitive drum being transferred to the intermediate transfer member by the transfer portion;
a transfer voltage application portion that applies a transfer voltage to the intermediate transfer member; and
a control portion that performs control to be able to execute i) an image forming operation of forming an image on a recording material and ii) a toner supplying operation of supplying the toner from the developing member to the surface of the photosensitive drum, the toner supplying operation being an operation different from the image forming operation,
wherein in the toner supplying operation, a region on the photosensitive drum to which the toner is supplied from the developing member is defined as a first region,
wherein the control portion performs control to execute, by the photosensitive drum being rotated in the toner supplying operation,
i) a first process in which the first region forms the transfer portion in a state where the transfer voltage is applied such that a first potential difference is formed between the intermediate transfer member and the photosensitive drum, the first potential difference is a potential difference in a direction in which an electrostatic force in a direction from the intermediate transfer member to the photosensitive drum acts on the toner charged with the normal polarity at the transfer portion,
ii) a second process in which the first region forms the developing portion in a state where the developing voltage is applied such that a second potential difference is formed between the photosensitive drum and the developing member, after the first process, the second potential difference is a potential difference in a direction in which an electrostatic force in a direction from the photosensitive drum to the developing member acts on the toner charged with the normal polarity at the developing portion, and
iii) a third process in which the first region forms the transfer portion in a state where the transfer voltage is applied such that a third potential difference is formed between the photosensitive drum and the intermediate transfer member, after the second process, the third potential difference is a potential difference in a direction in which an electrostatic force in a direction from the photosensitive drum to the intermediate transfer member acts on the toner charged with the normal polarity at the transfer portion,
wherein in the image forming operation, a potential difference in a direction in which an electrostatic force in a direction from the photosensitive drum to the developing member acts on the toner charged with the normal polarity at the developing portion, which is a potential difference formed between the photosensitive drum and the developing member, is defined as a fourth potential difference, and
wherein the control portion performs control such that an absolute value of the second potential difference is greater than an absolute value of the fourth potential difference.

Also, according to some embodiments, an image forming apparatus of the present disclosure is characterized by features including:
a rotatable photosensitive drum;
a charging member that charges a surface of the photosensitive drum;
a charging voltage application portion that applies a charging voltage to the charging member;
an exposure device that exposes the surface of the photosensitive drum and forms an electrostatic latent image thereon;
a developing member that comes into contact with the photosensitive drum to form a developing portion and supplies, by the developing portion, a toner charged with a normal polarity to the surface of the photosensitive drum charged by the charging member;
a developing voltage application portion that applies a developing voltage to the developing member;
an intermediate transfer member that comes into contact with the photosensitive drum to form a transfer portion, the toner supplied to the surface of the photosensitive drum being transferred to the intermediate transfer member by the transfer portion;
a transfer member that comes into contact with the intermediate transfer member;
a transfer voltage application portion that applies a transfer voltage to the transfer member; and
a control portion that controls the charging voltage, an amount of exposure of the exposure device, the developing voltage, and the transfer voltage, the control portion being configured to be able to execute i) an image forming operation of forming an image on a recording material, and ii) a toner supplying operation in which toner is supplied from the developing member to the photosensitive drum such that, when a first region of the photosensitive drum to which toner has been supplied passes through a transfer portion, which is an abutting portion between the photosensitive drum and the intermediate transfer member, for a first time, a part of the toner supplied is moved to the intermediate transfer member, another part of the toner remains in the first region, and, when the residual toner passes through the transfer portion again, the residual toner is moved to the intermediate transfer member.

Also, according to some embodiments, an image forming apparatus of the present disclosure is characterized by features including:
a photosensitive drum;
a charging member that charges a surface of the photosensitive drum;
an exposure device that exposes the surface of the photosensitive drum and forms an electrostatic latent image thereon;
a developing member that comes into contact with the photosensitive drum to form a developing portion and supplies, by the developing portion, a toner charged with a normal polarity to the surface of the photosensitive drum charged by the charging member;
an intermediate transfer member that comes into contact with the photosensitive drum to form a transfer portion, the toner supplied to the surface of the photosensitive drum being transferred to the intermediate transfer member by the transfer portion;
a control portion that controls a surface potential of the photosensitive drum, the control portion being configured to be able to execute i) an image forming operation of transferring a toner image from the photosensitive drum to the intermediate transfer member and ii) a toner supplying operation of supplying a toner from the developing member to the photosensitive drum, collecting a part of the supplied toner by the developing member, and moving a part of the toner to the intermediate transfer member; and
a consumption amount acquisition portion being configured to be able to acquire an amount of consumed toner in the toner supplying operation on the basis of a value related to an amount of toner supplied from the developing member to the photosensitive drum in the toner supplying operation and a correction coefficient related to an amount of toner collected by the developing member in the toner supplying operation.

According to the present disclosure, it is possible to suppress the amount of toner consumption in an image forming apparatus that executes a toner supplying operation.

Features of the present disclosure will become apparent from the following description of embodiments with reference to the attached drawings. The following description of embodiments is described by way of example.

### BRIEF DESCRIPTION OF THE DRAWINGS

FIGS. 1A to 1F are explanatory diagrams of ejection control according to Example 1, where FIG. 1A is a diagram illustrating a state of a toner ejection process inside a developing unit, FIG. 1B is a diagram illustrating a primary transfer portion passing process of an ejected toner, FIG. 1C is a diagram illustrating an ejected toner charging portion passing process, FIG. 1D is a diagram illustrating a toner sorting process in a developing portion, FIG. 1E is a diagram illustrating a transfer process of a degraded toner, and FIG. 1F is a diagram illustrating a state of a cleaning process of the degraded toner;

FIG. 2 is a schematic sectional view of an overview configuration of an image forming apparatus according to Example 1;

FIG. 3 is an explanatory diagram of a configuration of an engine control portion according to Example 1;

FIG. 4 is an explanatory diagram of weak exposure control according to Example 1;

FIG. 5 is a schematic diagram illustrating an overview configuration of a developing device according to Example 1;

FIG. 6 is a diagram illustrating a configuration example of a toner including a projecting portion;

FIGS. 7A to 7D are explanatory diagrams of a method of collecting transfer residual toner according to Example 1, where FIG. 7A is a schematic diagram of a potential relationship when the toner is developed, FIG. 7B is a schematic diagram in the vicinity of the developing portion when the toner is developed, FIG. 7C is a schematic diagram of a potential relationship at the time of development collection, and FIG. 7D is a schematic diagram in the vicinity of the developing portion at the time of development collection;

FIG. 8 is an explanatory diagram of voltage and potential control in ejection control according to Example 1;

FIGS. 9A and 9B are explanatory diagrams of solid ejection control according to Comparative Example 2, where FIG. 9A is a diagram illustrating a toner ejection process, and FIG. 9B is a diagram illustrating a transfer process of an ejected toner;

FIG. 10 is an explanatory diagram of voltage and potential control in degraded solid ejection control according to Comparative Example 2;

FIG. 11 is a schematic sectional view of an overview configuration of an image forming apparatus according to Example 2;

FIG. 12 is a schematic diagram illustrating an overview configuration of a pre-charging exposure device according to Example 2;

FIG. 13 is an explanatory diagram of voltage and potential control in ejection control according to Example 2;

FIG. 14 is an explanatory diagram of a charge quantity distribution of a fogging toner;

FIG. 15 is an explanatory diagram of back contrast dependency of the fogging toner;

FIGS. 16A to 16E are explanatory diagrams of first fogging ejection control according to Example 3, where FIG. 16A is a diagram illustrating a state of an ejection process of a fogging toner in a developing unit, FIG. 16B is a diagram illustrating a state of a polarity separation process of the fogging toner at a primary transfer portion, FIG. 16C is a diagram illustrating a state of a charging portion passing process of a negative polarity fogging toner, FIG. 16D is a diagram illustrating a state of a transfer process of the negative polarity fogging toner, and FIG. 16E is a diagram illustrating a state of a cleaning process of the fogging toner;

FIG. 17 is an explanatory diagram of voltage and potential control in first fogging ejection control according to Example 3;

FIGS. 18A to 18F are explanatory diagrams of first fogging ejection control according to Example 4, where FIG. 18A is a diagram illustrating an ejection process of a fogging toner in a developing unit, FIG. 18B is a diagram illustrating a state of polarity separation process of the fogging toner at a primary transfer portion, FIG. 18C is a diagram illustrating a state of a charging roller capturing process of a positive polarity fogging toner, FIG. 18D is a diagram illustrating a state of a charging roller ejection process of the positive polarity fogging toner, FIG. 18E is a diagram illustrating a state of a transfer process of the positive polarity fogging toner, and FIG. 18F is a diagram illustrating a state of a cleaning process of the fogging toner;

FIG. 19 is an explanatory diagram of voltage and potential control in first fogging ejection control according to Example 4;

FIG. 20 is an explanatory diagram of voltage and potential control in first fogging ejection control according to Modification 1;

FIGS. 21A and 21B are explanatory diagrams of other configuration examples according to Example 4, where FIG. 21A is a diagram illustrating a configuration in which an urethane sponge roller is disposed as a temporary capturing member, and FIG. 21B is a diagram illustrating a configuration in which a brush-shaped capturing member 28 is disposed as a temporary capturing member;

FIGS. 22A to 22D are explanatory diagrams of later rotation control according to Example 11, where FIG. 22A is a diagram illustrating a state of a transfer process of a degraded toner, FIG. 22B is a diagram illustrating a state of a recharging process of an ejection transfer residual toner, FIG. 22C is a diagram illustrating a state of a transfer process of the ejection transfer residual toner, and FIG. 22D is a diagram illustrating a state of a cleaning process of a degraded toner;

FIG. 23 is an explanatory diagram of voltage and potential control in the later rotation control according to Example 11;

FIG. 24 is an explanatory diagram of voltage and potential control in the later rotation control according to Example 12;

FIGS. 25A and 25B are explanatory diagrams of an example in which a transfer contrast is individually adjusted, where FIG. 25A is a diagram illustrating a voltage control example of a station where ejection control is performed, and FIG. 25B is a diagram illustrating a voltage control example of a station where the ejection control is not performed;

FIGS. 26A and 26B are explanatory diagrams of a method of dividing a sheet region according to Example 13, where FIG. 26A is a diagram illustrating a division example of a sheet region (A4 sheet region) in a case where an A4 sheet is used, and FIG. 26B is a diagram illustrating an example in which an image is formed in the A4 sheet region in the division example of FIG. 26A;

FIG. 27 is an explanatory diagram of the number of fed sheets, a printing rate, and a degraded toner proportion according to Example 13;

FIGS. 28A to 28C are explanatory diagrams of ejection control according to Example 13, where FIG. 28A is a diagram illustrating a relationship between an average printing rate and a density of a toner ejection pattern, FIG. 28B is a diagram illustrating an average printing rate in three equally divided regions, and FIG. 28C is a diagram illustrating a toner ejection pattern determined on the basis of the average printing rate of the example illustrated in FIG. 28B;

FIG. 29 is a diagram illustrating a flowchart of pre-ejection control according to Example 14;

FIG. 30 is an explanatory diagram of a method of setting an execution interval of ejection control according to Example 14;

FIG. 31 is an explanatory diagram of a relationship between the execution interval of the ejection control and an aspect ratio;

FIG. 32 is an explanatory diagram of a method of setting an execution interval of ejection control according to Modification 7;

FIG. 33 is diagram illustrating a flowchart of a pre-ejection control according to Modification 8;

FIG. 34 is a diagram illustrating a flowchart of a pre-ejection control in control according to Example 14;

FIG. 35 is an explanatory diagram of a relationship between a cartridge lifetime and a transfer voltage according to Modification 9;

FIG. 36 is a schematic sectional view illustrating an overview configuration of a printer engine of Example 15;

FIG. 37 is a schematic sectional view illustrating an overview configuration of a developing unit according to Example 15;

FIG. 38 is an explanatory diagram of a hardware configuration according to Example 15;

FIG. 39 is an explanatory diagram of a configuration of an engine control portion according to Example 15;

FIG. 40 is an explanatory diagram of weak exposure control in an image forming process according to Example 15;

FIGS. 41A to 41D are explanatory diagrams of a method of collecting a transfer residual toner according to Example 15, where FIG. 41A is a schematic diagram of a potential relationship when the toner is developed, FIG. 41B is a schematic diagram in the vicinity of a developing portion when the toner is developed, FIG. 41C is a schematic diagram of a potential relationship at the time of development collection, and FIG. 41D is a schematic diagram in the vicinity of the developing portion at the time of development collection;

FIGS. 42A to 42F are explanatory diagrams of a degraded toner ejection operation according to Example 15, where FIG. 42A is a diagram illustrating a state of an ejection process of a toner in a developing unit, FIG. 42B is a diagram illustrating a primary transfer portion passing process of an ejected toner, FIG. 42C is a diagram illustrating an ejected toner charging portion passing process, FIG. 42D is a diagram illustrating a toner sorting process at the developing portion, FIG. 42E is a diagram illustrating a transfer process of a degraded toner, and FIG. 42F is a diagram illustrating a cleaning process of the degraded toner;

FIG. 43 is an explanatory diagram of voltage and potential control in degraded toner ejection control according to Example 15;

FIG. 44 is a flowchart illustrating a control flow according to Example 15; and

FIG. 45 is an explanatory diagram of a configuration of an engine control portion according to Example 16.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

### Example 1

Hereinafter, an image forming apparatus according to Example 1 to which the present disclosure can be applied will be described. In the following description, a case where the present disclosure is applied to an image forming apparatus of an electrophotographic image forming scheme of forming an image on a recording medium using an electrophotographic image forming process will be described. Examples of the image forming apparatus of the electrophotographic image forming scheme include an electrophotographic copy machine, an electrophotographic printer (such as an LED printer or a laser beam printer), and an electrophotographic facsimile apparatus.

### Image Forming Apparatus

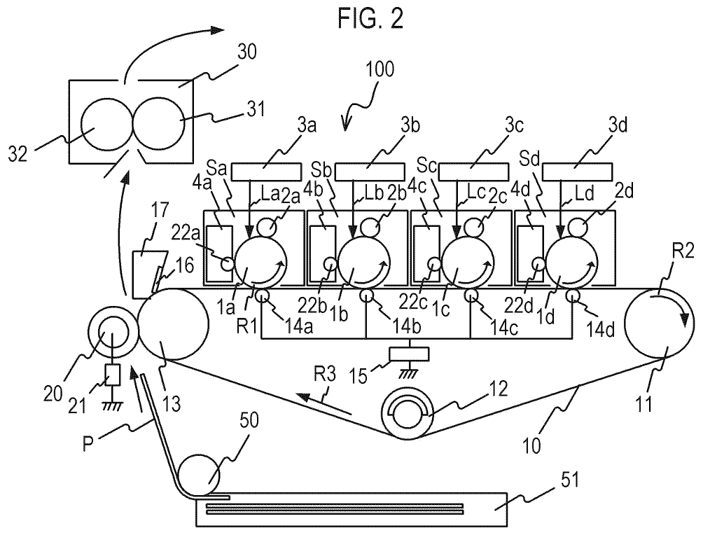

First, an overall configuration of an electrophotographic image forming apparatus (hereinafter, an image forming apparatus) according to the present disclosure will be described. A configuration, operations, and control of an image forming apparatus 100 of this example will be described using FIG. 2. FIG. 2 is a schematic sectional view illustrating an overview configuration of the image forming apparatus 100 of Example 1.

The image forming apparatus 100 of this example is a full-color laser printer that employs an inline scheme and an intermediate transfer scheme.

The image forming apparatus 100 can form a full-color image on a recording material P (for example, a recording sheet or a plastic sheet) in accordance with image information. The image information is input to the image forming apparatus 100 from an image reading apparatus or a host computer such as a personal computer communicably connected to the image forming apparatus 100.

The image forming apparatus 100 includes a plurality of image forming portions for forming images of yellow (Y), magenta (M), cyan (C), and black (K) colors. Furthermore, the image forming apparatus 100 includes first, second, third, and fourth process cartridges Sa, Sb, Sc, and Sd as cartridges constituting the image forming portions, respectively. In this example, the first to fourth process cartridges Sa, Sb, Sc, and Sd are disposed in one line in a direction intersecting the vertical direction. Note that in this example, the configurations and operations of the first to fourth process cartridges Sa, Sb, Sc, and Sd are substantially the same other than that colors of the images to be formed are different. Therefore, in a case where no special distinction is needed, the indexes a, b, c, and d attached to the reference signs to represent that the elements are provided for some of the colors will be omitted, and comprehensive description will be given below.

In this example, the image forming apparatus 100 includes, as a plurality of image bearing members, four drum-type electrophotographic photoreceptors, that is, four photosensitive drums 1 (1a, 1b, 1c, and 1d) aligned in a direction intersecting the vertical direction. The photosensitive drums 1 are rotationally driven by a photosensitive drum drive source 406 which is a driving mechanism. Charging rollers 2 (2a, 2b, 2c, and 2d), scanner units (exposure devices) 3 (3a, 3b, 3c, and 3d), and developing units (developing devices) 4 (4a, 4b, 4c, and 4d) are disposed around the photosensitive drums 1.

The charging rollers 2 are charging mechanisms (charging members) for uniformly charging the surfaces of the photosensitive drums 1. The scanner units 3 are exposure mechanisms (exposure devices) for forming electrostatic images (electrostatic latent images) on the photosensitive drums 1 by emitting laser beams on the basis of an output calculated by a CPU 207 from image information input from a host computer such as a personal computer. When the exposure mechanisms form electrostatic latent images in accordance with an image signal, the potential of the photosensitive drums are stabilized by uniformly and weakly exposing non-image regions on the surfaces of the photosensitive drums 1. Hereinafter, formation of electrostatic images by the exposure mechanisms will be distinguished as exposure, and uniform exposure of non-image regions will be distinguished as weak exposure. The developing units 4 are developing mechanisms (developing devices) that include developing rollers 22 as developing members and develop electrostatic images as developer (hereinafter, toner) images.

The photosensitive drums 1, the charging rollers 2 as process mechanisms acting on the photosensitive drums 1, and the developing units 4 are integrated to form process cartridges S. The process cartridges S are cartridges that are attachable to and detachable from the image forming apparatus 100 via attachment mechanisms such as attachment guides or positioning members provided in the image forming apparatus 100.

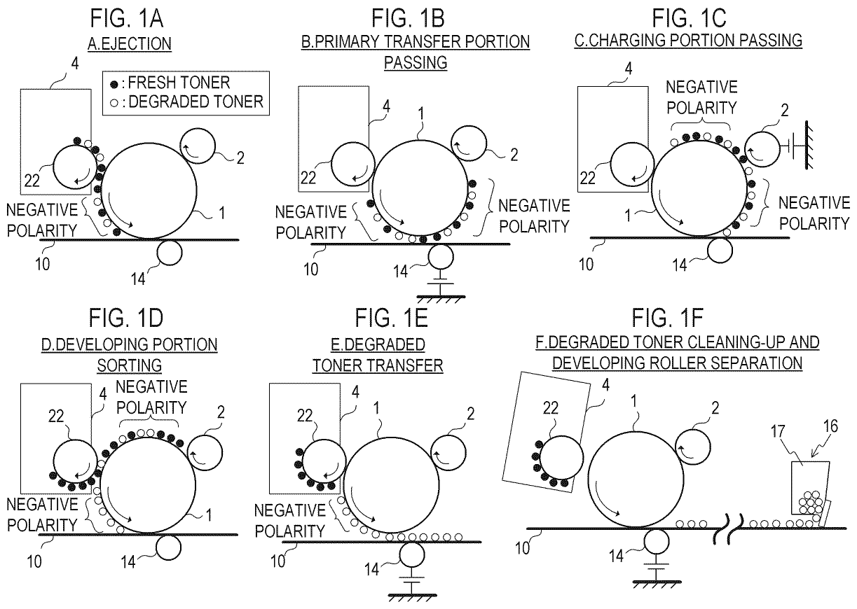

An intermediate transfer belt 10 as an intermediate transfer member for transferring toner images on the photosensitive drums 1 to a recording material P is disposed to face the four photosensitive drums 1. The intermediate transfer belt 10 formed of an endless belt abuts on all the photosensitive drums 1 and is circulated (rotated) in the direction of the arrow R3 (clockwise direction) in FIG. 2. The intermediate transfer belt 10 is stretched over, as a plurality of support members, a drive roller 11, a tension roller 12, and a secondary transfer counter roller 13. The drive roller 11 is a rotation drive member that drives and rotates the intermediate transfer belt 10 in the direction of the arrow R3 by rotating in the direction of the arrow R2 (clockwise direction) in FIG. 1.

On the side of the inner peripheral surface of the intermediate transfer belt 10, four primary transfer rollers 14 (14a, 14b, 14c, and 14d) as primary transfer mechanisms are aligned to face the photosensitive drums 1, respectively. The primary transfer rollers 14 are (primary) transfer members that come into contact with the intermediate transfer belt 10 and presses the intermediate transfer belt 10 toward the photosensitive drums 1 to form a primary transfer portion (primary transfer nip) where the intermediate transfer belt 10 and the photosensitive drums 1 abut on each other.

A transfer voltage (a primary transfer voltage Vtr=+100 V in this example) having a polarity opposite to the normal charge polarity of the toner is applied from a primary transfer power source 15 (high-voltage power source) as a primary transfer voltage application mechanism to the primary transfer rollers 14. In this manner, toner images on the photosensitive drums 1 are primarily transferred to the intermediate transfer belt 10. When a full-color image is formed, the aforementioned process is sequentially performed by the first to fourth process cartridges Sa, Sb, Sc, and Sd, the toner images of the colors are caused to overlap on and primarily transferred to the intermediate transfer belt 10.

The primary transfer rollers 14 according to this example are metal rollers of φ6 mm in a cylindrical shape, and a nickel-plated SUM material is used as a material.

The intermediate transfer belt 10 is an endless belt obtained by adding a conductive agent to a resin material to impart conductivity, and an endless polyimide resin having a peripheral length of 700 mm and a thickness of 70 m and mixed with carbon as a conductive agent is used as a base layer. The electrical characteristics are electron-conductive characteristics, and the intermediate transfer belt 10 is characterized in that a variation in resistance value of the atmosphere with respect to temperature and humidity is small. In this example, the volume resistivity of the intermediate transfer belt 10 is 1×109 Ω·cm. Measurement of the volume resistivity was conducted using a ring probe type UR (model MCP-HTP12) for HIRESTA-UP (MCP-HT450) from Mitsubishi Chemical Corporation. Measurement was conducted under conditions of a room temperature set to 23° C., room humidity set to 50%, an applied voltage of 100 V, and a measurement time of 10 sec. Here, the volume resistivity is a measure of conductivity as a material of the intermediate transfer belt 10.

A secondary transfer roller 20 as a secondary transfer mechanism is disposed at a position facing the secondary transfer counter roller 13 on the side of the outer peripheral surface of the intermediate transfer belt 10. The secondary transfer roller 20 is a (secondary) transfer member that comes into pressure contact with the secondary transfer counter roller 13 via the intermediate transfer belt 10 to form a secondary transfer portion (secondary transfer nip portion) where the intermediate transfer belt 10 and the secondary transfer roller 20 abut on each other.

A voltage having a polarity opposite to the normal charge polarity of the toner is applied from a secondary transfer power source 21 (high-voltage power source) as a secondary transfer voltage application mechanism to the secondary transfer roller 20. In this manner, the toner images of the four colors on the intermediate transfer belt 10 are collectively and secondarily transferred to the recording material P by an action of the secondary transfer roller 20 abutting on the intermediate transfer belt 10 via the recording material P. Note that the recording material P accommodated in a cassette 51 is conveyed to the secondary transfer portion by a feeding mechanism 50 in synchronization with movement of the intermediate transfer belt 10.

A cleaning device 16 as a cleaning-up device (removal device) to clean up (remove) the toner on the intermediate transfer belt 10 is disposed to face the secondary transfer counter roller 13 via the intermediate transfer belt 10. The secondary transfer residual toner remaining on the intermediate transfer belt 10 is cleaned up and removed by the cleaning device 16 and is then collected in a waste toner accommodating container 17.

The recording material P bearing the toner images of the four colors after the secondary transfer ends is conveyed to a fixing device 30, that is, a fixation nipping portion formed by a fixing roller 31 and a pressurizing roller 32. The toners of the four colors are melt, mixed, and fixed on the recording material P by the recording material P being heated and pressurized there, and the recording material P is then discharged from the image forming apparatus 100.

Note that the image forming apparatus 100 is adapted to be able to form a single-color or multiple-color image using only one desired image forming portion or using only some (not all) of the image forming portions.

In this example, the image forming apparatus 100 is a printer compatible with a LETTER size paper at a process speed of 148 mm/sec.

### Engine Control Portion

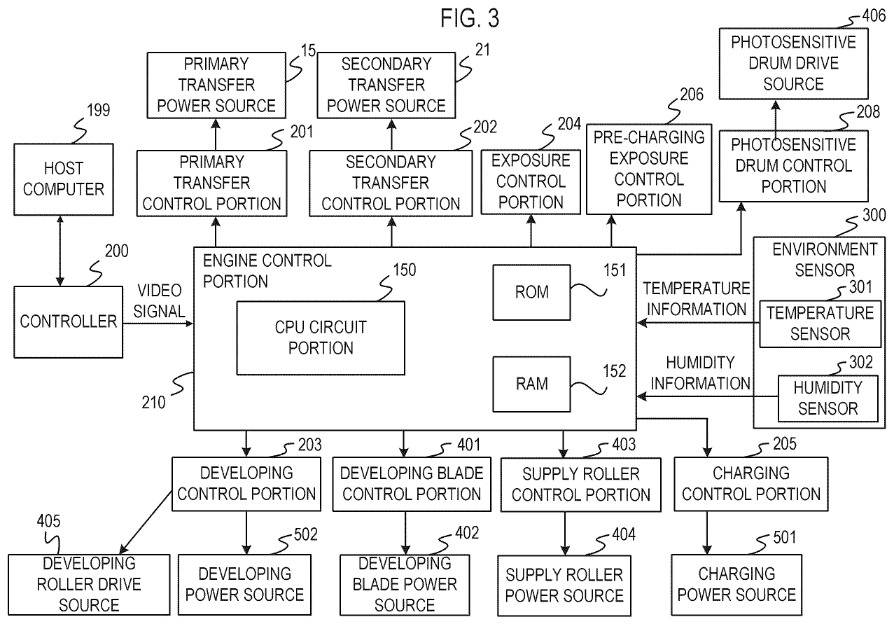

A configuration of an engine control portion 210 that controls the entire image forming apparatus will be described with reference to FIG. 3. FIG. 3 is an explanatory diagram of a configuration of the engine control portion 210 according to Example 1.

The image forming apparatus 100 includes the engine control portion 210 as a control portion for controlling operations of each portion in various operations such as printing operations. As illustrated in FIG. 3, the engine control portion 210 incorporates a CPU circuit portion 150, a ROM 151, and a RAM 152. The CPU circuit portion 150 collectively controls a primary transfer control portion 201, a secondary transfer control portion 202, a developing control portion 203, an exposure control portion 204, a charging control portion 205, a pre-charging exposure control portion 206, a developing blade control portion 401, and a supply roller control portion 403 in accordance with a control program stored in the ROM 151. The RAM 152 temporarily holds control data and is used as a work area for arithmetic processing accompanying the control.

A primary transfer voltage application portion that applies a primary transfer voltage (transfer voltage) to the primary transfer rollers 14 includes a primary transfer power source 15 as a primary transfer voltage application mechanism and a primary transfer control portion 201 that controls the primary transfer power source 15. A secondary transfer voltage application portion that applies a secondary transfer voltage (transfer voltage) to the secondary transfer roller 20 includes a secondary transfer power source 21 as secondary transfer voltage application mechanism and a secondary transfer control portion 202 that controls the secondary transfer power source 21. A developing voltage application portion that applies a developing voltage to the developing rollers 22 includes a developing power source 502 as a developing voltage application mechanism and a developing control portion 203 that controls the developing power source 502. A developing blade voltage application portion (regulating voltage application portion) that applies a developing blade voltage (regulating voltage) to developing blades 23 of the developing units 4 includes a developing blade power source 402 as a developing blade voltage application mechanism (regulating voltage application mechanism) and a developing blade power source 402 that controls the developing blade power source 402. A supply voltage application portion that applies a supply voltage to the supply rollers 26 of the developing units 4 includes a supply roller power source 404 as a supply voltage application mechanism and a supply roller control portion 403 that controls the supply roller power source 404. A charging voltage application portion that applies a charging voltage to the charging roller 2 includes a charging power source 501 as a charging voltage application mechanism and a charging control portion 205 that controls the charging power source 501. The image forming apparatus 100 also includes a photosensitive drum drive source 406 for driving the photosensitive drums 1 and a photosensitive drum control portion 208 that controls the photosensitive drum drive source 406 to control operations of the photosensitive drums 1.

Once a controller 200 receives print information and a print command from a host computer 199, a video signal is sent to the engine control portion 210, and the engine control portion 210 controls each of the aforementioned control portions in accordance with the video signal and executes an image forming operation necessary for a printing operation.

The image forming apparatus 100 includes an environment sensor 300 including a temperature sensor 301 that acquires temperature information on an installation environment and a humidity sensor 302 that acquires humidity information on the installation environment. The temperature information acquired by the temperature sensor 301 and the humidity information acquired by the humidity sensor 302 are sent to the engine control portion 210 and can be used for operation control of each portion.

### Weak Exposure Control

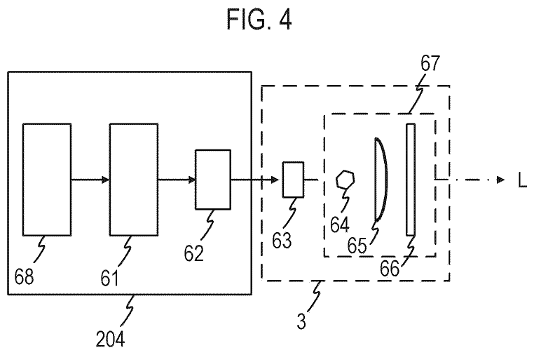

Control of weak exposure of a non-image region performed in this example will be described using FIG. 4. FIG. 4 is an explanatory diagram of weak exposure control according to Example 1.

In FIG. 4, an image signal sent from the controller 200 is a multi-value signal (0 to 255) having a depth direction of 8 bits=256 tones, and the laser beam is turned off when the signal is 0, the laser beam is completely turned on when the signal is 255, and the laser beam has a value gradually changing between on and off when the signal is between 1 to 254. Here, a non-image portion exposure level can be arbitrarily set in accordance with the level of the multi-value signal. In the following description, it is assumed that non-image portion exposure is performed using 32 as the level of the multi-value signal.

A non-image portion with an image signal of 0 sent from the controller 200 is converted into 32 by an image signal conversion circuit 68 in the exposure control portion 204, and image signals with values between 1 to 255 are compression-converted into values between 33 to 255. Thereafter, the signals are converted into signals in a serial time axis direction by a frequency modulation circuit 61 and are used for pulse width modulation of each dot pulse with a resolution of 600 dots/inch in this example.

With such a signal, a laser driver 62 is driven, a laser diode 63 emits light, and a laser beam L is emitted. The laser beam L passes through a correction optical system 67 including a polygon mirror 64, a lens 65, and a returning mirror 66, and is used to irradiate the photosensitive drums 1 as scanning light. Note that the frequency modulation circuit 61 may be provided on the side of the controller separately from the laser driver 62.

### Process Cartridge

Next, an overall configuration of each process cartridge S attached to the image forming apparatus 100 of this example will be described.

The process cartridge S is configured by integrating a photoreceptor unit having the photosensitive drum 1 and the rotatable charging roller 2, and a developing unit (developing device) 4 having the rotatable developing roller 22 and the like.

The photosensitive drum 1 is rotatably supported via a bearing, which is not illustrated. The photosensitive drum 1 is configured to be rotationally driven in the direction of the arrow R1 (counterclockwise direction) in FIG. 2 in accordance with an image forming operation by a drive force of a drive mechanism (drive source), which is not illustrated, being transmitted to the photoreceptor unit. The charging roller 2 is configured to perform driven-rotation with a roller portion of conductive rubber coming into pressure contact with the photosensitive drum 1. Although the charging roller 2 that comes into pressure contact with the photosensitive drum 1 is used in this example, the present disclosure is not limited thereto, and a non-contact charging scheme of a coroner charging device or the like may be adopted.

The photosensitive drum 1 is obtained by forming a photosensitive layer and a surface layer on an aluminum tube of φ20 mm. As the surface layer of the photosensitive drum 1, a thin film layer with a film thickness of 23 m formed of polyarylate is used.

As the charging roller 2, a roller with a length of 228 mm and φy8.5 mm, in which an elastic layer made of conductive rubber having a thickness of 1.5 mm and a volume specific resistance of about 1×106 Ωcm is provided on a metal shaft with a diameter of 5.5 mm, is used. The charging roller 2 is brought into pressure contact with the photosensitive drum 1 at a total of 600 gf, namely 300 gf on each side, from bearings, which are not illustrated, at both end portions of the metal shaft, and performs driven-rotation while forming a nip width of about 300 um.

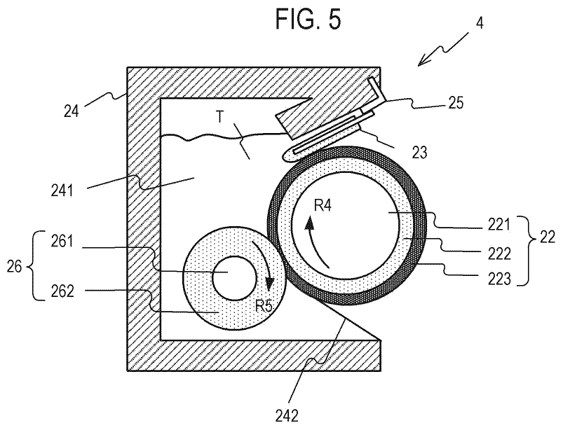

A device configuration of each developing unit 4 will be described using FIG. 5. FIG. 5 is a schematic sectional view illustrating an overview configuration of each developing unit 4.

As illustrated in FIG. 5, the developing unit 4 includes the developing roller 22 (developing member) that bears the toner T, the developing blade 23 (regulating member), the supply roller 26 (supply member), and a developing frame body 24 which fixes these components. The developing frame body 24 includes a developing chamber 241 where the developing roller 22 is disposed and a blowing-out prevention sheet 242 that seals a developing opening (opening portion) connected from the developing chamber 241 to the outside. The developing chamber 241 is a toner accommodating portion that accommodates the toner therein.

One end portion of the developing blade 23 is fixed to a fixing member 25. The developing blade 23 and the developing frame body 24 are integrated by the fixing member 25 being fixed to the developing frame body 24. The other end portion of the developing blade 23 on the side opposite to the one end portion is caused to abut on the developing roller 22 and is configured to be able to regulate the amount of coating of the developing roller 22 with the toner T and imparting of a charge. The developing roller 22 is disposed in the developing opening portion and is disposed to be able to abut on the photosensitive drum 1. In this example, the image forming apparatus 100 includes a disengagement/engagement mechanism that moves to cause the developing roller 22 to be separated from and abut on the photosensitive drum 1.

As illustrated in FIG. 5, the developing roller 22 is a roller having an outer diameter of φ10 mm and having a configuration in which a metal core 221, a base layer 222, and a surface layer 223 are sequentially stacked. The metal core 221 has a size of φ6.0 mm. The base layer 222 is made of conductive silicone rubber having a thickness of 2.0 mm and a volume specific resistance of about 1×107 Ωcm. The surface layer 223 is made of urethane. The developing roller 22 is disposed to rotationally drive in the direction of the arrow R4 (clockwise direction) in FIG. 2. The developing roller 22 rotates with a speed difference with respect to the photosensitive drum 1 in order to control the amount of development of the toner T on the photosensitive drum 1.

In this example, the developing control portion 203 illustrated in FIG. 3 controls the developing roller drive source 405. The rotation speed of the developing roller 22 with respect to the rotation speed of the photosensitive drum 1 can be changed by controlling the developing roller drive source 405. In this example, the developing roller 22 rotates at a speed of 140% relative to the rotation of the photosensitive drum 1.

As illustrated in FIG. 5, the developing blade 23 (regulating member) abuts on the developing roller 22 such that the developing blade 23 faces the counter direction with respect to the rotation direction of the developing roller 22, regulates the amount of coating with the toner T, and imparts a charge through triboelectric charging. In other words, the direction from the end portion of the developing blade 23 on the side of the fixing member 25 toward the end portion on the side of portion abutting on the developing roller 22 is a direction opposite to the rotation direction of the developing roller 22 at the abutting portion between the developing blade 23 and the developing roller 22.

The developing blade 23 as a regulating member for the toner T used in this example is a developing blade with a blade portion provided at support member with a leaf spring shape. The support member is a SUS plate with a leaf spring shape having a thickness of 50 μm to 120 μm. As the blade portion, a blade portion formed by applying a thin film made of a conductive urethane resin to the surface of the support member is used. The surface of the blade portion of the developing blade 23 is caused to abut on the developing roller 22 using spring elasticity of the support member.

Furthermore, a predetermined DC voltage (developing blade voltage Vbld) is applied to the developing blade 23, and a developing voltage Vdc (developing roller voltage) is applied to the developing roller 22. The amount of coating with the toner T and the amount of charging of the toner can be controlled by controlling a difference ΔVbld (Vbld−Vdc; developing blade contrast) that is a potential difference between the developing blade voltage Vbld and the developing voltage Vdc. In this example, control is performed such that Vbld=−500 V, Vdc=−300 V, and ΔVbld=−200 V are satisfied in the image forming operation.

The supply roller 26 (supply member) is configured by providing a urethane foam layer 262 around a core metal electrode 261 having an outer diameter of φ5.5 mm, which is a conductive support. The outer diameter of the entire supply roller 26 including the urethane foam layer 262 is φ11 mm. The amount of penetration of the supply roller 26 and the developing roller 22 is 1.2 mm. The supply roller 26 rotates in a direction (the direction of the arrow R5 in FIG. 2) such that the supply roller and the developing roller 22 have speeds in mutually opposite directions at the abutting portion therebetween. A powder pressure of the toner T that is present around the urethane foam layer 262 acts on the urethane foam layer 262, and the toner T is taken into the urethane foam layer 262 by the supply roller 26 further rotating.

The supply roller 26 containing the toner T supplies the toner T to the developing roller 22 at the portion abutting on the developing roller 22 and imparts a preliminary triboelectric charging charge to the toner T through further rubbing. In other words, the supply roller 26 is configured to be able to charge the toner T that the developing roller 22 bears. On the other hand, the supply roller 26 that supplies the toner T to the developing roller 22 also serves to peel off the toner T remaining on the developing roller 22 without being developed at the developing portion.

A predetermined DC voltage (supply voltage Vrs) is applied to the supply roller 26. The amount of toner to be supplied and the amount of preliminary triboelectric charging can be controlled by controlling a potential difference (difference ΔVrs=Vrs−Vdc) between the supply voltage Vrs and the developing voltage Vdc. In this example, control is performed such that Vrs=−500 V, Vdc=−300 V, and ΔVrs=−200 V are satisfied in the image forming operation.

The toner T according to Example 1 is a non-magnetic toner manufactured by suspension polymerization and having a negative normal charge polarity, and has a volume average particle size of 7.0 μm. The toner T is negatively charged when the developing roller 22 bears the toner T. In order to modify surface properties of a core material of the toner T (which refers to a composition containing carbon as a main component, such as a binder resin or a release agent contained in the toner particle), silicon oxide particles of about 1.5% with respect to the weight of the toner are attached (externally added) as an external additive to the surface of the toner. The volume average particle size of the silicon oxide particles is about 20 nm to 120 nm.

The shape of the toner T itself is deformed, or the external additive on the surface of the toner peels off or is embedded, due to rubbing against the developing blade for a long period of time. The deformation of the shape of the toner leads to an increase in contact area between the toner T and the photosensitive drum 1. Furthermore, the resin component of the toner comes into contact with the photosensitive drum 1 by the external additive on the surface of the toner peeling off, and the contact area between the toner and the photosensitive drum 1 increases by the eternal additive being embedded in the toner. As a result, a non-electrostatic adhesion force to the photosensitive drum 1 becomes higher than that in a state of a new product. Such a phenomenon will be referred to as degradation of the toner T in the following description.

A change in non-electrostatic adhesion force accompanying deformation of the toner shape can be replaced by a change in average circularity (aspect ratio) of the toner T. In this example, the average circularity in the state of a new product is about 0.95, and the state where the average circularity has become about 0.90 or less is define as a degraded state. The average circularity of the toner can be measured by a flow-based particle image analyzer “FPIA-3000” (manufactured by Sysmex Corporation).

Furthermore, a change in surface state caused by peeling-off or embedding of the external additive contained in the toner T can be quantitatively recognized using a BET value. In this example, QUADRASORB SI (QUADRA. SORB) manufactured by Quantachrome Instruments is used to measure the BET value of the toner T. The BET value of the toner T used as a change in adhesion state of the external additive to the surface of the toner indicates the amount of adhesion of the external additive to the surface of the toner, and the BET value of the toner T decreases as the amount of external additive that is present on the surface of the toner decreases. In other words, although the BET value of the toner is increased by externally adding an external additive having a large BET value to the surface of the toner core, the BET value of the toner T is decreased by the external additive being embedded in the toner resin or by the external additive being separated from the toner surface. In a case where the external additive is completely eliminated from the toner surface, the BET value of the toner T becomes the same as the BET value of the toner core. In this example, the BET value in the state of a new product is about 2.8 m2/g, and the state where the BET value has become 2.0 m2/g or less is defined as a degraded state.

It should be noted that the change in non-electrostatic adhesion force can be replaced with other indicators, and for example, the change in non-electrostatic adhesion force can be determined from an increase in primary transfer residue by directly measuring the amount of toner (primary transfer residue) remaining at the time of the primary transfer.

Although a toner obtained by externally adding an external additive to a core is used as the toner T in this example, the present disclosure is not limited thereto. For example, a toner having projecting portions Ta containing an organic silicon polymer having a partial structure represented by Expression (1) on the surface of the toner core may be used as the toner T.

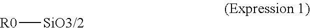

(R0 is an alkyl group or a phenyl group having at least 1 and not more than 6 carbon atoms.)

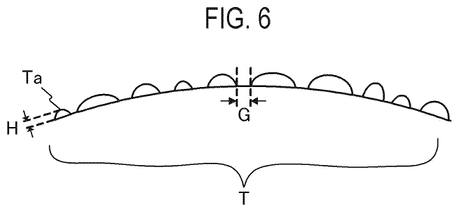

FIG. 6 is a diagram illustrating a configuration example of the toner T having the projecting portions Ta. The projecting interval G which is an interval between mutually adjacent projecting portions Ta on the toner surface and the projecting height H which is the height of the projecting portions Ta from the core can be measured with a scanning probe microscope (hereinafter, an SPM). The SPM includes a probe, a cantilever supporting the probe, a displacement measurement system that detects bending of the cantilever, detects an interatomic force (an attraction force or a repulsion force) between the probe and a sample, and observes the shape of the surface of the sample.

### Development of Toner and Collection of Transfer Residual Toner

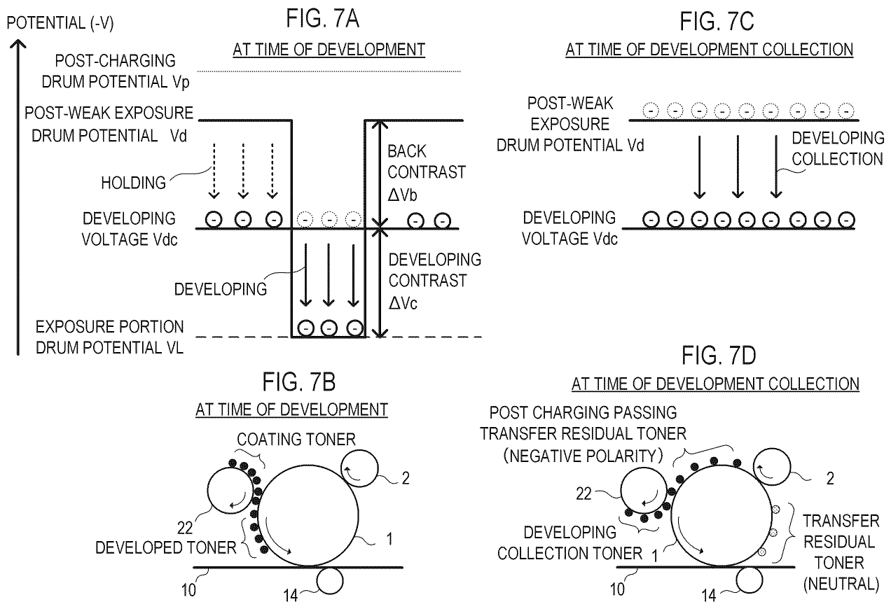

Development of the toner and collection of the transfer residual toner in the developing portion will be described with reference to FIGS. 7A to 7D. FIGS. 7A to 7D are explanatory diagrams of a method of collecting the transfer residual toner. Note that the circles of the solid lines in FIGS. 7A and 7C indicate the toner after movement, and the circles of the dashed lines indicate the toner before movement.

First, the development of the toner will be described using FIGS. 7A and 7B. FIG. 7A is a schematic diagram of a potential relationship when the toner is developed. FIG. 7B is a schematic diagram in the vicinity of the developing portion when the toner is developed.

A charging voltage Vpri applied to the charging roller 2 during the image forming operation in this example is −1200 V, and the surface potential (post-charging potential Vp; post-charging drum potential) of the photosensitive drum 1 after charging is approximately −700 V. Furthermore, a post-weak exposure potential Vd (post-weak exposure drum potential) formed in the non-image region on the photosensitive drum 1 through weak exposure is approximately −480 V. The developing voltage Vdc applied to the developing roller 22 is −300 V, and the post-exposure potential VL (exposure portion drum potential) of the photosensitive drum 1 with the charge attenuated through the exposure is about −150 V.

The primary transfer is performed with a transfer contrast ΔVtr1 (primary transfer contrast) that is a potential difference between the post-exposure potential VL and the primary transfer voltage Vtr. As illustrated in FIGS. 7A and 7B, an electrostatic latent image is visualized as an image at the developing portion where the negatively charged toner comes into contact with the photosensitive drum 1 due to the potential difference (hereinafter, referred to as a developing contrast ΔVc) between the developing voltage Vdc and the post-exposure potential VL, thereby forming a toner image. Also, the toner on the developing roller 22 is electrically held such that the toner does not shift to the non-image region by a potential difference (hereinafter, referred to as a back contrast ΔVb) between the developing voltage Vdc and the post-weak exposure potential Vd formed through weak exposure.

Subsequently, a method of processing the toner (hereinafter, referred to as a transfer residual toner) on the surface of the photosensitive drum 1 without being transferred to the intermediate transfer belt 10 in the primary transfer process will be described.

In this example, the transfer residual toner is collected by the developing roller 22 and recycled. A method of collecting (hereinafter, referred to as development collection) the transfer residual toner by the developing roller 22 will be described using FIGS. 7C and 7D. FIG. 7C is a schematic diagram of a potential relationship at the time of the development collection. FIG. 7D is a schematic diagram in the vicinity of the developing portion at the time of the development collection.

In the toner developed on the photosensitive drum 1, a toner with a small amount of charging and with a substantially neutral polarity remains on the surface of the photosensitive drum 1 as a transfer residual toner without being able to be transferred to the intermediate transfer belt 10 in the primary transfer process. As illustrated in FIGS. 7C and 7D, the transfer residual toner is charged with a normal charge polarity with the charging voltage Vpri when passing through the portion abutting on the charging roller 2. At this time, the post-charging potential Vp is formed on the surface of the photosensitive drum 1 with the charging voltage Vpri at the same time, and the post-weak exposure potential Vd is then formed through weak exposure.

A potential difference (back contrast ΔVb) occurs between the potential (developing voltage Vdc) of the developing roller 22 formed by applying a DC voltage to the developing roller 22 and the post-weak exposure potential Vd. The transfer residual toner on the drum surface on which the post-weak exposure potential Vd has been formed is charged with the normal charge polarity. The transfer residual toner on the drum surface on which the post-weak exposure potential Vd has been formed is collected by the developing roller 22 with an electric field caused by the potential difference (back contrast ΔVb). The toner collected by the developing roller 22 is then recycled.

### Ejection Control

The image forming apparatus 100 according to Example 1 is configured to be able to efficiently eject a degraded toner generated in association with utilization of the process cartridge S from the developing unit 4 (developing container) and process the degraded toner without ejecting a large amount of toner that has not yet been degraded. In the following description, the toner that has not yet been degraded will be referred to as a fresh toner, and the degraded toner generated in association with utilization of the process cartridge S will be referred to as a degraded toner.

In this example, the image forming apparatus 100 is configured to be able to execute an image forming mode in which the image forming operation is performed and an ejection mode in which a toner ejection operation (toner supplying operation) for processing the degraded toner is performed. In the toner ejection operation, the toner in the developing unit 4 (including both the degraded toner and the fresh toner) is ejected to the photosensitive drum 1. Thereafter, the fresh toner is selectively collected by the developing portion, and the degraded toner is collected in the waste toner accommodating container 17 by the cleaning device 16. Hereinafter, operation control of such a toner ejection operation, which is different from the image forming operation, will be referred to as a degraded toner ejection control (ejection control; toner supply control).

The image forming apparatus 100 according to Example 1 can selectively eject the degraded toner from the developing unit 4 while collecting a part of the fresh toner in the developing unit 4 through the degraded toner ejection control (degraded toner ejection operation). It is thus possible to realize efficient ejection and to curb unnecessary toner consumption.

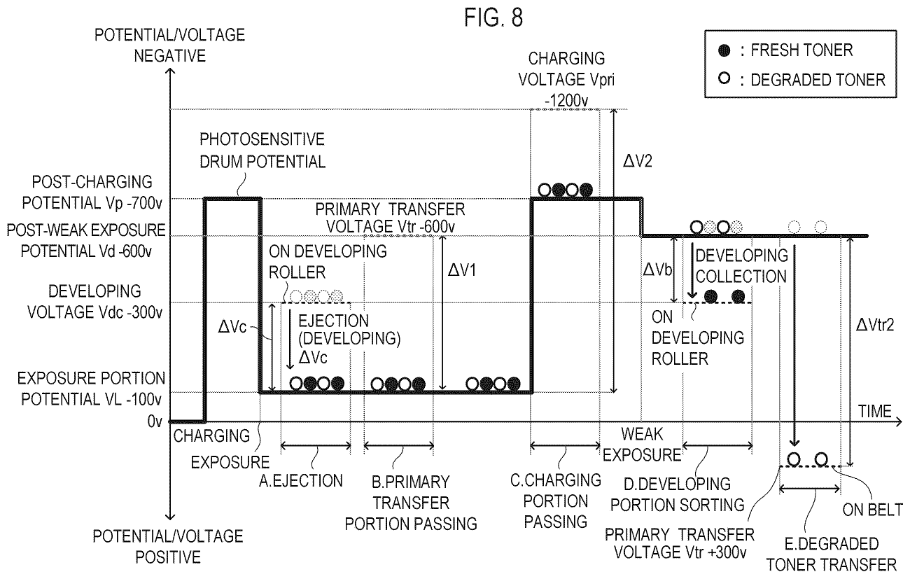

Hereinafter, the degraded toner ejection control (ejection operation) will be described in more detail using FIGS. 1A to 1F and FIG. 8. Hereinafter, the toner ejected from the developing unit 4 will be referred to as an ejected toner. FIGS. 1A to 1F are explanatory diagrams of degraded toner ejection control, and are schematic diagrams illustrating movement of the ejected toner when ejection control is executed. FIG. 8 is an explanatory diagram of voltage and potential control in the ejection control, and is a diagram schematically representing a potential of the photosensitive drum 1, the developing voltage, transition of the primary transfer voltage, and toner movement in the ejection control along a time axis. FIG. 8 illustrates a graph in which the vertical axis represents potential/voltage and the horizontal axis represents time, the surface potential (the potential of the photosensitive drum) at a predetermined location moving with rotation of the photosensitive drum 1 is illustrated by the thick line, and the toner adhering to the part is illustrated together. In each of the drawings used in the following description, the fresh toner is illustrated by a black circle, and the degraded toner is illustrated by a white circle. The circle of the solid line represents the toner after movement, and the circle of the dashed line represents the toner before movement.

This control is roughly categorized into processes A. ejection of the toner in the developing unit 4, B. passing of the ejected toner through the primary transfer portion, C. passing of the ejected toner through the charging portion, D. toner sorting at the developing portion, E. transfer of the degraded toner, and F. cleaning-up (processing) of the degraded toner. Each process will be described below. Note that each of the processes A to F corresponds to FIGS. 1A to 1F, and a range corresponding to each of the processes A to E is also indicated by an arrow in FIG. 8 as well.

### A. Ejection of Toner Inside Developing Unit 4

FIG. 1A is a diagram illustrating a state of the ejection process of the toner inside the developing unit 4. The ejection process of the toner is a process in which the toner is supplied from the developing roller 22 to the photosensitive drum 1. Once the ejection control operation is started, the photosensitive drum 1 is uniformly charged to a predetermined potential with a negative polarity by the charging roller 2 in a rotation process, and is then exposed by the scanner unit 3. In this manner, a latent image potential of the post-exposure potential VL is formed on the photosensitive drum 1. In this example, it is assumed that the post-charging potential Vp=−700 V and the post-exposure potential VL=−100 V.

Thereafter, as illustrated in FIG. 1A, the toner that the developing roller 22 bears is ejected to the photosensitive drum 1 by the potential difference (developing contrast ΔVc) between the developing voltage Vdc and the post-exposure potential VL at the position where the developing roller 22 abuts on the photosensitive drum 1. At this time, the ejected toner contains both the degraded toner and the fresh toner. In this example, it is assumed that the developing voltage Vdc=−300 V. In other words, an absolute value of the developing contrast ΔVc is 200 V

Note that in this ejection control, the amount of exposure by the scanner unit 3 is made different from that in the image forming operation, the post-exposure potential VL is set to be greater (from −150 V to −100 V) (caused to approach a positive value) and the absolute value of the developing contrast ΔVc is set to be greater (from 150 V to 200 V) as compared with those in the image forming operation. This is for firmly develop the toner on the developing roller 22 onto the photosensitive drum 1.

In the rotation direction of the photosensitive drum 1, the length of the ejected toner ejected at a time (under one ejection control) is preferably equal to or longer than the length of one turn of the developing roller 22, and is preferably within the length of one turn of the photosensitive drum 1. Since consumption of the toner in the vicinity of the developing roller 22 is assumed, the length of the ejected toner is preferably equal to or longer than one turn of the developing roller 22 in order to eject all the toners with which the developing roller 22 is coated immediately before the ejection control. On the other hand, there is a concern that collection efficiency is degraded if the ejection of the toner accommodated in the developing unit 4 and the collection of the fresh toner at the developing portion, which will be described later, are performed at the same time due to a relationship with the photosensitive drum potential. Accordingly, the length of the ejected toner is preferably within one turn of the photosensitive drum 1.

In this example, the toner corresponding to a length of 44.8 mm (=10 mm×3.14÷1.4×2) of two turns of the developing roller 22 is ejected. The length of one turn of the photosensitive drum 1 is 62.8 mm (=20 mm×3.14), and the length, by which the toner is ejected, in the rotation direction of the photosensitive drum 1 is less than the length of one turn of the photosensitive drum 1. Note that although there is a limitation on the length of the toner to be ejected at a time in the rotation direction of the photosensitive drum 1, the total amount of toner to be ejected may be adjusted by repeating this ejection control.

### B. Passing of Ejected Toner Through Primary Transfer Portion

FIG. 1B is a diagram illustrating an ejected toner primary transfer portion passing process (first process). The primary transfer portion passing process is a process in which the toner supply portion (first region) of the photosensitive drum 1 supplied with the toner from the developing roller 22 passes through the primary transfer portion, which is the abutting portion between the photosensitive drum 1 and the intermediate transfer belt 10, for the first time. When the ejected toner passes through the primary transfer portion, a voltage of −600 V is applied from the primary transfer power source 15 to the primary transfer roller 14 which is a metal roller. As illustrated in FIG. 8, a potential difference ΔV1 (first potential difference) is formed between the post-exposure potential VL and the potential formed between the photosensitive drum 1 and the intermediate transfer belt 10 at the primary transfer portion such that the ejected toner (normal charge polarity) remains on the photosensitive drum 1. As a result, the toner ejected to the toner supply portion passes through the primary transfer portion while the photosensitive drum 1 bears the toner, as illustrated in FIG. 1B.

If the potential formed on the intermediate transfer belt 10 is a negative potential and has an absolute value greater than the absolute value of the post-exposure potential VL of the photosensitive drum 1, it is possible to cause the ejected toner to remain on the photosensitive drum 1. This is because the ejected toner is charged with a normal charge polarity (negative polarity) by rubbing against the developing blade 23. In other words, the toner is electrostatically attracted to the photosensitive drum 1 by the intermediate transfer belt 10 where the negative potential with an absolute value greater than the absolute value of the potential (post-exposure potential VL) of the photosensitive drum 1 is formed. It is possible to cause the ejected toner to remain on the photosensitive drum 1 if the potential difference is equal to or greater than the transfer contrast ΔVtr1 at the time of the image formation. Note that if the potential difference ΔV1 is excessively large, there is a concern that abnormal discharge may occur at the primary transfer portion, the toner polarity may be inverted, and the potential difference ΔV1 is preferably less than 1500 V in the configuration of this example. In this example, the potential of −600V is formed in the intermediate transfer belt 10 by the primary transfer power source 15 such that the absolute value of the potential difference ΔV1 becomes 500 V.

### C. Passing of Ejected Toner Through Charging Portion

FIG. 1C is a diagram illustrating an ejected toner charging portion passing process. The charging portion passing process is a process in which the toner supply portion of the photosensitive drum 1 supplied with the toner from the developing roller 22 passes the charging portion which is an abutting portion between the photosensitive drum 1 and the charging roller 2. The ejected toner that has passed through the primary transfer portion passes through a position where the charging roller 2 charges the photosensitive drum 1, which is a position (charging portion) the charging roller 2 and the photosensitive drum 1 come into contact with each other. As illustrated in FIG. 8, a voltage with a negative polarity of −1200 V is applied to the charging roller 2 when the ejected toner passes through the charging portion. As a result, the ejected toner passes without adhering to the charging roller 2 due to a potential difference (hereinafter, referred to as a charging contrast ΔV2) between the potential of the photosensitive drum 1 and the voltage of the charging roller 2. At this timing, formation of the post-charging potential Vp and imparting of a charge to the ejected toner are performed at the same time.

Note that the charging contrast ΔV2 is preferably large to some extent from any of the above viewpoints and it is sufficient for the charging contrast ΔV2 to be equal to or greater than the charging contrast in the image forming operation. On the other hand, if the charging contrast ΔV2 is excessively large, there is a concern that abnormal discharge may occur at the charging portion, and the toner polarity may be inverted, which may lead to adhesion to the charging roller 2. For this reason, the charging contrast ΔV2 is set to 1100 V in this example.

### D. Toner Sorting at Developing Portion

FIG. 1D is a diagram illustrating a toner sorting process (second process) at the developing portion. The toner sorting process is a process in which a part of the toner on the surface of the photosensitive drum 1 supplied from the developing roller 22, that is, a part of the toner in the toner supply portion is collected by the developing roller 22. After the ejected toner passes through the charging portion, the degraded toner and the fresh toner are sorted at the position where the developing roller 22 and the photosensitive drum 1 come into contact with each other (hereinafter, referred to as a developing portion). The ejected toner that has passed through the charging portion passes through the developing portion thereafter with rotation of the photosensitive drum 1. At this time, the developing voltage Vdc=−300 V is applied to the developing roller 22, and Vd=−600 V is formed on the surface of the photosensitive drum through weak exposure, as illustrated in FIG. 8. The ejected toner is collected by the back contrast ΔVb (second potential difference) which is a potential difference between the post-weak exposure potential Vd and the developing voltage Vdc.

The ejected toner contains both the fresh toner and the degraded toner. The degraded toner is a toner with the shape itself deformed, or with the external additive on the surface thereof having peeled off or having been embedded, due to rubbing against the developing blade 23 for a long period of time. The deformation of the shape of the toner increases the contact area between the toner and the photosensitive drum 1. For example, the contact area between the toner and the photosensitive drum 1 may increase by the resin component in the toner and the photosensitive drum 1 coming into contact with each other and the exterior additive being embedded in the toner due to peeling off of the external additive from the toner surface. As a result, the degraded toner has a higher non-electrostatic adhesion force to the photosensitive drum 1 as compared with the fresh toner. On the other hand, since the fresh toner has been less degraded, the non-electrostatic adhesion force to the photosensitive drum 1 is low contrary to the degraded toner.

As described above, since there is a difference in non-electrostatic adhesion force between the degraded toner and the fresh toner, the fresh toner is likely to be collected and the degraded toner is less likely to be collected when the ejected toner is collected at the developing portion. In the first example, the fresh toner is selectively collected at the developing portion (the degraded toner is selectively not collected) as illustrated in FIG. 1D using such a difference in non-electrostatic adhesion force between the degraded toner and the fresh toner. With such a configuration, since a large amount of fresh toner with less degradation can be collected from the ejected toner, the lifetime of the developing unit 4 can be prolonged without unnecessarily consuming toner. Note that in this example, the fresh toner had a BET value of about 2.8 m2/g and the degraded toner had a BET value of about 2.0 m2/g or less as an example. However, the toner can be sorted even in a case where the difference in non-electrostatic adhesion force is 0.8 m2/g or less in terms of the BET value in the toner sorting in this process, and the toner can be sorted from an initial stage of utilization of the process cartridge S (in a state close to a new product). As the service time of the process cartridge S increases and the lifetime of the process cartridge S becomes closer to its end, the proportion of the degraded toner increases. Accordingly, it is more effective to perform the toner sorting in the latter half of the lifetime of the process cartridge S in which the proportion of the degraded toner is high.

Ejected toner collection efficiency when the ejected toner is collected at the developing roller 22 can be controlled by the back contrast ΔVb. First, as an absolute value of the back contrast ΔVb increases within a range below a discharge threshold value, an electric field for moving the ejected toner toward the side of the developing roller 22 becomes stronger, and the collection efficiency is thus improved. Note that in a case where the back contrast ΔVb is greater than the discharge threshold value between the developing roller 22 and the photosensitive drum 1, the polarity of the ejected toner is inverted through the discharge, resulting in a decrease in collection efficiency.

On the other hand, in a case where the absolute value of the back contrast Δ Vb is small, not only a decrease in collection efficiency occurs, but also it becomes impossible to hold the toner with which the developing roller 22 is coated on the developing roller 22, and the toner is developed on the photosensitive drum 1. Such unintended development is referred to as fogging. Accordingly, it is necessary to set the back contrast ΔVb to be less than the discharge threshold value and within a range in which fogging does not occur such that the fresh toner is selectively collected by the developing roller 22. Specifically, the back contrast ΔVb may be 100 V or more and less than about 500 V, and may be appropriately adjusted in accordance with the properties (an adhesion force, the amount of charging, the shape, and the degree of degradation) of the used toner.

In this example, the voltage (developing voltage Vdc) applied to the developing roller 22 is set to −300 V such that the absolute value of the back contrast ΔVb becomes 300 V In other words, the absolute value of the back contrast ΔVb in the ejection control is set to be greater than that in the image forming operation (fourth potential difference). Note that although the back contrast ΔVb is formed through weak exposure in this example, the present disclosure is not limited to such a configuration. In a case of an image forming apparatus that does not include (cannot execute) weak exposure, for example, an appropriate charging contrast ΔV2 and the back contrast ΔVb may be secured by adjusting the charging voltage.

Most of the fresh toner can be collected at the developing roller 22, and most of the degraded toner can be caused to remain on the photosensitive drum 1, by controlling various voltages and the amount of exposure as described above.

### E. Degraded Toner Transfer

FIG. 1E is a diagram illustrating a degraded toner transfer process (third process). The degraded toner transfer process is a process in which the toner supply portion of the photosensitive drum 1 supplied with the toner from the developing roller 22 passes through the transfer portion again, and the remaining toner moves from the photosensitive drum 1 to the intermediate transfer belt 10. In other words, the degraded toner remaining on the photosensitive drum 1 is transferred to the intermediate transfer belt 10 after the sorting collection process of the developing portion. The degraded toner that has passed through the developing portion is charged with a negative polarity (normal charge polarity). Accordingly, a positive primary transfer voltage is applied to the primary transfer roller 14 to thereby transfer the degraded toner to the intermediate transfer belt 10 as illustrated in FIG. 1E. At this time, the potential on the surface of the photosensitive drum 1 where the degraded toner remains is the post-weak exposure potential Vd as illustrated in FIG. 8. Then, the degraded toner is transferred to the intermediate transfer belt 10 by a transfer contrast ΔVtr2 which is a potential difference (third potential difference) between the post-weak exposure potential Vd and the primary transfer voltage Vtr.

As described above, the degraded toner has a higher adhesion force to the photosensitive drum 1 than the fresh toner. Accordingly, the degraded toner is unlikely to be transferred to the intermediate transfer belt 10 with the same potential difference similar to that during ordinary image formation in the transfer of the degraded toner to the intermediate transfer belt 10. Therefore, it is necessary to set the transfer contrast ΔVtr2 such that the degraded toner can be transferred to the intermediate transfer belt 10.

The degraded toner remaining on the photosensitive drum 1 is a toner that has not been collected at the developing roller 22 with the back contrast ΔVb at the time of immediately preceding collection by the developing roller 22. Therefore, it is preferable that the transfer contrast ΔVtr2 be set to be equal to or greater than the back contrast ΔVb at the time of development collection of the fresh toner. As described above, the degraded toner has a high adhesion force to the photosensitive drum 1, and is less likely to be transferred. Therefore, it is preferable that the transfer contrast ΔVtr2 be greater than the transfer contrast ΔVtr1 (fifth potential difference) at the time of the ordinary image forming operation. In other words, the transfer contrast ΔVtr2 is preferably greater than a greater one out of the back contrast ΔVb at the time of the development collection of the fresh toner and the transfer contrast ΔVtr1 at the time of the ordinary image forming operation. However, since there is a concern that if the transfer contrast ΔVtr2 is excessively large, abnormal discharge may occur at the primary transfer portion, the transfer contrast ΔVtr2 is preferably less than about 2000 V.

In this example, the transfer contrast ΔVtr2 between the post-weak exposure potential Vd=−600 V and the primary transfer voltage Vtr=+300 V is to be 900 V in the transfer of the degraded toner to the intermediate transfer belt 10.

### F. Cleaning of Degraded Toner

FIG. 1F is a diagram illustrating a state of a cleaning process of the degraded toner. The degraded toner transferred to the intermediate transfer belt 10 is sent to the cleaning device 16 by rotation of the intermediate transfer belt 10, and is then collected and processed in the waste toner accommodating container 17.

A part of the toners containing most of the degraded toner in the ejected toner can be sent to the waste toner accommodating container 17 in Example 1 in this manner. Accordingly, it is possible to delay filling of the waste toner accommodating container 17 as compared with a case where all the ejected toner is sent to the waste toner accommodating container 17. It is thus possible to reduce the replacement frequency of the waste toner accommodating container by a user.

In this example, the developing roller 22 is immediately separated from the photosensitive drum 1 by the disengagement/engagement mechanism after the ejected toner finishes passing through the developing portion (between FIG. 1E and FIG. 1F), and the rotation of the developing roller 22 is then stopped. This is performed for the purpose of avoiding unnecessary rubbing by immediately performing separation at the timing at which it becomes unnecessary for the developing roller 22 to be in contact with the photosensitive drum 1 since the toner on the developing roller 22 rubs against the developing blade 23 with the rotation of the developing roller 22.

In this example, a voltage with a negative polarity is applied to the secondary transfer roller 20 when the degraded toner charged with a negative polarity on the intermediate transfer belt 10 is sent to the cleaning device 16. In this manner, the degraded toner on the intermediate transfer belt 10 passes without adhering to the secondary transfer roller 20.

If the absolute value of the voltage applied to the secondary transfer roller 20 when the degraded toner on the intermediate transfer belt 10 passes through the portion abutting on the secondary transfer roller 20 is excessively small, the degraded toner will adhere to the secondary transfer roller 20. Even if the absolute value of the applied voltage is excessively high, the polarity of the toner is inverted due to abnormal discharge, and the degraded toner will adhere to the secondary transfer roller 20. Therefore, the voltage applied to the secondary transfer roller 20 is preferably about −300 to −1000 V. In this example, a voltage of −500 V is applied to the secondary transfer roller 20. Note that although the secondary transfer roller 20 is in contact with the intermediate transfer belt 10 in this example, the secondary transfer roller 20 may be separated from the intermediate transfer belt 10 to prevent adhesion of the degraded toner to the secondary transfer roller 20 in a case where a disengagement/engagement mechanism for the secondary transfer roller 20 is included.

It should be noted that the degraded toner transferred to the intermediate transfer belt 10 may not necessarily be sent to the cleaning device 16 during the ejection control. For example, the ejection control may be terminated at the timing right after the degraded toner is transferred to the intermediate transfer belt 10. At this time, the degraded toner remaining on the intermediate transfer belt 10 may be sent to the cleaning device 16 by a rotating operation of the intermediate transfer belt 10 in the next ordinary image forming operation and may be collected and processed therein. It is thus possible to execute the ejection control without generating an unnecessary down time.

Note that the ejection mode is made to operate with the developing voltage Vdc of −300V, which is the same as that in the image forming operation, with different charging voltage, amount of exposure, and the like from those in the image forming operation in this example, the present disclosure is not limited to such a configuration. For example, the developing voltage Vdc may be changed to change the back contrast ΔVb and the developing contrast ΔVc.

### Execution Timing of Ejection Control

The ejection mode (toner ejection operation) is preferably executed after the image forming operation ends such that there is no delay in start of the image forming operation, or between sheets of the recording materials P (when the image forming operation is not being performed) when images are successively formed on the plurality of recording materials P.

In order to selectively eject most of the degraded toner from the developing unit 4 (developing device), it is preferable to execute the ejection control in the latter half of the lifetime of the process cartridge S in which the degraded toner is accumulated in the developing unit 4. As described hitherto, it is necessary to rotate the developing roller 22 to correspond to at least one turn of the photosensitive drum in the toner ejection control. Accordingly, execution of the ejection control more than necessary is accompanied by rotation of the developing roller 22 (that is, rubbing between the developing blade 23 and the toner) more than necessary. Therefore, this ejection control is performed every 50 sheets of paper feed after half the lifetime (for example, the amount of remaining toner or the rotation distance of the developing roller) of the process cartridge S in this example. However, a method of determining the timing of executing the toner ejection control is not limited to such a configuration, and a configuration in which a detecting portion that detects a lifetime or a utilization time of any of the photosensitive drum 1, the charging roller 2, and the developing roller 22 is provided and the toner ejection control is executed on the basis of a detection result of the detecting portion may be adopted.

Efficient ejection can be realized by selectively ejecting most of the degraded toner generated in association with the utilization of the process cartridge S from the developing unit 4 by executing the ejection control as described above. It is thus possible to suppress unnecessary toner consumption and to reduce a replacement frequency of the waste toner accommodating container.

### Evaluation Tests

Evaluation tests conducted to confirm the effect of suppressing the toner consumption and the effect of reducing the replacement frequency of the waste toner accommodating container in this example will be described below.

First, in order to confirm the effect of suppressing the toner consumption, the following test was conducted for the configuration of Example 1 and a configuration of Comparative Example 1 on the basis of the cartridge printable number measurement standard ISO/IEC19798. In an environment of the temperature of 23° C./the relative humidity of 50%, feeding tests of 5000 sheets with a XEROX Business 4200 LETTER size (Xerox; trade name) as recording material P were conducted, and the presence or absence of image defects was verified.

Example 1: ejection control was performed (performed for every 50 sheets after 2500 sheets of paper were fed).

Comparative Example 1: ejection control was not performed.

Note that a configuration and operations of the image forming apparatus 100 of Comparative Example 1 are substantially similar to those of the image forming apparatus 100 of Example 1 except that the ejection control is not performed.

Table 1 below shows the evaluation results of this test. Table 1 shows presence or absence of image defects the first fed sheet and every 1000 sheets in Example 1 and Comparative Example 1. Determination of image defects was made on the basis of collection defects at the developing portion (hereinafter, referred to as development collection defects) with deterioration of primary transfer properties due to toner degradation. Here, a case where no development collection defects occurred was evaluated as A, a case where minor development collection defects occurred was evaluated as B, and a case where unacceptable development collection defects occurred was evaluated as C. It was determined that no problems had occurred for the ranks A and B, and it was determined that some image defects had occurred for the rank C.

TABLE 1

| | First | 1000th | 2000th | 3000th | 4000th | 5000th |
|---|---|---|---|---|---|---|
| | Sheet | sheet | sheet | sheet | sheet | sheet |
| Example 1 | A | A | A | A | A | A |
| Comparative | A | A | A | B | B | C |
| Example 1 | | | | | | |

In the configuration of Comparative Example 1, the transfer properties deteriorated as the number of fed sheets increased. Specifically, development collection defects occurred on and after 3000th sheet. In particular, unacceptable (rank C) development collection defects occurred at the timing of 5000 sheets.

On the other hand, in the configuration of Example 1 in which ejection control was performed periodically in the latter half of the lifetime of the process cartridge S, no development collection defects occurred even after the number of fed sheets reached 5000. In other words, since the degraded toner was ejected from the developing unit 4 in Example 1, a difference occurred on and after the 3000th sheet as compared with Comparative Example 1.

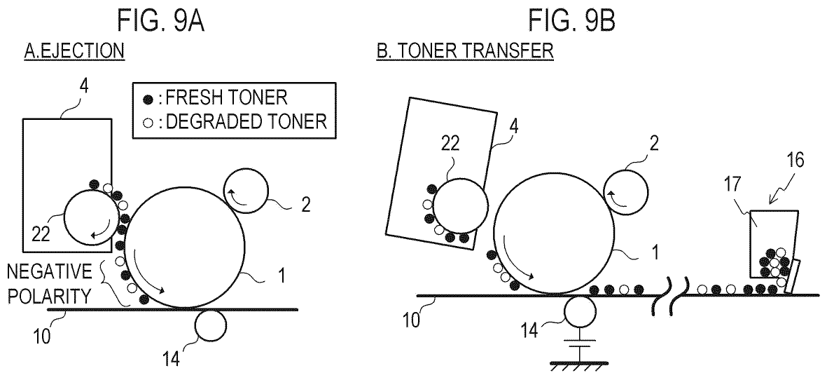

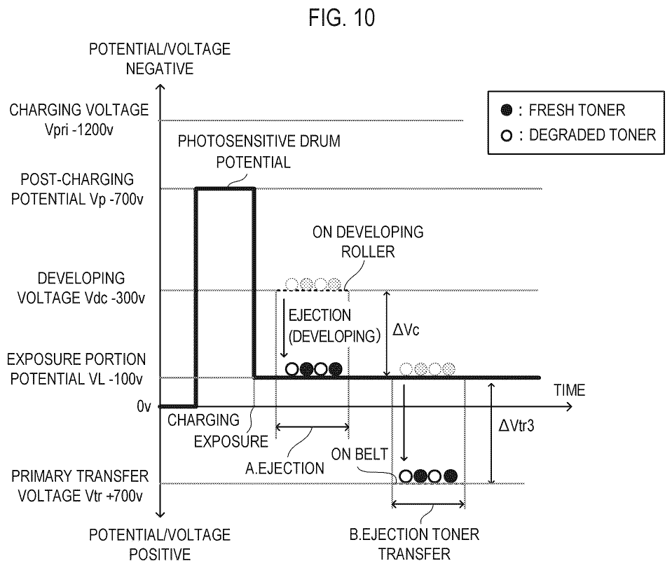

Next, evaluation tests were conducted on the configurations of Example 1 and Comparative Example 2 below in order to confirm the effect of reducing the replacement frequency of the waste toner accommodating container of this example. First, the configuration of Comparative Example 2 will be described using FIGS. 9A and 9B and FIG. 10.

In Comparative Example 2, ejection control (hereinafter referred to as “solid ejection control” for distinguishing this from the ejection control in Example 1) described below was conducted. FIGS. 9A and 9B are explanatory diagrams of the solid ejection control according to Comparative Example 2 and are schematic diagrams illustrating movement of the ejected toner when the solid ejection control is executed. FIG. 10 is an explanatory diagram of voltage and potential control in the solid ejection control according to Comparative Example 2, and is a diagram schematically illustrating the potential of the photosensitive drum 1, the developing voltage, the transition of the primary transfer voltage, and the movement of the toner in the solid ejection control along the time axis. FIG. 10 illustrates a graph in which the vertical axis represents the potential/voltage and the horizontal axis represents the time, the surface potential (photosensitive drum potential) at a predetermined location moving with rotation of the photosensitive drum 1 is illustrated by the solid line, and the toner adhering to the part is illustrated together. In FIG. 10, A and B corresponds to FIGS. 9A and 9B, respectively.

The solid ejection control can be roughly divided into two processes: A. ejection of the toner from the developing unit 4; and B. transfer of the ejected toner. Note that the processes A and B correspond to FIGS. 9A and 9B, and ranges corresponding to the processes are indicated by arrows in FIG. 10 as well.

### A. Toner Ejection

FIG. 9A is a diagram illustrating a toner ejection process. In the solid ejection control, the toner inside the developing unit 4 is ejected onto the photosensitive drum 1 first as illustrated in FIG. 9A. Note that the potential relationship of each portion in the ejection process at the time of the solid ejection control is similar to that in A. ejection process (FIG. 8A) in Example 1 as illustrated in FIG. 10.

### B. Transfer of Ejected Toner

FIG. 9B is a diagram illustrating an ejected toner transfer process. After the toner ejected process, the toner ejected onto the photosensitive drum 1 is transferred as it is to the intermediate transfer belt 10 as illustrated in FIG. 9B. The transferred toner is then cleaned and accommodated by the cleaning device 16 and the waste toner accommodating container 17. In the transfer of the ejected toner according to Comparative Example 2, the primary transfer voltage was set to 700 V such that the transfer contrast ΔVtr3 satisfied ΔVtr3=800 V (=ΔVtr2) in order to transfer the toner ejected onto the photosensitive drum 1 to the intermediate transfer belt 10.

Evaluation tests were conducted on Comparative Example 2 in which the solid ejection control was performed and Example 1 in which (degraded toner) ejection control was performed. In the test, 250000 sheets with a XEROX Business 4200 LETTER size (Xerox; trade name) were fed as the recording materials P in an environment at a temperature of 23° C./a relative humidity of 50%, and the numbers of times of replacement of the waste toner accommodating container 17 were compared. Ejection control was performed every 50 sheets in Example 1, and solid ejection control was performed every 50 sheets in Comparative Example 2.

Since a high-yield printing toner was ejected every 50 sheets and sent to the waste toner accommodating container in Comparative Example 2, the waste toner accommodating container was replaced three times in total in the 250000-sheet feeding test.

On the other hand, in the ejection control of Example 1, although a high-yield printing toner was ejected every 50 sheets, a fresh toner therein was collected at the developing unit 4, and it was thus possible to reduce the amount of toner fed to the waste toner accommodating container 17 as compared with Comparative Example 2. Specifically, in the configuration of Example 1, about 50% of the toner ejected in one ejection control was collected at the developing unit 4. As a result, the test was completed with a total of one replacement of the waste toner accommodating container in the 250000-sheet feeding test, and the waste toner accommodating container was replaced a smaller number of times as compared with Comparative Example 2.

As described above, most of the degraded toner generated in association with utilization of the process cartridge S can be selectively ejected from the developing unit 4, and efficient ejection can be realized, by executing the aforementioned ejection control. Consequently, it is possible to provide an image forming apparatus that suppresses unnecessary toner consumption and reduces the replacement frequency of the waste toner accommodating container.

### Example 2

Next, Example 2 according to the present disclosure will be described. Hereinafter, only differences in configurations and effects of Example 2 from those of Example 1 will be described. In the configuration of Example 2, configurations similar to those in Example 1 will be denoted by the same reference signs, and description will be omitted.

In Example 1, the ejected toner is charged and is caused to pass without adhering to the charging roller 2, and the post-charging potential Vp is also formed at the same time, by applying a voltage of −1200 V from the charging power source 501 to the charging roller 2 when the ejected toner passes through the charging portion. On the other hand, Example 2 is different from Example 1 in that a pre-charging exposure device is provided to control the drum potential through pre-charging exposure before an ejected toner passes through a charging portion. In terms of the potential and the voltage, Example 2 is different from Example 1 in that a voltage of −1100 V, an absolute value of which is smaller than that of −1200 V, is applied to a charging roller 2. Note that control in the ejection control is also similar to that in Example 1 other than a value of a voltage to be applied to the charging roller 2 when the ejected toner passes through the charging portion and a post-charging potential Vp of a photosensitive drum 1 charged with a charging voltage.

### Description of Pre-Charging Exposure Device

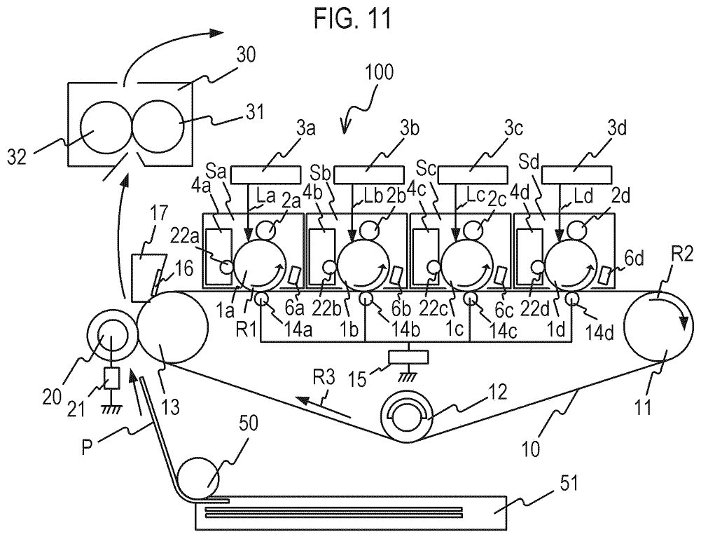

First, a pre-charging exposure device 6 will be described. FIG. 11 is a schematic sectional view illustrating an overview configuration of the image forming apparatus 100 of Example 2. The image forming apparatus 100 of Example 2 has a configuration similar to that of Example 1 other than that the pre-charging exposure device 6 is included.

The pre-charging exposure device 6 is disposed to face the photosensitive drum 1 and is configured to be able to exposure the surface of the photosensitive drum 1. In the rotation direction of the photosensitive drum 1, the pre-charging exposure device 6 is located on the downstream side of a primary transfer roller 14 and an upstream side of the charging roller 2. In other words, the image forming apparatus 100 is provided with a scanner unit 3 as a first exposure device and the pre-charging exposure device 6 as a second exposure device.

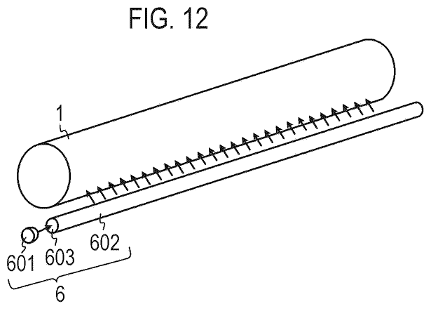

FIG. 12 is a schematic sectional view of a configuration of the pre-charging exposure device 6 according to Example 2. The pre-charging exposure device 6 is configured to include a light emitting element 601 and a light guide 602.

The light emitting element 601 is installed in an apparatus body of the image forming apparatus 100. On the other hand, the light guide 602 is a light guiding member for irradiating the photosensitive drum 1 with light of the light emitting element 601 and is provided in a cartridge tray (not illustrated) that holds a process cartridge S. The light guide 602 is disposed on the side further downstream than the primary transfer roller 14 and on the side further upstream than the charging roller 2 in the rotation direction of the photosensitive drum 1.

The light guide 602 is disposed such that the axial direction (longitudinal direction) thereof is substantially parallel to the axial direction of the photosensitive drum 1. One end portion of the light guide 602 in the axial direction is provided with a light incident portion 603 that receives light emitted from the light emitting element 601.

The amount of light emitted by the light emitting element 601 is controlled at a predetermined timing by a light emission amount control mechanism, which is not illustrated. The light guided to the light guide 602 becomes diffused light from a side surface of the light guide 602, the photosensitive drum 1 is irradiated therewith, and static elimination of the surface potential of the photosensitive drum 1 is thereby performed. This is because the surface charge of the photosensitive drum 1 after the primary transfer process is eliminated to smooth the surface potential. With such a configuration, the pre-charging exposure device 6 eliminates the surface potential of the photosensitive drum 1 to a predetermined potential (approximately 0 V in this example). In other words, the pre-charging exposure device 6 in this example is a static eliminating device that eliminates static from the surface of the photosensitive drum 1.

Although the amount of light emitted in the pre-charging exposure is adjusted to a predetermined amount of light set in advance in this example, the present disclosure is not limited to such a configuration. For example, a light receiving element for detecting the amount of light emitted in the pre-charging exposure may be disposed in the vicinity of the light emitting element 601, the light guide 602, and the photosensitive drum 1, and a mechanism to adjust the amount of light emitted by the pre-charging exposure device 6 may be provided. With such a configuration, the amount of light emitted by the pre-charging exposure device 6 can be adjusted in accordance with deterioration of the light emitting element 601, contamination of the light guide 602, and a change in light receiving sensitivity of the photosensitive drum 1.

Although the configuration in which the light guide 602 is disposed in the cartridge tray has been described, the present disclosure is not limited to such a configuration. For example, a configuration in which the light guide 602 is installed in the process cartridge S, a configuration using an LED array instead of the light guide 602, or a configuration in which the photosensitive drum 1 is directly irradiated with light without using the light guide 602 for further simplification of the apparatus may be adopted.

### Ejection Control

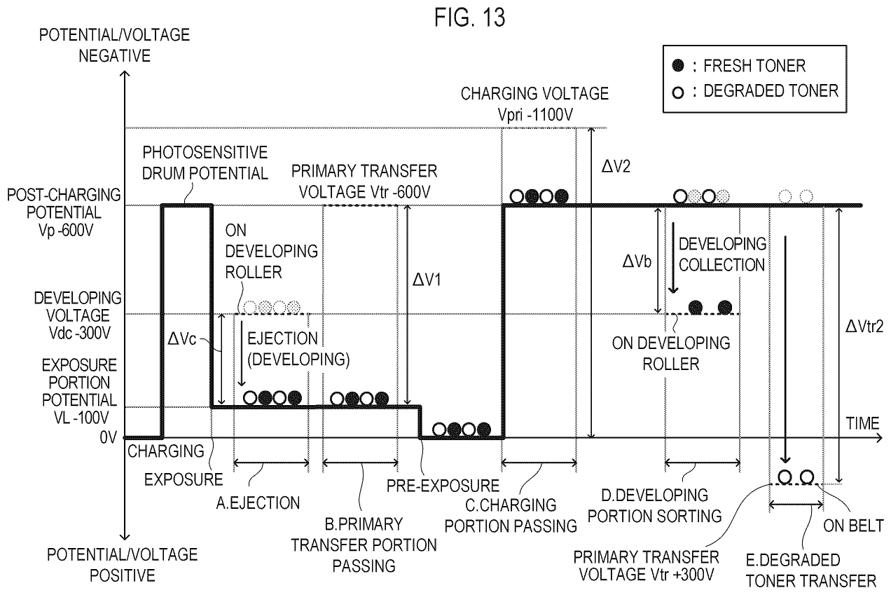

Movement of an ejected toner in ejection control in Example 2 is similar to that in Example 1. In other words, the ejected toner in the ejection control according to Example 2 moves similarly to the ejected toner in Example 1 illustrated in FIGS. 1A to 1F. Since only the potential of the photosensitive drum 1 and the charging voltage in the ejection control in Example 2 are different from those Example 1, the differences from Example 1 will be described with reference to FIG. 13.

FIG. 13 is an explanatory diagram of voltage and potential control in the ejection control according to Example 2, and is a diagram schematically illustrating a potential of the photosensitive drum 1, a developing voltage, transition of a primary transfer voltage, and movement of the toner in the ejection control along a time axis. FIG. 13 illustrates a graph in which the vertical axis represents the potential/voltage and the horizontal axis represents the time, a surface potential (photosensitive drum potential) at a predetermined location that moves with rotation of the photosensitive drum 1 is illustrated by the thick line, and the toner adhering to the part is illustrated together. In FIG. 13, ranges corresponding to the processes in the ejection control illustrated in FIGS. 1A to 1E are illustrated by the arrows.

Example 2 is different from Example 1 in the voltage and potential relationships in a range after B. passing of the ejected toner through the primary transfer portion and before D. the toner sorting at the developing portion in the processes of the ejection control. In Example 2, the pre-charging exposure device 6 eliminates the drum potential to 0 V after the ejected toner passes the primary transfer portion (between B. passing of the ejected toner through the primary transfer portion and C. passing of the ejected toner through the charging portion). Since a difference between the charging voltage Vpri and the drum potential entering the charging portion is the charging contrast ΔV2, the charging contrast ΔV2 can be increased by the amount corresponding to the potential eliminated by the pre-charging exposure device 6.

The selection of the charging voltage Vpri can be made more flexible by the pre-charging exposure device 6 performing static elimination. As described in Example 1, the charging contrast ΔV2 has a plurality of roles, and an increase in charging contrast ΔV2 within an appropriate range is preferable from the viewpoint of securing charging properties of the ejected toner, prevention of adhesion to the charging roller 2, and formation of the back contrast ΔVb. However, if the drum potential before entering the charging portion is the post-exposure potential VL (−100 V in the case of Example 1) as in Example 1, it becomes necessary to increase the charging voltage Vpri to increase the charging contrast ΔV2. If the charging voltage Vpri is excessively large, a load is likely to be imparted to a high-voltage element of the charging power source 501, and risks such as high-voltage oscillation and current leakage to the photosensitive drum 1 are likely to occur. The potential of the photosensitive drum 1 can be lowered to approximately 0 V through pre-charging exposure, and the charging contrast ΔV2 can be increased without increasing the charging voltage Vpri, by providing the pre-charging exposure device 6 as in this example.

Although the post-charging potential Vp is lower than that in Example 1 because the charging voltage Vpri is set to be lower than that in Example 1, the same potential as the post-weak exposure potential Vd=−600 V in Example 1 is formed. Therefore, it is possible to secure the back contrast ΔVb similar to that in Example 1 and to obtain effects similar to those of Example 1 in this example.

As described above, most of the degraded toner generated in association with utilization of the process cartridge S can be selectively ejected from the developing unit 4, and efficient ejection can be realized, by executing the aforementioned ejection control. Consequently, it is possible to provide an image forming apparatus that suppresses unnecessary toner consumption and reduces the replacement frequency of the waste toner accommodating container.

### Example 3

Next, Example 3 according to the present disclosure will be described. Hereinafter, only differences in configurations and effects of Example 3 from those of Example 1 will be described. In the configuration of Example 3, configurations similar to those in Example 1 will be denoted by the same reference signs, and description will be omitted. Note that an apparatus configuration of an image forming apparatus 100 according to Example 3 is similar to that of Example 2, and the image forming apparatus 100 includes a pre-charging exposure device 6.

In Example 3, control for efficiently processing a degraded toner in a way different from those in Examples 1 and 2 will be described. The degraded toner is a toner containing both positive and negative polarities. In Example 3, such a degraded toner containing both positive and negative polarities is ejected (developed) from a developing roller 22 of a developing unit 4 to a photosensitive drum 1, the toner with a negative polarity is caused to remain on the photosensitive drum 1 by a primary transfer portion, and the toner with a positive polarity is transferred to an intermediate transfer belt 10. Then, the toner with a negative polarity caused to remain on the photosensitive drum 1 is transferred to the intermediate transfer belt 10 after one turn without being re-collected at the developing roller 22, the toner with both polarities is thereby cleaned up by the cleaning device 16 and is then collected and processed in a waste toner accommodating container 17.

It is possible to eject a degraded toner from the inside of the developing unit 4 even under the control in Example 3 similarly to Examples 1 and 2. As a result, unnecessary toner consumption can be suppressed. It is possible to reduce the amount of toner to be collected in the waste toner accommodating container 17 at the same time and to thereby reduce the replacement frequency of the waste toner accommodating container. Note that for distinction from Examples 1 and 2, the toner ejected from the developing unit 4 will be referred to as a fogging toner, and the series of operations will be referred to as first fogging ejection control.

### Fogging

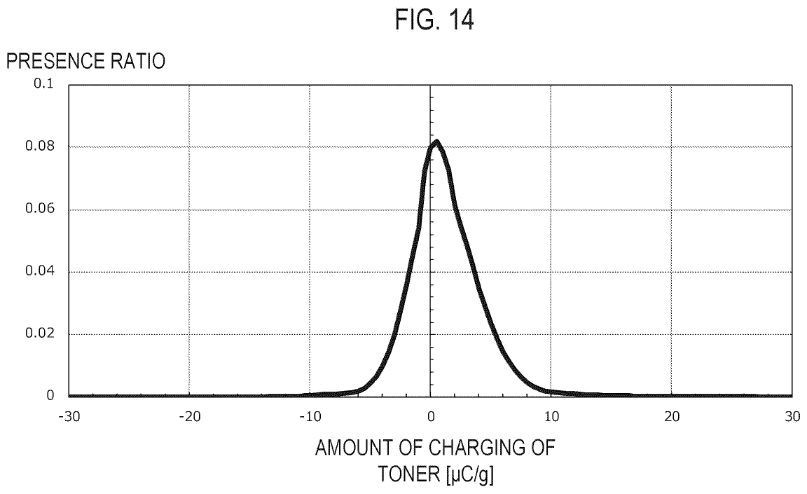

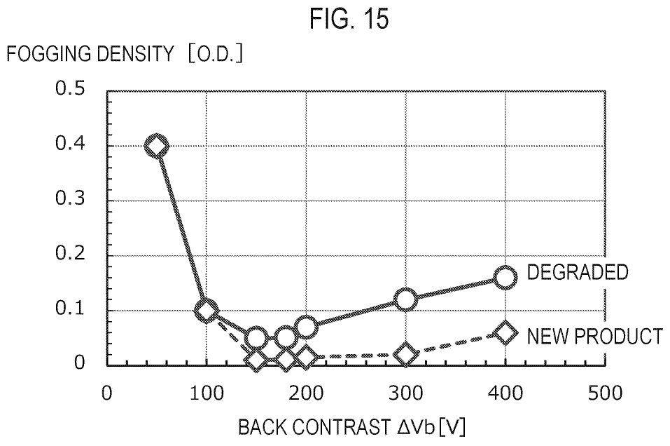

First, fogging will be described using FIGS. 14 and 15. FIG. 14 is an explanatory diagram of a charge quantity distribution of a fogging toner. FIG. 15 is an explanatory diagram of back contrast ΔVb dependency of the fogging toner according to Example 3.

When the toner is degraded (such as deformation of the toner, peeling-off of an external attachment, embedding of the external attachment), triboelectric properties due to rubbing against the developing blade 23 are lowered. This lowers fluidity of the toner in a case where toner deformation or external additive embedding progresses, for example, which thus leads to a decrease in rolling properties at the time of rubbing between the developing blade 23 and the developing roller 22. In a case where the peeling-off of the external additive of the toner progresses, the toner core is exposed, and it becomes impossible to exhibit desired charging properties. In this manner, as the toner degradation progresses, the triboelectric properties against the developing blade 23 decreases due to a decrease in fluidity and a decrease in charging properties. As a result, the degraded toner is brought into a state where most of them has the amount of charging of zero with the rest having a small amount of charging and containing both the positive and negative polarities.

At the time of developing the toner, the toner on the developing roller 22 is originally electrically held not to be transferred to the non-image region due to the back contrast ΔVb which is a potential difference between the developing voltage Vdc and the potential of the photosensitive drum 1 (the post-charging potential Vp or the post-weak exposure potential Vd). However, in a case where the degraded toner containing both positive and negative polarities is accommodated in the developing unit 4, the toner having a polarity (a positive polarity in this example) opposite to the normal charge polarity in the degraded toner is developed with the back contrast ΔVb. Also, even if the toner has a normal charge polarity (a negative polarity in this example), the amount of charge is small, a reflection force with the developing roller 22 is weak, and there is thus a case where the toner cannot be held on the developing roller 22 with the back contrast ΔVb and moves to the photosensitive drum 1. The toner developed differently from the toner developed with the developing contrast ΔVc in this manner will be referred to as a fogging toner, and the developing phenomenon will be referred to as fogging.

FIG. 14 illustrates a result of measuring a charge amount distribution for 3000 fogging toners generated from the developing unit 4 in a degraded state using an E-Spart analyzer manufactured by Hosokawa Micron Group. FIG. 14 is a graph in which the vertical axis represents the abundance ratio and the horizontal axis represents the amount of charging of the toner [μC/g]. As described above, it is possible to confirm in the graph that most of the fogging toner has the amount of charging of zero with the rest containing both the positive and negative polarities.

FIG. 15 is a graph in which the horizontal axis represents the back contrast ΔVb [V] and the vertical axis represents the fogging density [O.D.] (the amount of fogging toner). In the graph, the amount of fogging toner in a case where a toner in a new product (fresh) state is used is illustrated by the dashed line and the rhombus plot, and the amount of fogging toner in a case where a toner in a degraded state is used is illustrated by the solid line and the circle plot. The amount of fogging toner is a result measured by a Macbeth densitometer (manufacturer: GretagMacbeth LLC), and a larger value indicates a larger amount of fogging toner.

As illustrated in FIG. 15, in both the new product state and the degraded state, the amount of fogging toner is the smallest when the back contrast ΔVb is about 150 V to 180 V, and the fogging increases as the back contrast ΔVb increases. The fogging on the side where the back contrast ΔVb is large will be referred to as inverted fogging. Note that the fogging on the side where the back contrast ΔVb is small is the same phenomenon as an ordinary phenomenon and will be referred to as ground fogging for distinguishing it from the inverted fogging.

As illustrated in FIG. 15, the reason that the amount of fogging in the vicinity of ΔVb=150 V to 180 V increases in the degraded state as compared with the new product state is because of the decrease in reflection force with respect to the developing roller 22 due to toner degradation. Also, the reason that the inverted fogging increases in the degraded state compared to the new product state is because the toner with a positive polarity which is opposite to the normal charge polarity is developed on the photosensitive drum 1 due to the potential difference of ΔVb due to an influence of a decrease on triboelectric charging properties due to toner degradation and because the toner becomes unlikely to be charged with the normal charge polarity. Furthermore, the toner with a negative polarity, which is the normal charge polarity, in the degraded toner also has a small amount of charging as described above, and the toner is thus developed on the photosensitive drum 1 due to the potential difference of ΔVb. In this manner, the fogging toner contains both the positive and negative polarities and contains a large amount of degraded toner.

The image forming apparatus 100 according to Example 3 is configured to be able to execute first fogging ejection control by using the characteristics of fogging with respect to the back contrast ΔVb for the fogging toner containing both polarities and containing a large amount of degraded toner. In Example 3, the fogging toners with both the positive polarity and the negative polarity ejected from the developing roller 22 are transferred to the intermediate transfer belt 10 and are then cleaned up and removed by the cleaning device 16.

### First Fogging Ejection Control

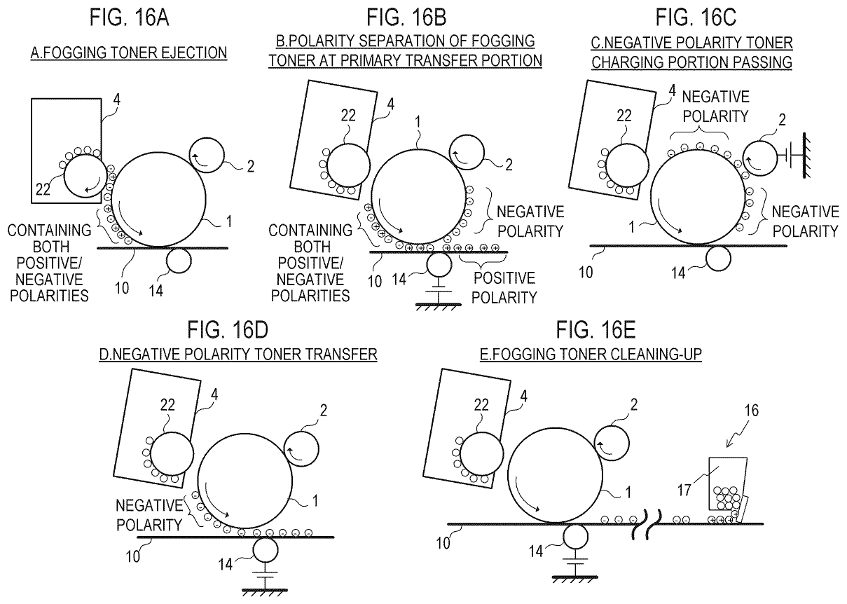

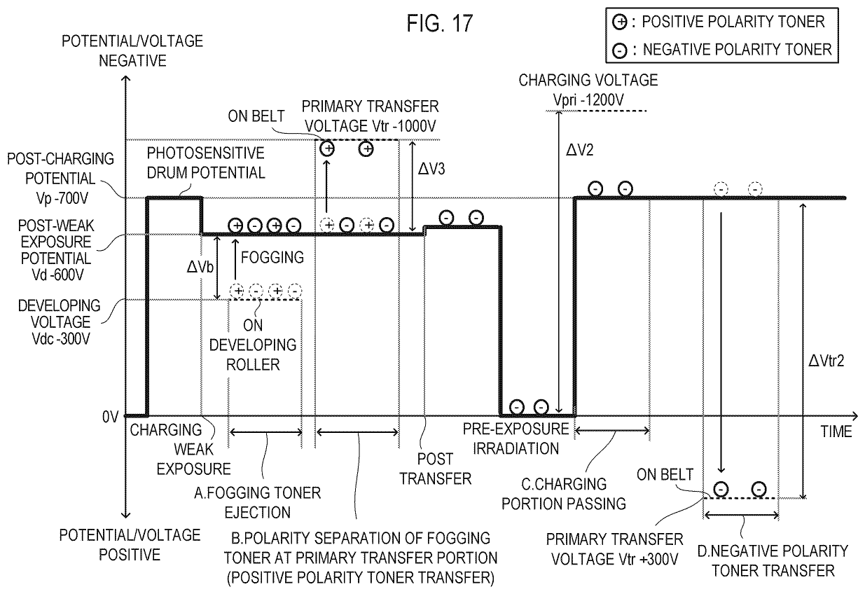

Next, the first fogging ejection control of this example will be described using FIGS. 16A to 16E and FIG. 17. FIGS. 16A to 16E are explanatory diagrams of the first fogging ejection control, and are schematic diagrams illustrating movement of the ejected toner when the ejection control is executed. FIG. 17 is an explanatory diagram of voltage and potential control in the first fogging ejection control, and is a diagram illustrating a potential of the photosensitive drum 1, a developing voltage, transition of a primary transfer voltage, and movement of the toner in the first fogging ejection control along the time axis. FIG. 17 illustrates a graph in which the vertical axis represents the potential/voltage and the horizontal axis represents the time, a surface potential (photosensitive drum potential) at a predetermined location moving with rotation of the photosensitive drum 1 is illustrated by the thick line, and the toner adhering to the part is also illustrated together. In a case where the positive polarity toner and the negative polarity toner are distinguished in each of the drawings used in the following description, the positive polarity toner is illustrated by a circle with “+” written therein, and the negative polarity toner is illustrated by a circle with “−” written therein.

This control is roughly categorized into processes: A. ejection of the fogging toner inside the developing unit 4; B. polarity separation of the fogging toner at the primary transfer portion; C. passing of the negative polarity fogging toner through the charging portion; D. transfer of the negative polarity fogging toner; and E. cleaning of the fogging toner. Each process will be described below. Note that the processes A to E correspond to FIGS. 16A to 16E, respectively, and ranges corresponding to the processes A to D are illustrated by the arrows in FIG. 17 as well.

A. Ejection of Fogging Toner inside Developing Unit 4

FIG. 16A is a diagram illustrating a state of an ejection process of the fogging toner inside the developing unit 4. Once the operation of the first fogging ejection control is started, the photosensitive drum 1 is uniformly charged to a predetermined potential (post-charging potential VP=−700 V) with a negative polarity by the charging roller 2 in the rotating process. Almost simultaneously, a predetermined voltage (developing voltage Vdc=−300 V) is applied to the developing roller 22 as well. The surface of the photosensitive drum 1 charged to the prescribed post-charging potential Vp is adjusted to a predetermined potential (post-weak exposure potential Vd=−600 V) through non-image portion weak exposure. Once the drum surface charged to the post-weak exposure potential Vd passes through the portion in contact with the developing roller 22, the fogging toner containing both positive and negative polarities is developed (moved to the surface of the photosensitive drum 1) with the back contrast ΔVb=300V.

In this example, the back contrast ΔVb is set to 300 V, and the absolute value of the back contrast ΔVb is set to be greater than that in the image forming operation (ΔVb=180 V in this example) when fogging is caused in the first fogging ejection control. This is for causing more fogging toner with a positive polarity that is different from the normal charge polarity to be developed as described in FIGS. 14 and 15.

Furthermore, the length of the fogging ejected toner, which is ejected at a time (under one fogging ejection control), in the rotation direction of the photosensitive drum 1 is preferably equal to or greater than the length of one turn of the developing roller 22 and is preferably within the length of the one turn of the photosensitive drum 1. Since it is assumed that the toner in the vicinity of the developing roller 22 is likely to be consumed, the length of the fogging ejected toner is preferably equal to or greater than the length of one turn of the developing roller 22 in order to eject all the toners with which the developing roller 22 is coated immediately before the first fogging ejection control. On the other hand, in order to prevent the fogging toner from being collected at the developing roller 22 after one turn of the photosensitive drum 1, the length of the fogging ejected toner is preferably within one turn of the photosensitive drum 1.

In this example, the fogging toner with a length of 44.8 mm (=10 mm×3.14÷1.4×2) corresponding to two turns of the developing roller 22 is ejected at a time. The length of one turn of the photosensitive drum 1 is 62.8 mm (=20 mm×3.14), and the length of the fogging ejected toner ejected at a time in the rotation direction of the photosensitive drum 1 is less than the length of one turn of the photosensitive drum 1.

After the fogging toner with the predetermined length is developed, the developing roller 22 is immediately separated from the photosensitive drum 1, and the rotation of the developing roller 22 is stopped. This is for avoiding unnecessary rubbing of the toner on the developing roller 22 against the developing blade 23 and for avoiding collection of the fogging toner by the developing roller 22 after one turn of the photosensitive drum 1.

### B. Polarity Separation of Fogging Toner at Primary Transfer Portion

FIG. 16B is a diagram illustrating a state of a polarity separation process of the fogging toner at the primary transfer portion. In this process, passing of the negative polarity toner through the transfer portion and transfer of the positive polarity toner to the intermediate transfer belt 10 are performed.

When the fogging toner passes through the primary transfer portion for the first time, a voltage of −1000 V is applied from the primary transfer power source 15 to the primary transfer roller 14. As illustrated in FIG. 16B, a potential difference ΔV3 is formed between the photosensitive drum 1 and the intermediate transfer belt 10 at the primary transfer portion such that the negative polarity toner remains on the photosensitive drum 1 and the positive polarity toner is transferred to the intermediate transfer belt 10. The potential difference ΔV3 is a potential difference between the surface potential (post-weak exposure potential Vd) of the photosensitive drum 1 and the primary transfer voltage Vtr, and in this example, ΔV3=Vd−Vtr=400 V. As a result, only the positive polarity toner is transferred to the intermediate transfer belt 10 with the photosensitive drum 1 bearing the negative polarity toner, in the ejected fogging toner as illustrated in FIG. 16B.

If the potential formed on the intermediate transfer belt 10 is a potential that has a negative polarity and is greater than the absolute value of the surface potential of the photosensitive drum 1, a potential difference ΔV3 with which the positive polarity toner can be transferred to the intermediate transfer belt 10 is formed while the negative polarity toner in the fogging toner is caused remain on the photosensitive drum 1. The absolute value of the potential difference ΔV3 is preferably equal to or greater than the transfer contrast ΔVtr1 (250 V in this example) at the time of the image formation. As described above, the fogging toner contains a large amount of degraded toner and has a high non-electrostatic adhesion force. Therefore, there is a concern that the fogging toner (a positive polarity fogging toner in this example) cannot be transferred to the intermediate transfer belt 10 when the potential difference ΔV3 is about the transfer contrast ΔVtr1 at the time of ordinary image formation. Therefore, the negative polarity toner can be caused to remain on the photosensitive drum 1, and the positive polarity toner can be transferred to the intermediate transfer belt 10 at the same time, by setting the potential difference ΔV3 to be equal to or greater than the transfer contrast ΔVtr1 at the time of the image formation. Note that if the potential difference ΔV3 is excessively large, there is a concern that abnormal discharge may occur at the primary transfer portion and the polarity of the ejected toner may be inverted, and the potential difference ΔV3 is thus preferably less than 1500 V in the configuration of this example. In this example, a potential of −1000 V is formed on the intermediate transfer belt 10 by the primary transfer power source 15 such that the absolute value of the potential difference ΔV3 becomes 400 V.

### C. Passing of Negative Polarity Fogging Toner Through Charging Portion

FIG. 16C is a diagram illustrating a state of a charging portion passing process of the negative polarity fogging toner. Movement of the negative polarity fogging toner that has passed through the primary transfer portion and remains on the photosensitive drum 1 will be described. Note that a method of processing the positive polarity fogging toner transferred to the intermediate transfer belt 10 will be described separately with a method of processing the negative polarity fogging toner.

It is necessary to cause the negative polarity fogging toner remaining on the photosensitive drum 1 to pass through the charging portion without adhering to the charging roller 2. At this time, the fogging toner is caused to pass through the position (charging portion) where the charging roller 2 and the photosensitive drum 1 come into contact with each other with the charging contrast ΔV2 which is the potential difference between the surface potential of the photosensitive drum 1 and the charging voltage Vpri.

In this example, the potential of the photosensitive drum 1 may be slightly displaced by the potential difference ΔV3=400 V in the process B. In addition, from the viewpoint of securing sufficient charging contrast ΔV2, the pre-charging exposure device 6 eliminates the potential of the photosensitive drum 1 to approximately 0 V. As illustrated in FIG. 17, a voltage with a negative polarity of −1200 V is applied to the charging roller 2, and the charging contrast ΔV2 is controlled to 1200 V when the negative polarity fogging toner passes through the charging portion. As a result, the negative polarity fogging toner passes through the charging portion while the photosensitive drum 1 bears the negative polarity fogging toner as illustrated in FIG. 16C. Since the post-charging potential Vp is also formed at the same time, the potential of the photosensitive drum becomes−700 V. The charging contrast ΔV2 is sufficient if it is equal to or greater than the charging contrast at the time of the image forming operation (the charging contrast ΔV2 at the time of the image forming operation in this example is 1200 V).

Note that in a case of an image forming apparatus having no pre-charging exposure device 6 as described in Example 1, the charging contrast ΔV2 may be secured by increasing the charging voltage Vpri.

### D. Transfer of Negative Polarity Fogging Toner

FIG. 16D is a diagram illustrating a state of a transfer process of the negative polarity fogging toner. The negative polarity fogging toner that has passed through the charging portion reaches the primary transfer portion again, and is transferred to the intermediate transfer belt 10. As described above, since the developing roller 22 is spaced apart from the photosensitive drum 1, the fogging toner reaches the primary transfer portion without being collected by the developing roller 22.

In this process, the primary transfer voltage Vtr with a positive polarity is applied to transfer the negative polarity toner to the intermediate transfer belt 10. The negative polarity toner on the photosensitive drum 1 is transferred to the intermediate transfer belt 10 by the transfer contrast ΔVtr2 between the photosensitive drum potential and the primary transfer voltage Vtr. Since the fogging toner contains a large amount of degraded toner having increased non-electrostatic adhesion force, it is difficult to transfer the fogging toner to the intermediate transfer belt 10 with a potential difference similar to that during ordinary image formation. Therefore, it is necessary to set the transfer contrast ΔVtr2 such that the degraded toner can be transferred to the intermediate transfer belt 10. Specifically, it is preferable to set the transfer contrast ΔVtr2 to be greater than the transfer contrast ΔVtr1 at the time of the ordinary image forming operation. However, since there is a concern that if the transfer contrast ΔVtr2 is excessively large, abnormal discharge may occur at the primary transfer portion, the transfer contrast ΔVtr2 is preferably less than about 2000 V.

In this example, the transfer is performed with a transfer contrast ΔVtr2=1000 V between the post-charging potential Vp=−700 V and the primary transfer voltage Vtr=+300 V in the transfer process of the degraded toner to the intermediate transfer belt 10. Note that although the potential of the photosensitive drum is not adjusted through weak exposure in this example, the potential of the drum may be adjusted through weak exposure if an appropriate transfer contrast ΔVtr2 can be secured.

### E. Cleaning-up of Fogging Toner

FIG. 16E is a diagram illustrating a state of a cleaning-up process of the fogging toner. Processing of the fogging toner transferred to the intermediate transfer belt 10 will be described.

The fogging toners with a positive polarity and a negative polarity transferred to the intermediate transfer belt 10 are sent to the cleaning device 16 by rotation of the intermediate transfer belt 10 and are then collected and processed in the waste toner accommodating container 17.

As described above, according to the configuration of Example 3, it is possible to send only the fogging toner containing a large amount of degraded toner to the waste toner accommodating container 17 and to thereby lower the ratio of the degraded toner inside the developing unit 4. As a result, it is possible to suppress unnecessary toner consumption and to prolong the lifetime of the developing unit 4. At the same time, it is possible to reduce the amount of toner to be sent to the waste toner accommodating container 17 as compared with Example 1 and to thereby reduce the replacement frequency of the waste toner accommodating container by the user.

As described above, most of the degraded toner generated in association with utilization of the process cartridge S can be selectively ejected from the developing unit 4 by executing the first fogging ejection control described above, and it is thus possible to realize efficient ejection. Consequently, it is possible to provide an image forming apparatus that suppresses unnecessary toner consumption and reduces the replacement frequency of the waste toner accommodating container. Furthermore, the control of Example 3 exhibits a more significant effect by being combined with the control of Example 1. Specifically, quality of the degraded toner to be discarded to the cleaning device 16 can be improved by combining Example 3 and Example 1. Since the proportion of the degraded toner is reduced by performing the control of Example 3 and the control of Example 1 together, it is possible to increase the amount of toner to be collected again.

### Example 4

Next, Example 4 according to the present disclosure will be described. Hereinafter, only differences in configurations and effects of Example 4 from those of Example 3 will be described. In the configuration of Example 4, configurations similar to those in Example 3 will be denoted by the same reference signs, and description will be omitted.

In Example 4, control for efficiently processing the fogging toner (degraded toner) by another mechanism will be described similarly to Example 3. In Example 3, control in which the positive polarity toner in the fogging toner containing a large amount of degraded toner is first transferred to the intermediate transfer belt 10 and the negative polarity toner is temporarily caused to remain on the photosensitive drum 1 and is then transferred to the intermediate transfer belt 10 without being collected by the developing roller 22 has been described. In Example 3, all of the fogging toner is processed by the cleaning device 16. In Example 4, control in which a negative polarity toner in a fogging toner is transferred to an intermediate transfer belt 10 first, a positive polarity toner is temporarily caused to remain on a photosensitive drum 1 and is then transferred to the intermediate transfer belt 10 without being collected by the developing roller 22 unlike Example 3 will be described.

According to the control of Example 4, the fogging toner can be ejected from a developing unit 4 with efficiency equal to or greater than that of Example 3. As a result, it is possible to more effectively suppress unnecessary toner consumption. Note that for distinction from Examples 1, 2, and 3, ejection control performed in Example 4 will be referred to as second fogging ejection control, and parts similar to those in Examples 1, 2, and 3 will be denoted by the same reference signs, and description will be omitted. The following description will be given on the basis of the image forming apparatus of Example 2.

### Second Fogging Ejection Control

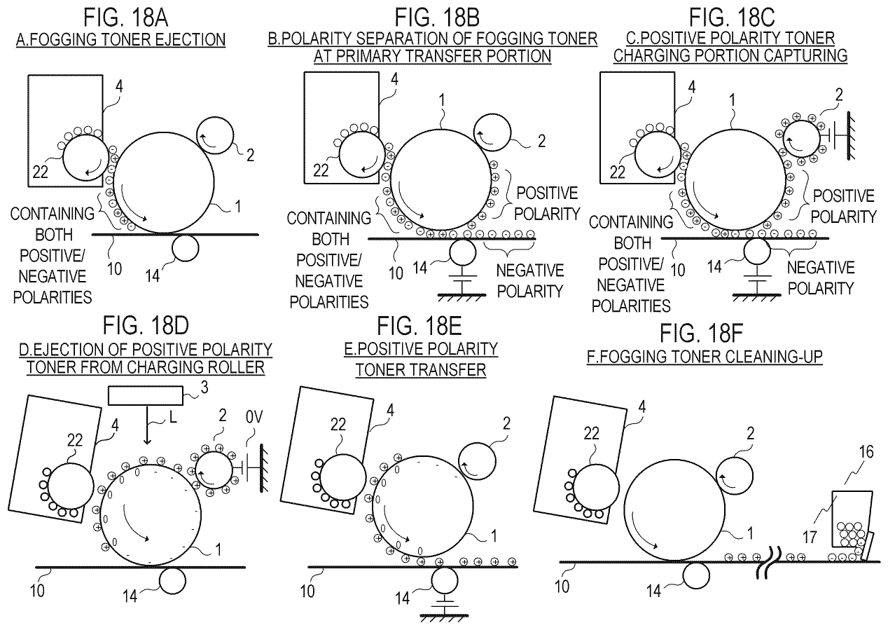

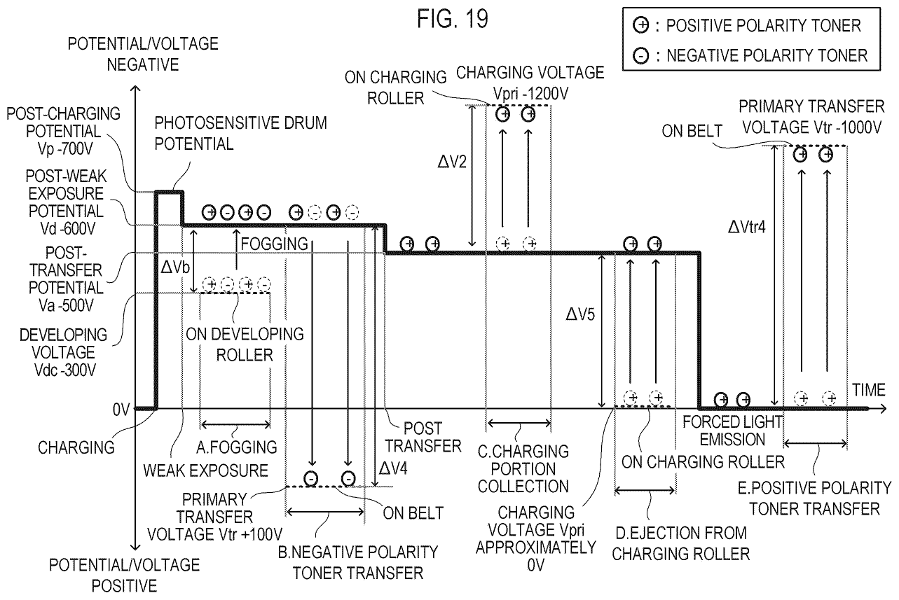

The second fogging ejection control of this example will be described using FIGS. 18A to 18F and FIG. 19. FIGS. 18A to 18F are explanatory diagrams of the second fogging ejection control, and are schematic diagrams illustrating movement of the ejected toner when the ejection control is executed. FIG. 19 is an explanatory diagram of voltage and potential control in the second fogging ejection control, and is a diagram schematically illustrating a potential of the photosensitive drum 1, a developing voltage, transition of a primary transfer voltage, and movement of the toner in the second fogging ejection control along a time axis. FIG. 19 illustrates a graph in which the vertical axis represents the potential/voltage and the horizontal axis represents the time, a surface potential (photosensitive drum potential) at a predetermined location moving with rotation of the photosensitive drum 1 is illustrated by the thick line, and the toner adhering to the part is also illustrated together.

This control is roughly categorized into processes: A. fogging ejection of the toner inside the developing device; B. polarity separation of the fogging toner at the primary transfer portion; C. collection of a positive polarity fogging toner at the charging roller; D. charging roller ejection of the positive polarity fogging toner; E. transfer of the positive polarity fogging toner; and F. cleaning-up of the fogging toner. Each process will be described below. Note that the processes A to F correspond to FIGS. 18A to 18F, respectively, and ranges corresponding to the processes A to E are illustrated by the arrows in FIG. 19 as well.

A. Fogging Ejection of Toner inside Developing Device

FIG. 18A is a diagram illustrating an ejection process of the fogging toner in the developing unit 4. Similarly to the first fogging ejection control of Example 3, once the operation of the second fogging ejection control is started, the photosensitive drum 1 is charged to a predetermined potential (post-charging potential Vp=−700 V) by the charging roller 2. A predetermined voltage (developing voltage Vdc=−300 V) is also applied to the developing roller 22 at substantially the same time. The surface of the photosensitive drum 1 charged to the post-charging potential VP=−700 V is adjusted to a prescribed potential (post-weak exposure potential Vd=−600 V) through non-image portion weak exposure. When the drum surface charged to the post-weak exposure potential Vd passes through the portion in contact with the developing roller 22, the fogging toner containing both the positive and negative polarities is developed (moved to the surface of the photosensitive drum 1). Note that in this example, the back contrast ΔVb is set to 300 V when fogging is caused, which is greater than the back contrast ΔVb=180 V at the time of the image formation, similarly to Example 3.

Furthermore, the length of the fogging ejected toner ejected at a time (under one fogging ejection control) in the rotation direction of the photosensitive drum 1 is preferably equal to or greater than the length of one turn of the developing roller 22 similarly to Example 3. However, as a difference from Examples 1, 2, and 3, the length of the ejected toner may be a length of equal to or greater than one turn of the photosensitive drum 1, and the length of the fogging ejected toner can be elongated as long as it is possible to capture the positive polarity fogging toner by the charging roller 2 with the amount. Therefore, it is possible to increase the amount of degraded toner to be ejected under one control as compared with Examples 1, 2, and 3. As a result, according to the configuration of Example 4, it is possible to reduce the number of times this control is executed throughout the lifetime of the process cartridge S and to thereby obtain an effect of reducing a downtime throughout the lifetime.

In this example, setting is made to eject the fogging toner with the length of 267 mm (=8.5 mm×3.14×10) corresponding to ten turns of the charging roller 2 at once. However, the amount of ejected toner is not limited thereto and can be appropriately set in accordance with the amount of fogging toner.

### B. Polarity Separation of Fogging Toner at Primary Transfer Portion

FIG. 18B is a diagram illustrating a state of a polarity separation process of the fogging toner at the primary transfer portion. In this process, passing of the positive polarity toner through the transfer portion and transfer of the negative polarity toner to the intermediate transfer belt 10 are performed.

When the fogging toner passes through the primary transfer portion for the first time, a voltage of +100 V is applied from the primary transfer power source 15 to the primary transfer roller 14. As illustrated in FIG. 18B, a potential difference ΔV4 is formed between the photosensitive drum 1 and the intermediate transfer belt 10 at the primary transfer portion such that the negative polarity toner is transferred to the intermediate transfer belt 10 and the positive polarity toner remains on the photosensitive drum 1. At this time, if the potential formed on the intermediate transfer belt 10 is on the positive side as compared with the potential of the photosensitive drum, then the positive polarity toner in the fogging toner can be caused to remain on the photosensitive drum 1, and the negative polarity toner can be transferred to the intermediate transfer belt 10.

The absolute value of the potential difference ΔV4 is preferably equal to or greater than a transfer contrast ΔVtr1 (250 V in this example) at the time of the image formation from the viewpoint of transferring the negative polarity fogging toner containing a large amount of degraded toner. However, if the potential difference ΔV4 is excessively large, there is a concern that abnormal discharge may occur at the primary transfer portion and the polarity of the ejected toner may be inverted or a concern that the drum potential after the transfer becomes a positive polarity, and the potential difference ΔV4 is thus preferably less than 1500 V in the configuration of this example. In this example, a potential (primary transfer voltage Vtr) of +100 V is formed on the intermediate transfer belt 10 by the primary transfer power source 15 such that the absolute value of the potential difference ΔV4 becomes 700 V.

### C. Capturing of Positive Polarity Fogging Toner by Charging Roller

FIG. 18C is a diagram illustrating a state of a charging roller capturing process of the positive polarity fogging toner. Movement of the positive polarity fogging toner that has passed through the primary transfer portion and remains on the photosensitive drum 1 will be described. Note that a method of processing the negative polarity fogging toner transferred to the intermediate transfer belt 10 will be described separately with a method of processing the positive polarity fogging toner.

In the second fogging ejection control, the positive polarity fogging toner remaining on the photosensitive drum 1 is temporarily captured by the charging roller 2 to which a voltage with a negative polarity is applied. At this time, the positive polarity fogging toner is moved from the photosensitive drum 1 to the charging roller 2 by the charging contrast ΔV2 between the photosensitive drum 1 and the charging voltage Vpri. Note that in this example, the surface potential of the photosensitive drum 1 is not eliminated by the pre-charging exposure device 6. This is because it is necessary to eject the positive polarity fogging toner from the charging roller 2 to the photosensitive drum 1 in the subsequent process. Therefore, the potential of the photosensitive drum reaching the charging portion in this process is a potential (referred to as a post-transfer potential Va) slightly displaced from the post-weak exposure potential Vd (−600 V) due to the potential difference ΔV4 (700 V). In this example, the post-transfer potential Va is set to −500 V.

Accordingly, the charging contrast ΔV2 in this example is the difference between the post-transfer potential Va=−500 V and the charging voltage Vpri=−1200 V, and in this example, the charging contrast ΔV2 is set to 700 V. As a result, the positive polarity fogging toner adheres to the charging roller 2 from the photosensitive drum 1 due to the charging contrast ΔV2 as illustrated in FIG. 18C. Note that it is preferable that the charging contrast ΔV2 be equal to or less than a discharge start voltage. This is because a large amount of toner can be caused to adhere to the charging roller 2 by increasing the potential difference, while there is a concern that the polarity of the toner is inverted at the time of discharge. Furthermore, there is also a concern that the toner on the side of the charging roller 2 may turn negative (have a negative polarity) through rubbing in the subsequent rotation of the photosensitive drum 1. Accordingly, it is preferable that the charging contrast ΔV2 in the charging roller capturing process be less than the charging contrast at the time of the image formation.

### D. Charging Roller Ejection of Positive Polarity Fogging Toner

FIG. 18D is a diagram illustrating a state of a charging roller ejection process of the positive polarity fogging toner. After a fixed amount of positive polarity fogging toner is captured by the charging roller 2, the captured positive polarity fogging toner is ejected from the charging roller 2 to the photosensitive drum 1. Prior to the ejection of the positive polarity fogging toner, the developing roller 22 is spaced apart from the photosensitive drum 1. This is for avoiding collection of the fogging toner ejected from the charging roller 2 in the developing roller 22.

In this example, approximately 0 V is applied to the charging roller 2 in order to eject the positive polarity fogging toner from the charging roller 2. The surface potential of the photosensitive drum 1 when it reaches the charging portion is a post-transfer potential Va=−500 V. The positive polarity fogging toner collected from the charging roller 2 to the photosensitive drum 1 is ejected by the potential difference ΔV5 (ΔV5=500 V in this example) between the post-transfer potential Va (−500 V) and the charging voltage Vpri (approximately 0 V) as illustrated in FIG. 18D.

The absolute value of the potential difference ΔV5 is preferably equal to or greater than the transfer contrast ΔVtr1 (250 V in this example) at the time of the image formation in order to eject the positive polarity fogging toner containing a large amount of degraded toner to the photosensitive drum 1. Note that although the potential difference ΔV5 is formed by applying 0 V to the charging voltage Vpri in this example, the present disclosure is not limited thereto, and both the post-transfer potential Va and the charging voltage Vpri may be adjusted such that the potential difference ΔV5 becomes equal to or greater than the transfer contrast ΔVtr1.

The surface of the photosensitive drum 1 from which the positive polarity fogging toner has been ejected is eliminated to approximately 0 V by the scanner unit 3 (hereinafter referred to as forced light emission). In this manner, the transfer contrast ΔVtr4 is secured as a potential difference (a difference between the surface potential of the photosensitive drum 1 and the primary transfer voltage Vtr) in the transfer of the positive polarity fogging toner in the next process.

### E. Transfer of Positive Polarity Fogging Toner

FIG. 18E is a diagram illustrating a state of a transfer process of the positive polarity fogging toner. The positive polarity fogging toner ejected from the charging roller 2 reaches the primary transfer portion again and is then transferred to the intermediate transfer belt 10. At this time, since the developing roller 22 is spaced apart from the photosensitive drum 1, the fogging toner reaches the primary transfer portion without being collected by the developing roller 22.

In this process, a primary transfer voltage Vtr with a negative polarity is applied to transfer the positive polarity toner. The positive polarity toner is transferred to the intermediate transfer belt 10 by the transfer contrast ΔVtr4 of the potential (approximately 0 V) of the photosensitive drum 1 and the primary transfer voltage Vtr. Since the fogging toner contains a large amount of degraded toner having an increased non-electrostatic adhesion force, it is difficult to transfer the fogging toner to the intermediate transfer belt 10 with a potential difference similar to that during ordinary image formation. Therefore, it is necessary to set the transfer contrast ΔVtr4 such that the degraded toner can be transferred to the intermediate transfer belt 10. Specifically, the transfer contrast ΔVtr4 is preferably greater than the transfer contrast ΔVtr1 (250 V in this example) during the ordinary image forming operation. However, since there is a concern that if the transfer contrast ΔVtr4 is excessively large, abnormal discharge may occur at the primary transfer portion, the transfer contrast ΔVtr4 is preferably less than about 2000 V.

In this example, the transfer of the positive polarity fogging toner to the intermediate transfer belt 10 is performed with the transfer contrast ΔVtr4=1000 V between the potential of approximately 0 V of the photosensitive drum after the forced light emission and the primary transfer voltage Vtr=−1000 V Note that although the potential of the photosensitive drum is eliminated to 0 V through the forced light emission in this example, the present disclosure is not limited thereto, and the potential of the photosensitive drum may not be eliminated to 0 V as long as it is possible to secure the appropriate transfer contrast ΔVtr4.

### F. Cleaning-up of Fogging Toner

FIG. 18F is a diagram illustrating a state of a cleaning-up process of the fogging toner. Processing of the fogging toner transferred to the intermediate transfer belt 10 will be described.

The fogging toners with a positive polarity and a negative polarity transferred to the intermediate transfer belt 10 are sent to the cleaning device 16 by rotation of the intermediate transfer belt 10 and are then collected and processed in the waste toner accommodating container 17.

As described above, according to the configuration of Example 4, it is possible to send only the fogging toner containing a large amount of degraded toner to the waste toner accommodating container 17 and to thereby obtain effects similar to those of Examples 1, 2, and 3. Furthermore, since it is possible to perform temporary capturing at the charging roller 2 in Example 4, it is possible to prolong the length of the ejected toner in one control as compared with Example 3. As a result, it is possible to suppress a downtime occurrence frequency. Further, the control of Example 4 exhibits more significant effects by being combined with the control of Example 1 similarly to the control of Example 3. Specifically, quality of the degraded toner to be discarded to the cleaning device 16 can be improved by combining Example 3 and Example 1. Since the proportion of the degraded toner is reduced by performing the control of Example 3 and the control of Example 1 together, it is possible to increase the amount of toner to be collected again.

### Modification 1

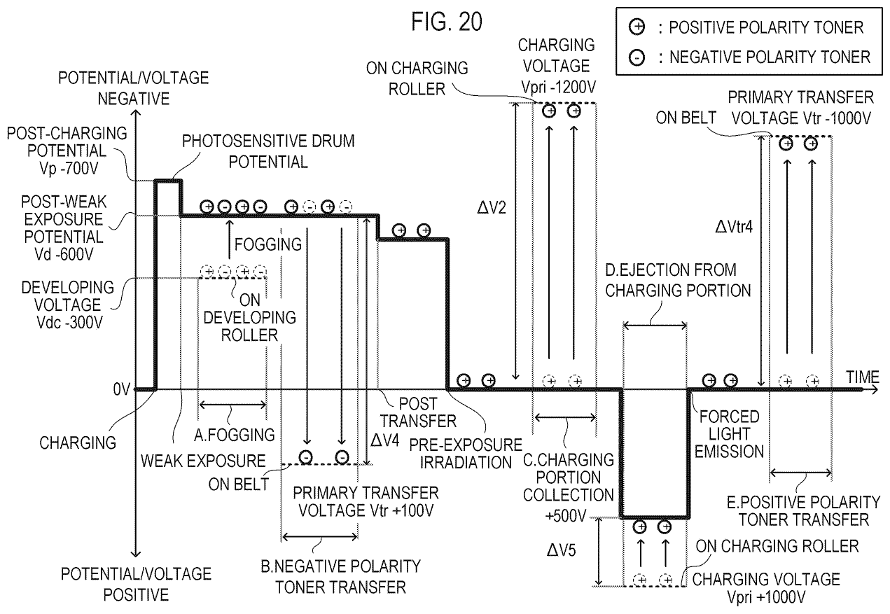

Next, Modification 1 of Example 4 will be described. Although the pre-charging exposure is not performed immediately before the capturing of the positive polarity fogging toner at the charging roller 2 in Example 4, the potential of the photosensitive drum 1 may be eliminated through pre-charging exposure. Differences of the control in that case from Example 4 will be described using FIG. 20.

FIG. 20 is an explanatory diagram of voltage and potential control in the second fogging ejection control according to Modification 1, and is a diagram schematically illustrating a potential of the photosensitive drum 1, a developing voltage, transition of a primary transfer voltage, and movement of the toner in the second fogging ejection control along a time axis. FIG. 20 illustrates a graph in which the vertical axis represents the potential/voltage and the horizontal axis represents the time, a surface potential (a potential of the photosensitive drum) at a predetermined location moving with rotation of the photosensitive drum 1 is illustrated by the thick line, and the toner adhering to the part is also illustrated together.

First, in a case where the pre-charging exposure is performed immediately before the positive polarity fogging toner is captured by the charging roller 2, the positive polarity fogging toner moves to the charging roller 2 similarly to Example 4. Thereafter, when the positive polarity fogging toner is ejected from the charging roller 2, it is necessary to move the positive polarity fogging toner from the charging roller 2 to the surface of the photosensitive drum 1 that has been subjected to static elimination to approximately 0 V. Therefore, in Modification 1, a voltage with a positive polarity is applied to the charging roller 2. Although the positive polarity fogging toner moves from the charging roller 2 to the photosensitive drum 1 at this time, the potential of the photosensitive drum is charged to the positive polarity at the same time. In this modification, a charging voltage Vpri of +1000 V is applied to the charging roller 2 in ejection of the positive polarity fogging toner from the charging roller 2, and the surface potential of the photosensitive drum 1 formed at that time is +500 V. Accordingly, in this modification, the scanner unit 3 performs forced light emission similarly to Example 4 to perform static elimination to approximately 0 V. This results in the same state as that in FIG. 18E and the portion E in FIG. 19 in Example 4. Since the subsequent operations are similar to those in Example 4, description thereof will be omitted.

### Other Configurations

Although the positive polarity fogging toner is temporarily collected by the charging roller 2 in Example 4, the present disclosure is not limited to such a configuration. For example, instead of the charging roller 2, a capturing member that comes into contact with the photosensitive drum 1 and charges the photosensitive drum 1 to thereby temporarily capture the positive polarity fogging toner may be provided. At this time, a configuration may be made such that the voltage applied to the capturing member is controlled by the engine control portion 210 similarly to other applied voltages. The temporary capturing member is preferably disposed on the upstream side of the charging roller 2 (charging portion) and the downstream side of the primary transfer roller 14 (transfer portion) in the rotation direction of the photosensitive drum 1.

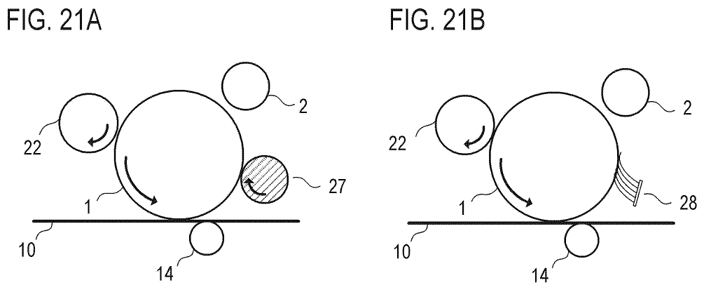

FIGS. 21A and 21B are explanatory diagrams of other configuration examples according to Example 4. FIG. 21A illustrates a construction in which a urethane sponge roller 27 is disposed as the temporary capturing member. FIG. 21B illustrates a configuration in which a brush-shaped capturing member 28 is disposed as a temporary capturing member. Furthermore, the temporary capturing member may be a non-contact type charging member instead of a contact type. Moreover, in a case where the temporary capturing member is provided, the charging member such as the charging roller 2 may not be of a contact type and may be a non-contact type charging member.

As described above, most of the degraded toner generated in association with utilization of the process cartridge S can be selectively ejected from the developing unit 4 by executing the above-described second fogging ejection control, and it is thus possible to realize efficient ejection. Consequently, it is possible to provide an image forming apparatus that suppresses unnecessary toner consumption and reduces the replacement frequency of the waste toner accommodating container.

### Example 5

Next, Example 5 according to the present disclosure will be described. Hereinafter, only differences in configurations and effects of Example 5 from those of Example 1 will be described. In the configuration of Example 5, configurations similar to those in Example 1 will be denoted by the same reference signs, and description will be omitted.

Although ejection control is performed in this example similarly to Example 1, this example is different from Example 1 in that an absolute value of a difference between a voltage applied to a regulating member and a voltage applied to a developing mechanism is greater in an ejected toner formation than in an image forming operation.

As described above in Example 1, a developing blade 23 as the regulating member regulates the amount of coating of the toner layer formed on a developing roller 22 as the developing mechanism and imparts charges. A voltage having the same polarity as that of the developing roller 22 and having a large absolute value is applied to the developing blade 23. With this voltage, the toner T on the developing roller 22 rubs against the developing blade 23 and causes triboelectric charging, and an electric charge is imparted thereto through injection of the electric charge from the developing blade 23. Hereinafter, the operation of charging the toner that the developing roller 22 bears by the developing blade 23 to form the toner to be ejected from the developing roller 22 will be referred to as an ejected toner formation. In this example, both the developing blade voltage Vbld and the developing voltage Vdc are negative values and have a relationship|Vbld|>|Vdc|.

The larger the absolute value of the difference ΔVbld (=Vbld−Vdc) between the developing blade voltage Vbld applied to the developing blade 23 and the developing voltage Vdc applied to the developing roller 22, the larger the amount of charge injected from the developing blade 23 to the toner T. As the amount of charge injected into the toner T increases, the amount of charge of the toner T on the developing roller 22 increases. However, if the difference ΔVbld exceeds a predetermined threshold value (in this example, |ΔVbld|=about 500 V), then discharge begins. Therefore, it is necessary for the difference ΔVbld to be suppressed to a range in which no discharge occurs. Furthermore, the larger the difference ΔVbld, the stronger the electric field from the developing blade 23 to the developing roller 22. As a result, the toner T receives a strong Coulomb force from the developing blade 23 toward the developing roller 22, and the amount of toner passing through the regulating portion of the developing blade 23 and the developing roller 22 increases. As a result, the amount of toner with which the developing roller 22 is coated increases.

### Ejection Control

The ejection control in this example is basically the same as in Example 1 in terms of the movement of the toner, the potential relationship, and the like. The movement of the ejected toner described in Example 1 using FIGS. 1A to 1F and the potential relationship described using FIG. 8 are also applied similarly to Example 1.

At the time of the image formation, a developing blade voltage Vbld=−500 V is applied to the developing blade 23, and a developing voltage Vdc=−300 V is applied to the developing roller 22. Thus, the difference ΔVbld satisfies ΔVbld=Vbld−Vdc=−200 V.

On the other hand, at the time of ejected toner formation (corresponding to FIG. 1A and the portion A in FIG. 8) in the ejection control, a developing blade voltage Vbld=−700 V is applied to the developing blade 23, and a developing voltage Vdc=−300 V is applied to the developing roller 22. Thus, the difference ΔVbld satisfies ΔVbld=Vbld−Vdc=−400 V. The amount of toner T with which the developing roller 22 is coated and the amount of charging increase by setting the absolute value of the difference ΔVbld to be larger than that at the time of the image formation.

The weight M per unit area (g/m2) and the amount of charging per unit weight Q (C/g) of the ejected toner formed on the surface of the photosensitive drum 1 at the timing in FIG. 1A were confirmed by changing ΔVbld. When ΔVbld=−200 V, M=4.6 g/m2, Q=0.040 C/g were satisfied. On the other hand, when ΔVbld=−400 V, M=4.9 g/m2 and Q=0.045 C/g were satisfied.

As described in Example 1, the degraded toner is a toner in which an external additive on the surface of the toner has peeled off or has been embedded, or the shape of the toner itself has been deformed. A part of the external additive is externally added for the purpose of imparting a charge to the toner, and the amount of charging of the toner decreases due to the peeling-off and the embedding of the external additive. Furthermore, the deformation of the shape of the toner makes it difficult for the toner to roll on the developing roller 22, the opportunity of triboelectric charging is thus lost, and the amount of charging of the toner decreases. Therefore, the amount of charging of the degraded toner is likely to become lower than that of the normal toner. The degraded toner having a small amount of charging is less likely to be developed because the Coulomb force received due to the potential difference formed by the exposure portion potential between the developing roller 22 and the photosensitive drum 1 decreases. In this ejection control, the developing contrast ΔVc at the time of ejected toner formation (corresponding to FIG. 1A) is set to be greater than that at the time of the image formation such that the toner T is more likely to be developed on the photosensitive drum 1 than at the time of the image formation as described above in Example 1. However, a part of the degraded toner has an extremely small amount of charging, and there is a concern that the part of the degraded toner may remain on the developing roller 22 only by setting the developing contrast ΔVc to be large.

According to the configuration of this example, the difference ΔVbld is set to be large at the time of the ejected toner formation, the amount of charging of even the degraded toner thus increases, and the degraded toner becomes more likely to be developed. Therefore, the total amount of degraded toner contained in the ejected toner can be increased as compared with Example 1. Furthermore, the proportion of the degraded toner to the fresh toner in the ejected toner can be increased. As a result, the number of times this ejection control is executed throughout the lifetime of the process cartridge can be reduced, and the effect of reducing a downtime throughout the lifetime is obtained.

The period in which the difference ΔVbld is set to be large is the period in which the toner is ejected onto the photosensitive drum 1 (the portion Ain FIG. 8). Specifically, each applied voltage is controlled such that the toner that has passed at least once through the abutting portion between the developing blade 23 and the developing roller 22 where the changed difference ΔVbld is formed is carried to the abutting portion between the developing roller 22 and the exposure surface of the photosensitive drum 1 and is then ejected.

The reason that it is difficult to set a large difference ΔVbld at the time of the image formation will be described. If the difference ΔVbld is large in normal conditions, such as during image formation, the toner may be excessively charged. The toner that has passed the abutting portion between the developing blade 23 and the developing roller 22 many times is often injected and charged from the developing blade 23, and the toner often rolls on the developing roller 22 and rubs against the developing blade 23, the amount of charging is likely to increase. In addition, since the amount of injection charging from the developing blade 23 increases due to the large difference ΔVbld, the amount of charging further increases. If the amount of charging becomes excessively large, image defects such as a decrease in image density by the distance corresponding to one turn of the developing roller 22 may occur. Therefore, it is preferable that the difference ΔVbld be not excessively increased at the time of the image formation. In this example, satisfactory images were obtained when ΔVbld was maintained to be about −200 V at the time of the image formation.

On the other hand, when the ejected toner is formed in the ejection control, the toner is immediately ejected over the entire periphery of the developing roller even if the difference ΔVbld is increased, and therefore, the toner does not pass through the abutting portion between the developing blade 23 and the developing roller 22 many times in the state where the difference ΔVbld is large. Therefore, the over-charging of the toner is less likely to occur at the time of ejection control. Also, even if the toner is overcharged, the toner is ejected onto the photosensitive drum 1, and is collected by the developing roller 22, or is then transferred to the intermediate transfer belt 10 and is collected in the waste toner accommodating container 17 in the ejection control, and the toner does not cause image defects by being transferred to the recording material. Therefore, it is possible to set a larger difference ΔVbld at the time of the ejection control than that at the time of the image formation.

### Evaluation Tests

In order to confirm the effect of efficiently ejecting the degraded toner and the effect of reducing the downtime throughout the lifetime of this example, the following test was conducted. In an environment at a temperature of 23° C./relative humidity of 50%, feeding test of 5000 sheets with a XEROX Business 4200 LETTER size (Xerox; trade name) as recording material P were conducted, and the presence or absence of image defects was verified.

In the evaluation tests, the difference ΔVbld was set to −400 V, and the ejection control was performed for every 50 sheets on and after 2500th sheet in Example 5 similarly to Example 1. Furthermore, the number of times of the ejection control was reduced in the evaluation tests, and control was executed such that the ejection control was performed for every 100 sheets on and after 2500th sheet. Table 2 shows the evaluation results of this test. Table 2 shows the presence or absence of image defects in the first sheet and every 1000 sheets under two types of control in Example 5. Image defects were determined on the basis of collection defects (development collection defects) at the developing portion with deterioration of primary transfer properties caused by toner degradation. Evaluation criteria were similar to those in the evaluation tests in Example 1.

TABLE 2

| Ejection frequency of | First | 1000th | 2000th | 3000th | 4000th | 5000th |
|---|---|---|---|---|---|---|
| 2500th sheet or later | sheet | sheet | sheet | sheet | sheet | sheet |
| Once per 50 sheets | A | A | A | A | A | A |
| Once per 100 sheets | A | A | A | A | A | A |

As shown in Table 2, in a case where the ejection control was performed for every 50 sets on and after 2500th sheet, no development collection defects occurred even after the number of passing sheets reached 5000 in this example similarly to Example 1. In this manner, it was confirmed that the control of this example had the effect of efficiently ejecting the degraded toner while suppressing unnecessary toner consumption similarly to Example 1.

Furthermore, as illustrated in Table 2, the development collection defects did not occur even after the number of passing sheets reached 5000 in a similar manner even in the case where the frequency of the ejection control was reduced and the ejection control was performed for every 100 sheets on and after 2500th sheet. In this manner, it was possible to reduce the ejection frequency in the control of this example since the proportion and the total amount of degraded toner ejected in one ejection control are increased by increasing the difference ΔVbld at the time of the ejected toner formation. As a result, it was possible to suppress an occurrence frequency of a downtime due to the ejection control.

As described above, control was performed to increase the absolute value of the difference ΔVbld at the time of ejected toner formation as compared with that at the time of the image formation in this example. The effect of achieving efficient ejection, suppressing unnecessary toner consumption, and reducing the replacement frequency of the waste toner accommodating container was achieved similarly to Example 1 by performing such control. In addition to these effects, it was possible to increase the proportion and the total amount of degraded toner in the ejected toner according to the control of this example. As a result, it was possible to reduce the number of times this ejection control was to be executed and to obtain the effect of reducing the downtime throughout the lifetime.

### Modification 2

Modification 2 according to Example 5 will be described. In the configuration of this modification, the difference ΔVbld is increased stepwise at the time of ejected toner formation. Specifically, the absolute value of the difference ΔVbld is increased for each turn of the developing roller 22 in the rotation direction of the photosensitive drum 1 at the time of the ejected toner formation. The parts (configurations, effects, and the like) similar to those in Example 5 will be denoted by the same reference signs, and description will be omitted.

### Toner on Developing Roller at Time of Ejection

The toner T on the developing roller 22 is charged by passing through the abutting portion between the developing blade 23 and the developing roller 22. Therefore, in a case where a non-printing state continues, the amount of charging of the toner T on the developing roller 22 is likely to increase (hereinafter, referred to as a post-white toner). On the other hand, if the toner T on the developing roller 22 once moves onto the photosensitive drum 1 after a high-yield printing image (hereinafter, referred to as a solid image) over the entire periphery of the developing roller 22 is printed, the toner T with which the developing roller 22 is coated thereafter (hereinafter, referred to as a post-black toner) passes the abutting portion between the developing blade 23 and the developing roller 22 only once, the amount of charging thus decreases. In a case where a solid image is continuously printed over a plurality of turns of the developing roller 22, the toner in the vicinity of the developing roller 22 becomes insufficient, and the amount of toner with which the developing roller 22 is coated may decrease in accordance with the number of turns.

### Ejection Control

Although the toner with a length of 44.8 mm (=10 mm×3.14÷1.4×2) corresponding to two turns of the developing roller 22 is ejected when the ejection control is executed in Example 1, the toner with a length of 60 mm, that is, a length corresponding to about 2.7 turns of the developing roller is ejected in this modification.

In this modification, a developing voltage Vdc=−300 V is constantly applied to the developing roller 22. At the time of the ejected toner formation, the developing blade voltage Vbld of −700 V is applied for the first turn, −720 V is applied for the second turn, and −740 V is applied for the third turn to the developing blade 23. In other words, the difference ΔVbld (Vbld−Vdc) is −400 V for the first turn, −420 V for the second turn, and −440 V for the third turn. In this manner, the developing voltage Vdc and the developing blade voltage Vbld are controlled such that the absolute value of the difference ΔVbld increases in accordance with an increase in a rotation distance of the developing roller 22 in this modification.

As described above, the control was performed to gradually increase the absolute value of the difference ΔVbld between the developing blade voltage Vbld and the developing voltage Vdc at the time of ejection control as compared with the time of the image formation in this modification. As a result, according to the control of this example, the difference in amounts of charging of the post-white toner and the post-black toner is reduced, and even the post-black toner can be sufficiently charged and ejected in addition to the effect of Example 5. Also, it becomes possible to suppress a decrease in amount of toner on the developing roller 22 in accordance with the number of turns at the time of the ejected toner formation.

### Example 6

Next, Example 6 according to the present disclosure will be described. Hereinafter, only differences in configurations and effects of Example 6 from those of Example 1 will be described. In the configuration of Example 6, configurations similar to those in Example 1 will be denoted by the same reference signs, and description will be omitted.

Although the ejection control is performed in this example similarly to Example 1, this example is characterized in that the relative rotation speed of a developing mechanism with respect to an image bearing member is higher in ejected toner formation than in image formation, and is different from Example 1 in that point. Parts (configurations, effects, and the like) similar to those in Example 1 will be denoted by the same reference signs, and description will be omitted.

A developing roller 22 as the developing mechanism rotates with a speed difference with respect to a photosensitive drum 1 as the image bearing member. If the relative rotation speed of the developing roller 22 with respect to the photosensitive drum 1 is increased, the distance by which a toner layer on the developing roller 22 comes into contact with an exposure surface of the photosensitive drum 1 increases. As a result, the amount of toner developed from the developing roller 22 to the photosensitive drum 1 increases in a case where a developing contrast ΔVc, which is a potential difference between the exposure portion of the photosensitive drum 1 and the developing roller 22, is sufficiently large. As described above in Example 1, developing contrast ΔVc may be set to be larger than that in the image forming operation by differentiating the amount of exposure by an exposure mechanism from that in the image forming operation in the ejection control. Accordingly, the total amount of toner T to be developed increases if the relative rotation speed of the developing roller 22 with respect to the photosensitive drum 1 is increased in the ejection control.

### Ejection Control

The ejection control in this example is basically the same as in Example 1 in terms of the movement of the toner, the potential relationship, and the like. The movement of the ejected toner described in Example 1 using FIGS. 1A to 1F and the potential relationship described using FIG. 8 are also applied similarly to Example 1. Hereinafter, the rotation speed of the developing roller 22 when the rotation speed of the photosensitive drum 1 is defined as 100% will be expressed by a percentage and will be referred to as a relative developing roller speed. In other words, the relative developing roller speed is the same as the ratio of the rotation speed of the developing roller 22 to the rotation speed of the photosensitive drum 1.

During an ordinary operation other than the ejection control, such as during image formation, the relative developing roller speed is 140%. In this example, the relative developing roller speed is set to 160% at the time of the ejected toner formation (corresponding to FIG. 1A and the portion A in FIG. 8). The total amount of toner developed from the developing roller 22 to the photosensitive drum 1 increases by performing such control. The weight M (g/m2) per unit area of the ejected toner formed on the surface of the photosensitive drum 1 at the timing of FIG. 1A was confirmed by changing the relative developing roller speed. When the relative developing roller speed was 140%, M=4.6 g/m2 was satisfied. On the other hand, when the relative developing roller speed was 160%, M=5.2 g/m2 was satisfied.

In this manner, the total amount of toner developed from the developing roller 22 to the photosensitive drum 1 can be increased by increasing the rotation speed of the developing roller 22 with respect to the photosensitive drum 1 at the time of the ejected toner formation. As a result, the total amount of degraded toner contained in the ejected toner can be increased. As a result, it is possible to reduce the number of times this ejection control is to be executed throughout the lifetime of the process cartridge and to thereby obtain an effect of reducing a downtime throughout the lifetime.

### Evaluation Tests

In order to confirm the effect of efficiently ejecting the degraded toner and the effect of reducing the downtime throughout the lifetime of this example, a test similar to that in Example 5 was conducted. More specifically, the relative developing roller speed at the time of the ejected toner formation was set to 160%, and control in which the ejection control was performed for every 50 sheets on and after 2500th sheet and control in which the ejection control was performed for every 100 sheets on and after 2500th sheet were executed in Example 6. Table 3 shows evaluation results of this test. Table 3 shows presence or absence of image defects for the first sheet and every 1000 sheets under two kinds of control in Example 6. Evaluation criteria were similar to those in the evaluation tests in Examples 1 and 5.

TABLE 3

| Ejection frequency of | First | 1000th | 2000th | 3000th | 4000th | 5000th |
|---|---|---|---|---|---|---|
| 2500th sheet or later | sheet | sheet | sheet | sheet | sheet | sheet |
| Once per 50 sheets | A | A | A | A | A | A |
| Once per 100 sheets | A | A | A | A | A | A |

As shown in Table 3, in a case where the ejection control was performed for every 50 sets on and after 2500th sheet, no development collection defects occurred even after the number of passing sheets reached 5000 in the control of this example similarly to Example 1. As described above, it was confirmed that the control of this example has the effect of efficiently ejecting the degraded toner while suppressing unnecessary toner consumption similarly to Example 1.

Furthermore, no development collection defects occurred even after the number of passing sheets reached 5000 in a similar manner even in the case where the frequency of ejection control is reduced and the ejection control was performed for every 100 sheets on and after 2500th sheet as shown in Table 3. As described above, the total amount of degraded toner ejected in one ejection control was increased by raising the circumferential speed (relative developing roller speed) of the developing roller 22 at the time of the ejected toner formation, and it was thus possible to reduce the ejection frequency under the control of this example. As a result, it was possible to suppress an occurrence frequency of a downtime due to the ejection control.

As described above, control was performed such that the rotation speed of the developing roller 22 with respect to the photosensitive drum 1 at the time of the ejected toner formation was set to be larger than that at the time of the image formation in this example. By performing such control, it is possible to realize efficient ejection and to obtain an effect of suppressing unnecessary toner consumption and reducing the replacement frequency of the waste toner accommodating container similarly to Example 1. In addition to these effects, it is possible to increase the total amount of degraded toner in the ejected toner under the control of this example. As a result, it is possible to reduce the number of times this ejection control is to be executed and to obtain an effect of reducing the downtime throughout the lifetime of the process cartridge S.

### Modification 3

In Example 6, the relative developing roller speed at the time of the toner ejection was raised in the ejection control described in Example 1. An example in which the first fogging ejection control described in Example 3 or the second fogging ejection control described in Example 4 instead of the ejection control described in Example 1 will be described below as Modification 3 according to Example 6. In Modification 3, the relative developing roller speed was raised at the time of ejection of a fogging toner (at the time of FIGS. 16A and 18A) in fogging ejection control. Hereinafter, parts (configurations, effects, and the like) similar to those in Example 6 will be denoted by the same reference signs, and description will be omitted.

In this modification, the relative developing roller speed is set to 140% at the time of the image formation, and the relative developing roller speed is set to 160% at the time of the fogging toner ejection. The total amount of fogging toner moving onto the photosensitive drum 1 increases as compared with that at the time of image formation by performing such control, and it is thus possible to increase the amount of degraded toner to be discharged through one fogging ejection control. As a result, it is possible to reduce the number of times the fogging ejection control is to be executed and to obtain an effect of reducing the downtime throughout the lifetime in addition to the effects of Examples 3 and 4 in this modification.

### Example 7

Next, Example 7 according to the present disclosure will be described. Hereinafter, only differences in configurations and effects of Example 7 from those of Example 1 will be described. In the configuration of Example 7, configurations similar to those in Example 1 will be denoted by the same reference signs, and description will be omitted.

Although the ejection control is performed similarly to Example 1 in this example, this example is characterized in that an absolute value of a difference between a voltage to be applied to a developer supply mechanism and a voltage to be applied to a developing mechanism at the time of ejected toner formation is greater than that at the time of image formation and is different from Example 1 in that point.

A supply roller 26 as the developer supply mechanism is supplied with a supply voltage Vrs as a predetermined DC voltage as described in Example 1. A voltage having the same polarity as that of a developing voltage Vdc applied to a developing roller 22 as the developing mechanism and having a large absolute value is applied as the supply voltage Vrs. Note that in this example, both the supply voltage Vrs and the developing voltage Vdc are negative values and have a relationship of |Vrs|>|Vdc|.

A charge is imparted to the toner on the developing roller 22 through charge injection from the supply roller 26. Therefore, if the absolute value of the difference ΔVrs (=Vrs−Vdc; the supply roller contrast) between the voltages applied to the supply roller 26 and the developing roller 22 is increased, the amount of charging of the toner T on the developing roller 22 increases. When the difference ΔVrs is increased, the amount of toner moving from the supply roller 26 to the developing roller 22 increases, and the amount of coating on the developing roller 22 increases. As a result, in a case where the developing contrast ΔVc, which is a potential difference between an exposure portion of a photosensitive drum 1 and the developing roller 22, is sufficiently large, the amount of toner developed from the developing roller 22 to the photosensitive drum 1 increases. However, when the difference ΔVrs exceeds a threshold value (|ΔVrs|=about 500 V in the configuration of this example), the discharge begins. Therefore, it is necessary to set ΔVrs within a reduced range in which discharge does not occur.

### Ejection Control

The ejection control in this example is basically the same as in Example 1 in terms of the movement of the toner, the potential relationship, and the like. The movement of the ejected toner described in Example 1 using FIGS. 1A to 1F and the potential relationship described using FIG. 8 are also applied similarly to Example 1.

At the time of the image formation, a supply voltage Vrs=−500 V is applied to the supply roller 26, and a developing voltage Vdc=−300 V is applied to the developing roller 22. Thus, the difference ΔVrs satisfies ΔVrs=Vrs−Vdc=−200 V.

On the other hand, a supply voltage Vrs=−700 V is applied to the supply roller 26, and the developing voltage Vdc=−300 V is applied to the developing roller 22 at the time of the ejected toner formation (corresponding to FIG. 1A and the portion A in FIG. 8). At this time, the difference ΔVrs satisfies ΔVrs=Vrs−Vdc=−400 V. By performing such control, the amount of toner T on the developing roller 22 increases, and the total amount of toner T developed from the developing roller 22 to the photosensitive drum 1 increases.

The weight M (g/m2) per unit area of the ejected toner formed on the surface of the photosensitive drum 1 at the timing of FIG. 1A was confirmed by changing the difference ΔVrs. When ΔVrs=−200 V was satisfied, M=4.6 g/m2 and Q=0.040 C/g were satisfied. On the other hand, when ΔVrs=−400 V, M=4.9 g/m2, and Q=0.045 C/g were satisfied. The total amount of toner T developed from the developing roller 22 to the photosensitive drum 1 can be increased by increasing the potential difference between the supply roller 26 and the developing roller 22 at the time of the ejected toner formation in this manner. As a result, the amount of degraded toner discharged per one ejection control increases.

However, if the difference ΔVrs is kept large at a timing other than the ejected toner formation, such as at the time of image formation, the toner T may be excessively charged. Therefore, it is preferable that the difference ΔVrs be increased at the timing before the ejected toner formation and be returned to the original magnitude after the ejected toner formation ends.

### Evaluation Tests

In order to confirm the effect of efficiently ejecting the degraded toner and the effect of reducing the downtime throughout the lifetime of this example, a test similar to those of Examples 5 and 6 was conducted. Specifically, an absolute value of the difference ΔVrs at the time of the ejected toner formation was set to 400 V, which was greater than that at the time of the image formation, and a control in which the ejection control was performed for every 50 sheets on and after the 2500th sheet and a control in which the ejection control was performed for every 100 sheets on and after the 2500th sheet in were executed in Example 7.

As test results, no development collection defects occurred in all the tests. From the results, it was possible to confirm that the control of this example had an effect of suppressing unnecessary toner consumption and efficiently ejecting the degraded toner and an effect of suppressing an occurrence frequency of the downtime due to the ejection control similarly to Example 6.

As described above, control is performed to increase the potential difference between the supply roller 26 and the developing roller 22 at the time of ejected toner formation as compared with the time of image formation in this example. The total amount of toner T developed from the developing roller 22 to the photosensitive drum 1 increases, and the total amount of degraded toner contained in the ejected toner can be increased, by performing such control. As a result, it is possible to realize efficient ejection and to obtain an effect of suppressing unnecessary toner consumption and reducing the replacement frequency of the waste toner accommodating container similarly to Example 1. In addition to these effects, it is possible to reduce the number of times the ejection control is to be executed throughout the lifetime of the process cartridge S and to obtain an effect of reducing the downtime throughout the lifetime.

### Modification 4

Modification 4 according to Example 7 will be described below. In the configuration of this modification, ΔVrs is increased stepwise at the time of the ejected toner formation. Specifically, an absolute value of the difference ΔVrs is increased for every turn of the developing roller 22 in the rotation direction of the photosensitive drum 1 at the time of the ejected toner formation. Hereinafter, parts (configurations, effects, and the like) similar to those in Example 7 will be denoted by the same reference signs, and description will be omitted.

As described in Modification 2 of Example 5, there may be a case where a difference is generated in amounts of charging between the post-white toner and the post-black toner in the toner on the developing roller 22 and a case where a solid image continuing over a plurality of turns of the developing roller 22 leads to a decrease in amount of toner on the developing roller 22.

If the difference ΔVrs, which is the potential difference between the supply roller 26 and the developing roller 22, is increased, the amount of charging of the toner T on the developing roller 22 can be increased. Therefore, it is possible to reduce the difference in amounts of charging between the post-white toner and the post-black toner by setting a larger difference ΔVrs for the post-black toner than for the post-white toner. Furthermore, in a case where a solid image continues over a plurality of turns of the developing roller 22, it is possible to prevent a decrease in amount of toner on the developing roller 22 by gradually increasing the difference ΔVrs.

Although the toner with a length of 44.8 mm (=10 mm×3.14÷1.4×2) corresponding to two turns of the developing roller 22 is ejected when the ejection control is executed in Example 1, the toner with a length of 60 mm, that is, a length corresponding to about 2.7 turns of the developing roller is ejected in this modification.

In this modification, the developing voltage Vdc=−300 V is constantly applied to the developing roller 22. At the time of the ejected toner formation, the supply voltage Vrs of −700 V is applied for the first turn, −720 V is applied for the second turn, and −740 V is applied for the third turn to the supply roller 26. In other words, the difference ΔVrs (Vrs−Vdc) is −400 V for the first turn, −420 V for the second turn, and −440 V for the third turn.

In addition to the effects of Example 7, the difference in amounts of charging between the post-white toner and the post-black toner decreases, and even the post-black toner can be sufficiently charged and ejected, by performing such control. Also, it becomes possible to suppress a decrease in amount of toner on the developing roller 22 in accordance with the number of turns at the time of the ejected toner formation.

### Modification 5

Modification 5, which is the second modification according to Example 7, will be described. In the configuration of this modification, an absolute value of a difference ΔVrs is lowered until a timing immediately before ejected toner formation as compared with that at the time of the image formation, and the absolute value of the difference ΔVrs is raised at the timing at which the ejected toner is formed. Hereinafter, parts (configurations, effects, and the like) similar to those in Example 7 will be denoted by the same reference signs, and description will be omitted.

In this modification, a developing voltage Vdc=−300 V is constantly applied to the developing roller 22. At the time of the image formation, a supply voltage Vrs=−500V is applied to the supply roller 26, and a relationship with the difference ΔVrs=−200 V is established.

A supply voltage Vrs=−400 V is applied to the supply roller 26 before the ejection control is started, and the difference ΔVrs=−100 V is established. If the absolute value of the difference ΔVrs is reduced before the ejection control is started as compared with that at the time of image formation, the amount of toner on the developing roller 22 decreases, and at that time, a fresh toner with a low non-electrostatic adhesion force preferentially moves from the developing roller 22. Therefore, it is possible to raise the ratio of the degraded toner on the developing roller 22 before the ejection control is started due to the decrease in difference ΔVrs.

Thereafter, when the ejection control is started and the ejected toner is moved to the photosensitive drum 1, the supply voltage Vrs=−700 V is applied to the supply roller 26, that is, the difference ΔVrs is set to satisfy ΔVrs=−400 V, such that the absolute value of the difference ΔVrs is increased as compared with that at the time of the image formation. Thus, the amount of toner on the developing roller is increased, and the amount of degraded toner discharged in one ejection control is increased. The timing at which the difference ΔVrs is lowered before the ejection control is started is set at least before the ejection control is started, and it is desirable that the developing roller 22 be rotated one turn in the state where the difference Δ Vrs has been lowered.

The amount of degraded toner discharged in this modification increased as compared with that in Example 7, by performing such control. As a result, it is possible to further reduce the number of times this ejection control is to be executed throughout the lifetime of the process cartridge as compared with Example 7 and to obtain an effect of reducing the downtime throughout the lifetime.

### Modification 6

In Example 7, the difference ΔVrs, which is the potential difference between the supply roller 26 and the developing roller 22, is increased in comparison with the ejection control described in Example 1. An example in which the first fogging ejection control described in Example 3 or the second fogging ejection control described in Example 4 instead of the ejection control described in Example 1 is executed will be described below as Modification 6 according to Example 7. In Modification 6, an absolute value of a difference ΔVrs is raised at the time of ejection of a fogging toner (the timing in FIG. 16A and FIG. 18A) in the fogging ejection control. Hereinafter, parts (configurations, effects, and the like) similar to those in Example 7 will be denoted by the same reference signs, and description will be omitted.

In this modification, the difference ΔVrs is set to satisfy ΔVrs=−200 V at the time of image formation, and to satisfy ΔVrs=−400 V at the time of fogging toner ejection. The amount of coating of the toner on the developing roller 22 at the time of the fogging toner ejection increases by performing such control. A toner T at a certain proportion in the toner T held on the developing roller 22 moves as the fogging toner to the photosensitive drum 1. Therefore, the amount of fogging toner also increases with an increase in amount of coating of the toner on the developing roller 22.

The total amount of fogging toner moving to the photosensitive drum 1 is increased by performing such control to increase the difference ΔVrs at the time of the fogging toner ejection, and it is thus possible to increase the amount of degraded toner to be discharged in one fogging toner ejection control. As a result, it is possible to reduce the number of times the ejection control is to be executed and to obtain an effect of reducing the downtime throughout the lifetime.

### Example 8

Next, Example 8 according to the present disclosure will be described. Hereinafter, only differences in configurations and effects of Example 8 from those of Example 1 will be described. In the configuration of Example 8, configurations similar to those in Example 1 will be denoted by the same reference signs, and description will be omitted.

In this example, the ejection control is performed similarly to Example 1. On the other hand, an absolute value of a difference between a voltage to be applied to a regulating member and a voltage to be applied to a developing mechanism at a timing at which an ejected toner on an image bearing member passes through a transfer portion and a charging portion and passes through a developing portion again is smaller than that at the time of image forming operation in this example. Hereinafter, the timing at which ejected toner on the image bearing member passes through the developing portion again will be referred to as a developing portion passing timing. Example 8 is characterized in that the difference between the voltage to be applied to the regulating member and the voltage to be applied to the developing mechanism at the developing portion passing timing is smaller than that in the image forming operation and is different from Example 1 in that point.

As described above in Example 1, it is possible to selectively eject a degraded toner while returning a large amount of fresh toner in the ejected toner to the developing unit 4 under the ejection control in Example 1. However, a part of fresh toner may be ejected and consumed along with the degraded toner. In this example, the amount of fresh toner to be development-collected increased, and the amount of toner to be consumed in the ejection control is reduced, at the developing portion passing timing of the ejected toner. As a result, it is possible to reduce the replacement frequency of the waste toner accommodating container.

### Ejection Control

The ejection control in this example is basically the same as in Example 1 in terms of the movement of the toner, the potential relationship, and the like. The movement of the ejected toner described in Example 1 using FIGS. 1A to 1F and the potential relationship described using FIG. 8 are also applied similarly to Example 1.

As described above in Example 5, charge injection from the developing blade 23 to the toner T is performed by the difference ΔVbld between the developing blade voltage Vbld applied to the developing blade 23 and the developing voltage Vdc applied to the developing roller 22. Therefore, if the absolute value of the difference ΔVbld is reduced, the amount of charging of the toner T on the developing roller 22 is reduced. Furthermore, as the absolute value of the difference ΔVbld decreases, the electric field from the developing blade 23 to the developing roller 22 becomes weaker. As a result, the Coulomb force that the toner T receives from the developing blade 23 toward the developing roller 22 is weakened, and the amount of toner that cannot pass through the regulating portion between the developing blade 23 and the developing roller 22 increases. As a result, the amount of coating of the toner on the developing roller 22 decreases.

At the time of the image formation, the developing blade voltage Vbld=−500 V is applied to the developing blade 23 as the regulating member, and the developing voltage Vdc=−300 V is applied to the developing roller 22 as the developing mechanism. Thus, the difference ΔVbld satisfies ΔVbld=Vbld−Vdc=−200 V.

On the other hand, in the ejection control, the developing blade voltage Vbld=−400 V is applied to the developing blade 23, and the developing voltage Vdc=−300 V is applied to the developing roller 22 at the developing portion passing timing (corresponding to FIG. 1D and the portion D in FIG. 8) of the ejected toner. Accordingly, the difference ΔVbld satisfies ΔVbld=Vbld−Vdc=−100 V. As described above, if the absolute value of the difference ΔVbld is reduced, the amount of charging of the toner T on the developing roller 22 decreases, and the amount of coating of the toner on the developing roller 22 decreases. The amount of toner to be collected by the developing roller 22 at the development portion passing timing of the ejected toner increases by the amount of coating of the toner on the developing roller 22 decreasing. Since the fresh toner has a lower non-electrostatic adhesion force than the degraded toner, it is preferentially collected over the degraded toner. Accordingly, it is possible to reduce the amount of fresh toner to be consumed in the ejection control by performing the control of this example.

The timing at which the difference ΔVbld is reduced is the developing portion passing timing (corresponding to FIG. 1D and the portion D of FIG. 8) of the ejected toner as described above. Specifically, each applied voltage is controlled such that the surface of the developing roller 22 that has passed at least once through the abutting portion between the developing roller 22 and the developing blade 23 where the changed difference ΔVbld is formed comes into contact with the toner ejected on the photosensitive drum 1.

### Evaluation Tests

In order to confirm the effect of suppressing image defects by the ejection of the degraded toner in the ejection control in this example, the following tests were conducted. In an environment at a temperature of 23° C./relative humidity of 50%, feeding test of 5000 sheets with a XEROX Business 4200 LETTER size (Xerox; trade name) as recording material P were conducted, and the presence or absence of image defects was verified. The ejection control was performed at an interval of once every 50 sheets on and after 2500th sheets. In other words, this evaluation tests were similar to those described in Example 1.

Table 4 below shows evaluation results of the tests. Table 4 also shows test results of Example 1 and Comparative Example 1 in which the ejection control was not performed, as comparison targets. Table 4 shows presence or absence of image defects for the first sheet and every 1000 sheets in the configuration of Example 8, Example 1, and Comparative Example 1. Determination of image defects were made on the basis of development collection defects. Evaluation criteria were similar to those in the evaluation tests in Example 1.

TABLE 4

| | First | 1000th | 2000th | 3000th | 4000th | 5000th |
|---|---|---|---|---|---|---|
| | sheet | sheet | sheet | sheet | sheet | sheet |
| Example 8 | A | A | A | A | A | A |
| Example 1 | A | A | A | A | A | A |
| Comparative | A | A | A | B | B | C |
| Example 1 | | | | | | |

As shown in Table 4, no development collection defects occurred even after the number of passing sheets reached 5000 in Example 8 similarly to Example 1. In other words, an effect of selectively ejecting the degraded toner is exhibited in Example 8 as compared with Comparative Example 1.

Also, an average circularity (aspect ratio) of the toner at the 5000th sheet was checked using an FPIA-3000 model. The average circularity (aspect ratio) was 0.901 in Example 8, 0.903 in Example 1, and 0.851 in Comparative Example 1. In other words, there was no significant difference between Example 8 and Example 1 while the average circularities in Example 8 and Example 1 were greater than that in Comparative Example 1. It was possible to confirm the effect of ejecting the degraded toner achieved by the configuration of Example 8 as compared with the configuration of Comparative Example 1 from this result as well.

Next, in order to confirm the effect of reducing the replacement frequency of the waste toner accommodating container of this example, the following tests were conducted. In an environment at a temperature of 23° C./relative humidity of 50%, feeding tests of 300000 sheets with a XEROX Business 4200 LETTER size (Xerox; trade name) as recording material P were conducted, and the numbers of times the waste toner accommodating container was to be replaced were compared. The ejection control was performed for every 50 sheets. In the tests, evaluation was made for the configuration of Example 1 as a comparison target in addition to the configuration of Example 8.

In the control of Example 1, it was necessary to replace the waste toner accommodating container twice in total in the feeding test of 300000 sheets. On the other hand, it was necessary to replace the waste toner accommodating container once in total in the feeding test of 300000 for the ejection control of this example. As described above, according to the ejection control of this example, the amount of toner consumed in one ejection control is reduced, and the replacement frequency of the waste toner accommodating container can be reduced as compared with Comparative Example 1.

As described above, control was performed to reduce the potential difference between the regulating member and the developing mechanism when the ejected toner at the time of the ejection control passes through the developing portion in this example. It was possible to suppress unnecessary toner consumption at the time of the ejection control and to reduce the replacement frequency of the waste toner accommodating container in addition to the effects of Example 1 by performing such control.

Although the difference between the voltage applied to the regulating member and the voltage applied to the developing mechanism is set to be smaller at the developing portion passing timing in the ejection control than that at the time of image formation in this example, the present disclosure is not limited to such a configuration. For example, it is possible to obtain the effect of suppressing unnecessary toner consumption at the time of ejection control even by setting the difference at the developing portion passing timing in the ejection control to be smaller than that at the time of ejected toner formation in the ejection control.

In order to suppress unnecessary toner consumption in the ejection control, it is particularly preferable to set (the difference ΔVbld at the developing portion passing timing)<(the difference ΔVbld at the time of image formation)<(the difference ΔVbld at the time of ejected toner formation).

### Example 9

Next, Example 9 according to the present disclosure will be described. Hereinafter, only differences in configurations and effects of Example 9 from those of Example 1 will be described. In the configuration of Example 9, configurations similar to those in Example 1 will be denoted by the same reference signs, and description will be omitted.

This example is characterized in that although ejection control is performed similarly to Example 1, a relative rotation speed of a developing mechanism with respect to an image bearing member is higher at a developing portion passing timing than in an image forming operation and is different from Example 1 in that point. Note that the development portion passing timing is a timing at which an ejected toner on the image bearing member passes through a developing portion after passing through a transfer portion and a charging portion.

### Ejection Control

The ejection control in this example is basically the same as in Example 1 in terms of the movement of the toner, the potential relationship, and the like. The movement of the ejected toner described in Example 1 using FIGS. 1A to 1F and the potential relationship described using FIG. 8 are also applied similarly to Example 1.

During an ordinary operation other than the ejection control, such as during image formation, the relative developing roller speed, which is a relative rotation speed of the developing roller 22, is 140% when the rotation speed of the photosensitive drum 1 is defined as 100%. On the other hand, the relative developing roller speed is set to 160% at the developing portion passing timing (corresponding to FIG. 1D and the portion D in FIG. 8) of the ejected toner in the ejection control in this example. The distance by which the developing roller 22 comes into contact with the surface of the photosensitive drum 1 where the ejected toner is present increases in the rotation direction of the developing roller 22 by performing such control. As a result, the amount of toner returning from the photosensitive drum 1 to the developing roller 22 increases at the developing portion passing timing of the ejected toner.

Since the fresh toner has a lower non-electrostatic adhesion force than the degraded toner, the fresh toner is more preferentially collected than the degraded toner at the developing portion passing timing. Therefore, it is possible to reduce the amount of fresh toner to be consumed in the ejection control by performing the control of this example.

### Evaluation Tests

In order to confirm the effect of suppressing image defects by the ejection of the degraded toner in the ejection control of this example, tests similar to those in Example 8 were conducted. More specifically, the relative developing roller speed at the developing portion passing timing was set to 160%, and feeding tests of total of 5000 sheets in which ejection control was conducted for every 50 sheets on and after the 2500th sheet were conducted in Example 9. As a result, no development collection defects occurred even after the number of passing sheets reached 5000, and it was also possible to obtain effect similar to those of Example 8 in the configuration of this example as well.

In order to confirm the effect of reducing the replacement frequency of the waste toner accommodating container of this example, feeding tests of total of 300000 sheets in which ejection control was conducted for every 50 sheets was conducted similarly to Example 8, and the numbers of times the waste toner accommodating container was replaced were compared. As a result, it was necessary to replace the waste toner accommodating container twice in total in Example 1, while it was necessary to replace the waste toner accommodating container only once in total in the configuration of this example.

As described above, control was performed to set the relative rotation speed of the developing mechanism with respect to the image bearing member when the ejected toner in the ejection control passes through the developing portion to be higher than that at the time of image forming operation in this example. It was possible to suppress unnecessary toner consumption and to reduce the replacement frequency of the waste toner accommodating container in addition to the effects of Example 1 by performing such control.

### Example 10

Next, Example 10 according to the present disclosure will be described. Hereinafter, only differences in configurations and effects of Example 10 from those of Example 1 will be described. In the configuration of Example 10, configurations similar to those in Example 1 will be denoted by the same reference signs, and description will be omitted.

Although ejection control is performed similarly to Example 1, this example is characterized in that an absolute value of a difference between a voltage applied to a developer supply mechanism and a voltage applied to a developing mechanism at a developing portion passing timing is smaller than that at the time of an image forming operation and is different from Example 1 in that point. Note that the developing portion passing timing is a timing at which the ejected toner on the image bearing member passes through a transfer portion and a charging portion and passes through a developing portion again.

### Ejection Control

The ejection control in this example is basically the same as in Example 1 in terms of the movement of the toner, the potential relationship, and the like. The movement of the ejected toner described in Example 1 using FIGS. 1A to 1F and the potential relationship described using FIG. 8 are also applied similarly to Example 1.

At the time of the image formation, a supply voltage Vrs=−500 V is applied to a supply roller 26 as the developer supply mechanism, and a developing voltage Vdc=−300 V is applied to a developing roller 22 as the developing mechanism. Thus, the difference ΔVrs satisfies ΔVrs=Vrs−Vdc=−200 V.

On the other hand, the supply voltage Vrs=−400 V is applied to the supply roller 26, and the developing voltage Vdc=−300 V is applied to the developing roller 22 at the developing portion passing timing (corresponding to FIG. 1D and the portion D in FIG. 8) of the ejected toner in the ejection control. At this time, the difference ΔVrs satisfies ΔVrs=Vrs−Vdc=−100 V. In this manner, if the absolute value of the difference ΔVrs at the developing portion passing timing of the ejected toner is reduced as compared with that at the time of image formation, the amount of charging of the toner T on the developing roller 22 decreases at the developing portion passing timing of the ejected toner. Furthermore, the amount of coating of the toner on the developing roller 22 decreases at the same time.

The weight M (g/m2) per unit area of the ejected toner formed on the surface of the photosensitive drum 1 at the timing of FIG. 1D was confirmed by changing the difference ΔVrs. When ΔVrs=−200 V was satisfied, M=4.6 g/m2 and Q=0.040 C/g were satisfied. On the other hand, when ΔVrs=−100 V was satisfied, M=4.3 g/m2 and Q=0.035 C/g were satisfied. In this manner, the amount of toner collected by the developing roller 22 in the ejected toner on the photosensitive drum 1 increases by the amount of coating of the toner on the developing roller 22 decreasing at the developing portion passing timing of the ejected toner. Since the fresh toner has a lower non-electrostatic adhesion force than the degraded toner, it is preferentially collected over the degraded toner. As a result, it is possible to reduce the amount of fresh toner to be consumed in the ejection control by performing the control of this example.

The timing at which the difference ΔVrs is reduced is the developing portion passing timing (corresponding to FIG. 1D and the portion D of FIG. 8) of the ejected toner as described above. Specifically, each applied voltage is controlled such that the surface of the developing roller 22 that has passed at least once through the abutting portion between the developing roller 22 and the developing blade 23 where the changed difference ΔVrs is formed comes into contact with the toner ejected on the photosensitive drum 1.

### Evaluation Tests

In order to confirm the effect of suppressing image defects by the ejection of the degraded toner in the ejection control of this example, tests similar to those in Example 8 were conducted. More specifically, the difference ΔVrs at the developing portion passing timing was set to −100 V, and feeding tests of total of 5000 sheets in which ejection control was conducted for every 50 sheets on and after the 2500th sheet were conducted in Example 10. As a result, no development collection defects occurred even after the number of passing sheets reached 5000, and it was also possible to obtain effect similar to those of Example 8 in the configuration of this example as well.

In order to confirm the effect of reducing the replacement frequency of the waste toner accommodating container of this example, feeding tests of total of 300000 sheets in which ejection control was performed for every 50 sheets were conducted similarly to Example 8, and the numbers of times the waste toner accommodating container was replaced were compared. As a result, it was necessary to replace the waste toner accommodating container twice in total in Example 1, while it was necessary to replace the waste toner accommodating container only once in total in the configuration of this example.

As described above, control was performed to set the difference between the voltage applied to the developer supply mechanism and the voltage applied to the developing mechanism to be smaller when the ejected toner in the ejection control passes through the developing portion than that at the time of the image forming operation in this example. It was possible to suppress unnecessary toner consumption and to reduce the replacement frequency of the waste toner accommodating container in addition to the effects of Example 1 by performing such control.

### Example 11

Next, Example 11 according to the present disclosure will be described. An apparatus configuration of an image forming apparatus 100 according to Example 11 is similar to that of Example 2, and the image forming apparatus 100 includes a pre-charging exposure device 6. Hereinafter, only differences in configurations and effects of Example 11 from those of Example 2 will be described. In the configuration of Example 11, configurations similar to those in Example 2 will be denoted by the same reference signs, and description will be omitted.

In Examples 1 to 10, the control to efficiently process the degraded toner has been described. In Example 11, a method of effectively transferring a degraded toner remaining on a photosensitive drum 1 in an ejected toner to an intermediate transfer belt 10 will be described.

According to control of Example 11, the degraded toner that may remain on the photosensitive drum can be transferred to the intermediate transfer belt 10, and member contamination such as toner melt adhesion to the photosensitive drum 1 can be suppressed while effects similar to those of Examples 1 to 10 are obtained. The melt adhesion of the toner to the photosensitive drum 1 occurs by the toner that remains on the photosensitive drum 1 repeatedly passing through a charging portion, a developing portion, and a transfer portion, collapsing on the photosensitive drum 1, and firmly fixing to the photosensitive drum 1. Once the toner firmly adhering to the photosensitive drum 1, a further toner adheres to the toner that has collapsed and adhered (a non-electrostatic adhesion force has been raised in a state where the toner core is exposed), collapses, is accumulated thereon, and thus grows to the height of about 10 μm to 15 μm. The state where the toner has been accumulated and grown up to this state is referred to as toner melt adhesion to the photosensitive drum 1, and image defects such as a phenomenon (hereinafter, referred to as white spots) of clipped whites of images due to charging defects may occur.

According to the configuration of this example, it is possible to suppress member contamination such as toner melt adhesion to the photosensitive drum 1. Note that for distinction from the control of Examples 1 to 10, control of Example 11 described below will be referred to as post-rotation control.

### Post-rotation Control

In this example, the post-rotation control is executed in order to effectively transfer the toner that may remain on the photosensitive drum 1 after a transfer process of a degraded toner in ejection control (a transfer residual toner of the degraded toner) to the intermediate transfer belt 10. Since processes up to a toner sorting process by the developing control in the ejection control according to Example 11 are similar to those in Example 2, description thereof will be omitted, and processes in and after a degraded toner transfer process in the ejection control will be described in detail.

In the degraded toner transfer process, the toner containing a large amount of degraded toner remaining on the photosensitive drum 1 after the toner sorting by the developing portion is transferred to the intermediate transfer belt 10. Since the degraded toner has a high adhesion force to the photosensitive drum 1, the transfer to the intermediate transfer belt 10 is performed with a potential difference that is equal to or greater than that in ordinary image formation in the degraded toner transfer process. However, since the degraded toner has a high adhesion force to the photosensitive drum 1, there may be a case where it is not possible to transfer all the toner to the intermediate transfer belt 10 and the toner remains on the photosensitive drum 1 in a case where the amount of toner is large. In order to distinguish the toner remaining on the photosensitive drum 1 in this manner from the ordinary transfer residual toner, the toner remaining on the photosensitive drum 1 will be referred to as an “ejection transfer residual toner”.

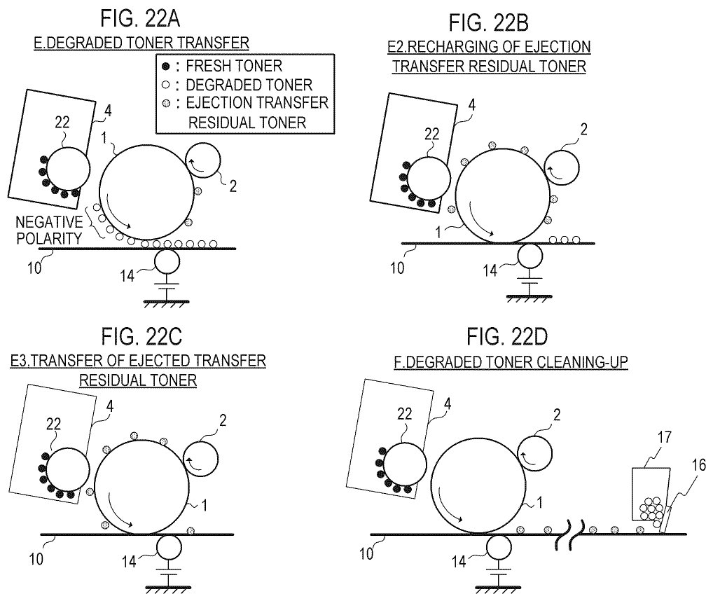

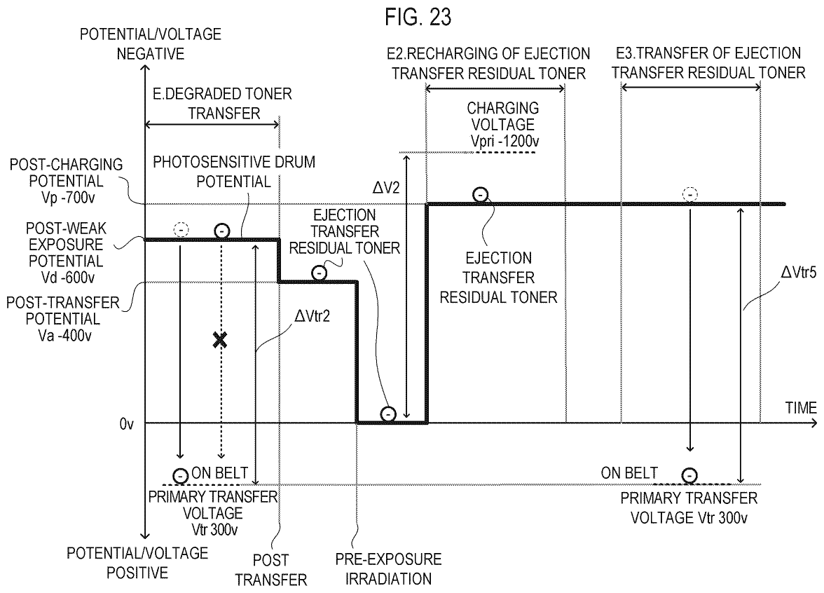

As the post-rotation control according to this example, control of transferring the ejection transfer residual toner to the intermediate transfer belt 10 without causing the ejection transfer residual toner to remain on the photosensitive drum 1 will be described using FIGS. 22A to 22D and FIG. 23. FIGS. 22A to 22D are explanatory diagrams of the post-rotation control, and are schematic diagrams illustrating movement of the ejected toner in processes in and after the degraded toner transfer process in the ejection control. FIG. 23 is an explanatory diagram of voltage and potential control in the post-rotation control, and is a diagram schematically illustrating a potential of the photosensitive drum 1, a developing voltage, transition of a primary transfer voltage, and movement of the toner in the post-rotation control along a time axis. FIG. 23 shows a graph in which the vertical axis represents the potential/voltage and the horizontal axis represents the time, a surface potential (photosensitive drum potential) at a predetermined location moving with rotation of the photosensitive drum 1 is illustrated by the thick line, and the toner adhering to the part is also illustrated together. In FIGS. 22A to 22D, the ejection transfer residual toner is illustrated with a dotted pattern.

The post-rotation control is performed after the E. degraded toner transfer process according to example 2 and before the F. degraded toner cleaning-up process. In other words, the post-rotation control can also be considered to be control which is a part of the ejection control. The post-rotation control is roughly categorized into processes: E2. recharging of the ejection transfer residual toner; and E3. ejection transfer residual toner transfer. Note that the processes E, E2, E3, and F correspond to FIGS. 22A to 22D, respectively, and ranges corresponding to the processes E, E2, and E3 are illustrated by the arrows in FIG. 23 as well.

### E. Degraded Toner Transfer

FIG. 22A is a diagram illustrating a state of the degraded toner transfer process. In the degraded toner transfer process, the toner on the surface of the photosensitive drum 1 is caused to move to the intermediate transfer belt 10. However, not all the toner on the surface of the photosensitive drum 1 necessarily moves to the intermediate transfer belt 10 in this process, and a part of the toner may remain on the surface of the photosensitive drum 1. The symbol×on the broken line arrow illustrated in FIG. 23 schematically represents that the toner has remained on the photosensitive drum 1 without being able to be transferred although it is originally desired to transfer the toner to the intermediate transfer belt 10. Such a toner remaining on the photosensitive drum 1 is the ejection transfer residual toner. In this example, the toner remaining after the toner supply portion supplied with the toner on the photosensitive drum 1 passes through the transfer portion twice corresponds to the ejection transfer residual toner.

After the ejected toner finishes passing through the developing portion, the developing roller 22 is immediately separated from the photosensitive drum 1 as illustrated in FIG. 22A, and rotation of the developing roller 22 is stopped. This is to avoid unnecessary rubbing of the toner on the developing roller 22 against the developing blade 23 and to avoid collection of the ejection transfer residual toner by the developing roller 22. The length of the ejected toner in the conveying direction is preferably less than the length of one turn of the photosensitive drum 1. Accordingly, it is only necessary to perform the operation of separating the developing roller 22 at a timing before the ejection transfer residual toner corresponding to the leading end part of the ejected toner reaches the developing portion again and after the posterior end of the ejected toner ends the collection process at the developing roller 22.

### E2. Recharging of Ejection Transfer Residual Toner

FIG. 22B is a diagram illustrating a state of the recharging process of the ejection transfer residual toner. When the ejection transfer residual toner reaches the charging portion, a voltage that is equal to or greater than a discharge threshold value is applied to the charging roller 2, and the surface of the photosensitive drum 1 is charged to a post-charging potential Vp as illustrated in FIGS. 22B and 23. At the same time, the ejection transfer residual toner is recharged by the discharge at the charging portion. At this time, a negative voltage with the same polarity as the normal charge polarity of the toner is applied to prevent the toner from adhering to the charging roller 2.

In this example, the potential of the photosensitive drum reaching the charging portion is eliminated to approximately 0 V by the pre-charging exposure device 6, a charging voltage Vpri=−1200 V which is equal to or greater than the discharge threshold value is applied to the charging roller 2, and the charging contrast ΔV2 is set to satisfy ΔV2=1200 V. At the same time with imparting of a charge to the ejection transfer residual toner, the surface of the photosensitive drum 1 is charged to the post-charging potential Vp=−700 V.

The recharging of the ejection transfer residual toner will be described in detail. As described above, triboelectric charging properties of the degraded toner at the developing blade 23 has decreased due to a decrease in flowability. Although the ejected toner containing such a degraded toner having a small amount of triboelectric charging is charged by the discharge in the charging portion passing process (corresponding to FIG. 1C) in the ejection control, there may be a case where it is not possible to impart a sufficient charge to the toner in a lower layer portion if the amount of toner is large. Therefore, the degraded toner located in the lower layer in the ejected toner has a high non-electrostatic adhesion force, also has a small amount of charging (charge), is likely to remain on the photosensitive drum 1 in the degraded toner transfer process illustrated in FIG. 22A, and is likely to become the ejection transfer residual toner.

However, since the ejection transfer residual toner reaching the charging portion has been subjected to the developing portion sorting process and the degraded toner transfer process, the amount thereof is smaller than the amount of ejected toner as illustrated in FIG. 22B. Therefore, it is possible to impart a sufficient charge through the discharge when the ejection transfer residual toner passes through the charging portion. The ejection transfer residual toner becomes more likely to be transferred to the intermediate transfer belt 10 in the later process by the imparting of the charge to the ejection transfer residual toner.

### E3. Ejection Transfer Residual Toner Transfer

FIG. 22C is a diagram illustrating a state of the ejection transfer residual toner transfer process. The ejection transfer residual toner, which has passed through the charging portion, to which the charge has been imparted, does not come into contact with the developing roller 22 since the developing roller 22 is spaced apart from the photosensitive drum 1. Also, the ejection transfer residual toner reaches the transfer portion again as illustrated in FIG. 22C with the rotation of the photosensitive drum 1, and is then transferred to the intermediate transfer belt 10 by a transfer contrast ΔVtr5 (a potential difference between the post-charging potential Vp and the primary transfer voltage Vtr). Since the ejection transfer residual toner has been recharged by passing through the charging portion, and the charge has been imparted thereto, the appropriate transfer contrast ΔVtr5 is provided, an electrostatic force that is greater than the non-electrostatic adhesion force to the photosensitive drum 1 is obtained, and it is thus possible to transfer the ejection transfer residual toner. As a result, the amount of toner remaining on the photosensitive drum 1 decreases, and it is possible to suppress member contamination such as toner melt adhesion due to accumulation of the toner on the photosensitive drum 1.

The transfer contrast ΔVtr5 when the toner supply portion supplied with the toner on the photosensitive drum 1 passes through the transfer portion for the third time is preferably greater than the transfer contrast ΔVtr2 when the toner supply portion passes through the transfer portion for the second time (at the time of the degraded toner transfer process). This is because the ejection transfer residual toner is a toner that cannot be transferred with the potential difference ΔVtr2 at the time of the degraded toner transfer. In this example, the primary transfer voltage Vtr=+300 V and the post-charging potential Vp=−700 V of the charged photosensitive drum 1 after charging are set with respect to the transfer contrast ΔVtr2=900 V in example 2, and the transfer is performed with the transfer contrast ΔVtr5=1000 V. It is possible to cause the toner remaining on the photosensitive drum 1 to move to the intermediate transfer belt 10 after passing through the transfer portion twice under such control. Note that although the transfer contrast ΔVtr5 when the toner supply portion passes through the transfer portion for the third time is set to be greater than the transfer contrast ΔVtr2 when the toner supply portion passes through the transfer portion for the second time in this example, the present disclosure is not limited thereto. For example, the transfer contrast when the toner supply portion passes through the transfer portion for the fourth and fifth times may be set to be greater than the transfer contrast ΔVtr2. In other words, it is only necessary to set the transfer contrast at any timing at which the toner supply portion passes through the transfer portion when the toner supply portion passes through the transfer portion for the third time or later to be greater than the transfer contrast ΔVtr2.

### F. Cleaning of Degraded Toner

FIG. 22D is a diagram illustrating the degraded toner cleaning-up process. Here, the degraded toner also includes the ejection transfer residual toner transferred to the intermediate transfer belt 10. The processing of the toner transferred to the intermediate transfer belt 10 is similar to that in Example 2. As illustrated in FIG. 22D, the degraded toner such as the ejection transfer residual toner is sent to the cleaning device 16 by the rotation of the intermediate transfer belt 10 and is collected and processed in the waste toner accommodating container 17.

It is possible to transfer a larger part of the ejected toner that may remain on the photosensitive drum 1 to the intermediate transfer belt 10 by the above control to thereby prevent the toner melt adhesion caused by the toner continuously remaining on the photosensitive drum 1.

Note that although the image forming apparatus 100 of Example 2 and the post-rotation control method in the ejection control have been described in this example, the present disclosure is not limited thereto, and the post-rotation control can be performed in a similar manner in a case where the toner with a negative polarity may remain on the photosensitive drum 1 as in Examples 1 and 3.

### Evaluation Tests

In order to confirm the effect of suppressing the melt adhesion of the toner to the photosensitive drum 1 in Example 11, the following tests were conducted for Example 11 and Comparative Example 3 below. In an environment at a temperature of 23° C./relative humidity of 50%, feeding tests of 5000 sheets with a XEROX Business 4200 LETTER size (Xerox; trade name) as recording material P were conducted, and presence or absence of white spots due to the toner melt adhesion to the photosensitive drum 1 was verified.

Example 11: Control: Ejection control was performed. Frequency: Every 50 sheets on and after the 2500th sheet. Post-rotation control: Post-rotation control was also performed simultaneously with the ejection control.
Comparative Example 3: Control: Solid ejection control was performed. Frequency: Every 50 sheets on and after the 2500th sheet. Post-rotation control: Not performed.

Note that a configuration and operations of the image forming apparatus 100 in Comparative Example 3 were substantially the same as the configuration and the operations of the image forming apparatus 100 in this example other than the above points.

Table 5 below shows evaluation results of the tests. Table 5 shows the results of checking presence or absence of white spots in the first sheets and every 1000 sheets in Example 11 and Comparative Example 3. The cases where white spots were generated are indicated as “YES”, and the cases where no white spots were generated are indicated as “NO”.

TABLE 5

| | First | 1000th | 2000th | 3000th | 4000th | 5000th |
|---|---|---|---|---|---|---|
| | sheet | sheet | sheet | sheet | sheet | sheet |
| Example 11 | No | No | No | No | No | No |
| Comparative | No | No | No | No | Yes | Yes |
| Example 3 | | | | | | |

Although no white spots were generated until the 3000th sheet, toner melt adhesion to the photosensitive drum 1 occurred in and after the 4000th sheet, and white spots also occurred in the configuration in Comparative Example 3.

On the other hand, it was possible to minimize the toner remaining on the photosensitive drum 1 since the post-rotation control was performed in addition to the ejection control in the configuration of Example 11, no white spots due to the toner melt adhesion to the photosensitive drum 1 were generated until the 5000th sheet, and no image defects occurred.

As described above, according to the configuration of Example 11, it is possible to transfer a larger part of the ejected toner that may remain on the photosensitive drum 1 to the intermediate transfer belt 10 and to thereby prevent the toner melt adhesion occurring by the toner continuously remaining on the photosensitive drum 1.

### Example 12

Next, Example 12 according to the present disclosure will be described. An apparatus configuration of an image forming apparatus 100 according to Example 12 is similar to that of Example 2, and the image forming apparatus 100 includes a pre-charging exposure device 6.

In Example 11, the control for suppressing member contamination such as toner melt adhesion to the photosensitive drum 1 by transferring more degraded toner that may remain on the photosensitive drum to the intermediate transfer belt 10 has been described. In Example 12, a method of achieving similar effects by another mechanism will be described. Hereinafter, only differences in configurations and effects of Example 12 from those of Example 11 will be described. In the configuration of Example 12, configurations similar to those in Example 11 will be denoted by the same reference signs, and description will be omitted.

Movement of the toner in ejection control and post-rotation control according to Example 12 are similar to those in Example 11 (FIGS. 22A to 22D). However, Example 12 is different from Example 11 in a potential relationship of some of members in the post-rotation control. Therefore, differences of the post-rotation control according to Example 12 from that in Example 11 will be mainly described.

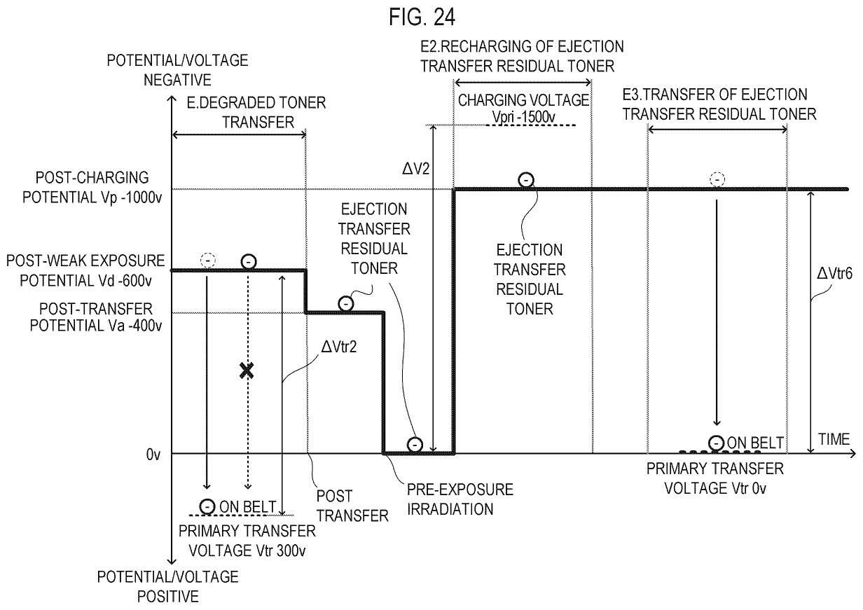

FIG. 24 is an explanatory diagram of voltage and potential control in the post-rotation control, and is a diagram schematically illustrating a potential of the photosensitive drum 1, a developing voltage, transition of a primary transfer voltage, and movement of the toner in the post-rotation control along a time axis. FIG. 24 shows a graph in which the vertical axis represents the potential/voltage and the horizontal axis represents the time, a surface potential (photosensitive drum potential) at a predetermined location moving with rotation of the photosensitive drum 1 is illustrated by the thick line, and the toner adhering to the part is also illustrated together.

In Example 12, a larger charging voltage Vpri as compared with that in Example 11 is applied to the charging roller 2, and discharge is caused with a charging contrast ΔV2 of equal to or greater than that in Example 11 as illustrated in FIG. 24 when the ejection transfer residual toner reaches the charging portion. In this manner, the post-charging potential Vp on the surface of the photosensitive drum 1 becomes large, and furthermore, the ejection transfer residual toner can be recharged by the discharge of equal to or greater than that in Example 11. In other words, since it is possible to impart a charge to the ejection transfer residual toner at a level that is equal to or greater than that in Example 11, and the ejection transfer residual toner is thus more likely to be transferred to the intermediate transfer belt 10 in the later process in Example 12.

Note that when the drum surface charged to the post-charging potential Vp reaches the developing portion, the developing roller 22 is spaced apart from the photosensitive drum 1. Accordingly, the post-charging potential Vp of the photosensitive drum 1, which is raised to be higher than that in Example 11, can be utilized to secure the transfer contrast ΔVtr6 in the following transfer process of the ejection transfer residual toner.

In this example, the potential of the photosensitive drum reaching to the charging portion is eliminated to approximately 0 V by the pre-charging exposure device 6, a charging voltage Vpri=−1500 V of equal to or greater than the discharge threshold value is applied to the charging roller 2, and the charging contrast ΔV2 is set to satisfy ΔV2=1500 V In other words, the absolute value of the charging contrast ΔV2 is set to be greater when the toner supply portion of the photosensitive drum 1 supplied with the toner passes through the charging portion again (at the time of FIG. 22B) than when the toner supply portion passes through the charging portion for the first time (at the time of FIG. 1C). At the same time with the imparting of the charge to the ejection transfer residual toner, the surface of the photosensitive drum 1 is charged to the post-charging potential Vp=−1000 V The charging voltage Vpri=−1200 V and the charging contrast ΔV2=1200 V in Example 11, and in Example 12, these values are set to be larger than those in Example 11.

The ejection transfer residual toner, which has passed through the charging portion, to which the charge has been imparted, reaches the transfer portion again as illustrated in FIG. 22C similarly to Example 11, and is then transferred to the intermediate transfer belt 10 by the transfer contrast ΔVtr6 similarly to Example 11. As a result, the amount of toner remaining on the photosensitive drum 1 decreases similarly to Example 11, and it is possible to suppress member contamination such as toner melt adhesion due to accumulation of the toner on the photosensitive drum 1.

Note that the transfer contrast ΔVtr6 at this time is preferably greater than the transfer contrast ΔVtr2 at the time of the degraded toner transfer process for a reason similar to that in Example 11. In this example, the primary transfer voltage Vtr=0 V and the post-charging potential Vp=−1000 V are set such that the transfer is performed with the transfer contrast ΔVtr6=1000 V, with respect to the transfer contrast ΔVtr2=900 V in Example 2.

The processing of the toner transferred to the intermediate transfer belt 10 is similar to that in Examples 2 and 11. In other words, the toner transferred to the intermediate transfer belt 10 is sent to the cleaning device 16 by rotation of the intermediate transfer belt 10 and is then collected and processed in the waste toner accommodating container 17.

Note that although the image forming apparatus 100 of Example 2 and the post-rotation control method in the ejection control have been described in this example, the present disclosure is not limited thereto, and the post-rotation control can be performed in a similar manner in a case where the toner with a negative polarity may remain on the photosensitive drum 1 as in Examples 1 and 3.

Since it is possible to transfer a part of the ejected toner that may remain on the photosensitive drum 1 to the intermediate transfer belt 10 by the above control, it is possible to prevent toner melt adhesion caused by the toner continuously remaining on the photosensitive drum 1.

### Other Examples

The image forming apparatus 100 includes a plurality of image forming portions corresponding to toners of different colors. In the case where the primary transfer voltage Vtr is applied by the primary transfer power source 15 shared by stations constituting the image forming portions as in the image forming apparatus 100 of this example, the transfer contrast may be adjusted by individually adjusting the charging voltage Vpri for each station. Note that the stations refer to units constituting the image forming portions and in this example, four stations are provided in the image forming apparatus 100. In other words, it is possible to suppress unnecessary discharge by reducing the transfer contrast for stations where the ejection control is not being executed while forming the transfer contrast ΔVtr5 necessary for the transfer for the stations where the ejection control is being executed.

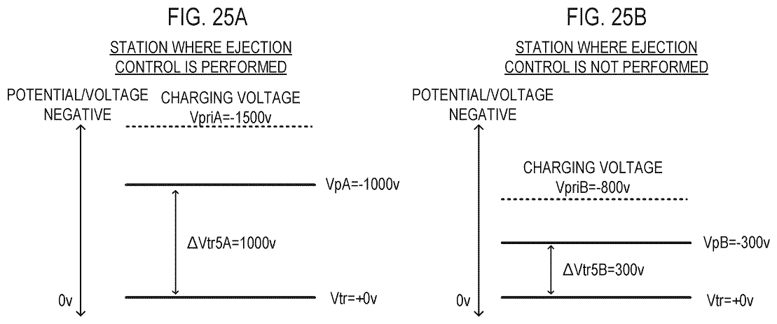

A method of individually adjusting the transfer contrast will be described as an illustrative example. FIGS. 25A and 25B are explanatory diagram of an example in which the transfer contrast is individually adjusted. FIG. 25A illustrates a control example of a voltage of a station where ejection control is performed. FIG. 25B illustrates a control example of a voltage of a station where the ejection control is not performed.

Hereinafter, a case where a first station (first image forming portion) where the ejection control is performed and a second station (second image forming portion) where the ejection control is not performed are present will be described as an example. The following description will be given in a distinguished manner by applying A to the reference sign of each potential (voltage) in the first station where the ejection control is performed and applying B to the reference sign of each potential (voltage) in the second station where the ejection control is not performed. However, since the primary transfer voltage Vtr is the same in each station, the primary transfer voltage Vtr is not particularly distinguished.

As illustrated in FIG. 25A, for example, a transfer contrast ΔVtr5A in the post-rotation control is formed by the primary transfer voltage Vtr=+0 V and the post-charging potential VpA=−1000 V in the first station where the ejection control is performed in Example 12.

On the other hand, there is no need to form the transfer contrast ΔVtr5=1000 V in the second station where the ejection control is not performed as illustrated in FIG. 25B. Thus, the charging voltage VpriB is controlled to satisfy VpriB=−800 V, and the post-charging potential VpB is set to satisfy VpB=−300 V in the second station where the ejection control is not performed. Therefore, the transfer contrast ΔVtr5B=300 V in the second station where the ejection control is not performed, and it is possible to achieve a potential difference that is smaller than ΔVtr5=1000 V. It is possible to suppress discharge at the station (image forming portion) where the ejection control is not performed and to prevent generation of a discharge product by such control. In a case where it is not possible to individually adjust the charging voltage for each stage as in the above description (in a case where the charging power source is commonly used, for example), the transfer contrast ΔVtr5 may be adjusted by individually adjusting the amount of exposure for each station.

Although the transfer contrast is set to be large to transfer the toner containing a large amount of degraded toner on the photosensitive drum 1 to the intermediate transfer belt 10 in Examples 11 and 12, the present disclosure is not limited thereto. In a case where the engine control portion 210 can control the rotation speed of the intermediate transfer belt 10 and the rotation speed of the intermediate transfer belt 10 can be individually changed, for example, a speed difference may be provided for each photosensitive drum 1, and physical transfer from the photosensitive drum 1 may be performed.

An example in which the physical transfer from the photosensitive drum 1 is performed by changing the rotation speed of the intermediate transfer belt 10 and providing a speed difference to the photosensitive drum 1 will be specifically described. The rotation speed of the photosensitive drum 1 and the rotation speed of the intermediate transfer belt 10 at the timing at which the ejected toner is transferred are defined as v1 and v2, respectively, and the rotation speed of the photosensitive drum 1 and the rotation speed of the intermediate transfer belt 10 at the timing at which the ejection transfer residual toner is transferred are defined as v3 and v4, respectively. At this time, the speed difference |v3−v4| between the rotation speeds of the photosensitive drum 1 and the intermediate transfer belt 10 at the transfer timing of the ejection transfer residual toner is set to be larger than the speed difference |v1−v2| between the rotation speeds of the photosensitive drum 1 and the intermediate transfer belt 10 at the transfer timing of the ejected toner. A physical peeling force from the photosensitive drum 1 is thus generated, and it is possible to improve transfer properties. Note that in order to generate a physical peeling force by the speed difference, the rotation speed of the photosensitive drum 1 may be set to be higher than the rotation speed of the intermediate transfer belt 10, or the rotation speeds may be set in an opposite manner. Here, the rotation speeds of the photosensitive drum 1 and the intermediate transfer belt 10 refer to the moving speeds of the surfaces of the members.

Although the transfer of the ejection transfer residual toner is completed once in Examples 11 and 12, the present disclosure is not limited thereto. For example, the transfer may be repeated until more ejection transfer residual toner is transferred to the intermediate transfer belt 10. Furthermore, the transfer contrast ΔVtr5 may be increased as the number of turns increases, for example, such that more ejection transfer residual toner is transferred to the intermediate transfer belt 10.

Since it is possible to transfer a part of the ejected toner that may remain on the photosensitive drum 1 to the intermediate transfer belt 10 by the above control, it is possible to prevent toner melt adhesion caused by the toner continuously remaining on the photosensitive drum 1.

### Example 13

Next, Example 13 according to the present disclosure will be described. Hereinafter, only differences in configurations and effects of Example 13 from those of Example 1 will be described. In the configuration of Example 13, configurations similar to those in Example 1 will be denoted by the same reference signs, and description will be omitted.

### Average Printing Rate

Depending on a history of printed images, proportions of the degraded toner and the fresh toner on the developing roller 22 and inside the developing units 4 differ. Since the fresh toner is consumed in a midpoint stage in which the fresh toner shifts to the degraded toner in a region where the amount of used toner is large in the longitudinal direction of the developing roller 22 intersecting (perpendicularly intersecting in this example) the conveying direction of the recording material P, the proportion of the degraded toner is low. On the other hand, since the toner staying in the developing units 4 and on the developing roller for long periods of time increases in a region where the amount of used toner is small, the proportion of the degraded toner is high.

The longitudinal direction of the developing roller 22 is a rotation axis direction of the developing roller 22 and is a direction parallel to the longitudinal direction of the photosensitive drums 1 and the like. Also, the longitudinal direction of the developing roller 22 is substantially parallel to the width direction of the recording material P conveyed inside the image forming apparatus 100.

In Example 13, a sheet region which is a region on the developing roller 22 corresponding to the recording material P is divided into a plurality of regions in the longitudinal direction (the direction perpendicularly intersecting the sheet conveying direction) of the developing roller 22, and an average printing rate for each region is acquired. Also, the proportion of the degraded toner for each region is acquired on the basis of the acquired average printing rate. Hereinafter, a method of acquiring the proportion of the degraded toner for each region obtained by dividing the sheet region in the longitudinal direction will be described. In the following description, the direction parallel to the longitudinal direction of the developing roller 22 to divide the sheet region is defined as a division direction E.

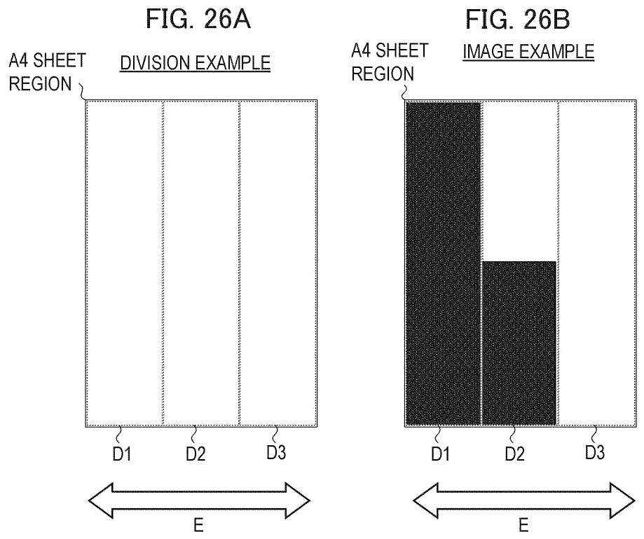

FIGS. 26A and 26B are explanatory diagrams of a method of dividing the sheet region according to Example 13. FIG. 26A illustrates a division example of a sheet region (A4 sheet region) in a case where an A4 sheet is used. In this example, the A4 sheet region is divided into three parts in the division direction E. The divided regions are defined as D1, D2, and D3 regions from one end side (the left side in FIG. 26A) in the division direction E. The A4 sheet region has a size of 210 mm width×297 mm. Each region after the division has the same size, and the size of each region has an equal size of 70 mm×297 mm. In a case of 600 dpi, for example, each region is configured of 1654×7016=11604464 pixels. However, the present disclosure is not limited to such a configuration, and the size of each region may be different, or the number of divided regions may be increased.

FIG. 26B is a diagram illustrating an example in which an image is formed in the A4 sheet region in the division example in FIG. 26A. A rule for counting the number of pixels will be described by exemplifying the image illustrated in FIG. 26B. In this example, a case of the process cartridge S for a toner color Bk will be described.

Each pixel has density information of 0 to 255. In each of the D1, D2, and D3 regions, the total number of pixels with the density information of greater than zero is calculated. Since the number of pixels where the toner is present is counted, the total calculated number will be referred to as the total number of toner pixels.

The image illustrated in FIG. 26B includes a black solid image in an entire D1 region and a black solid image in half a D2 region, and no pixels having density information are present in a D3 region. Note that “solid” means a portion of a group of pixels with density information 255. The total number of toner pixels in each region is 11604464 in the D1 region, 5802232 in the D2 region, and 0 in the D3 region. A value obtained by dividing the total number of toner pixels by the total number of pixels in each region and multiplying the obtained value by 100 will be referred to as a printing rate. The printing rate for each region is calculated for each sheet, and an average printing rate in each region is calculated. In this manner, the engine control portion 210 may be caused to have such a function of the printing rate acquisition portion that divides the sheet region (the region on the developing roller 22 in the longitudinal direction corresponding to the recording material P) and acquires the average printing rate for each region, for example. Alternatively, a configuration in which a control portion functioning as the printing rate acquisition portion is provided separately from the engine control portion 210 may be adopted.

### Average Printing Rate and Degraded Toner Proportion

Evaluation tests were conducted to investigate a relationship between the printing rate and the degraded toner proportion. In the tests, 3 kinds of images with different printing rates, which were 1%, 5%, and 10%, were prepared, sheet feeding was repeated, and 1000 sheets were fed. The density information of all pixels to be printed was set to 255.

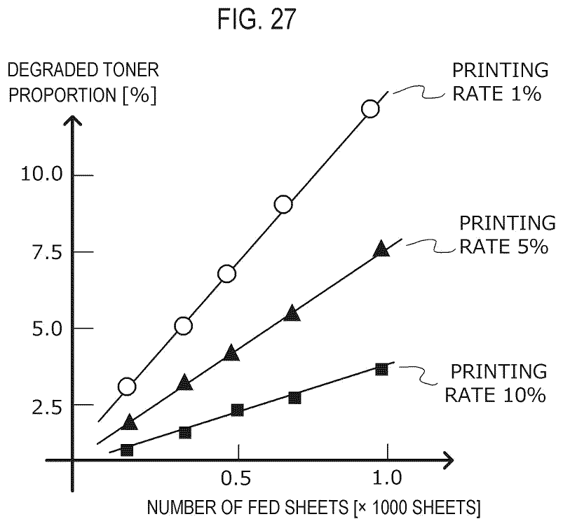

FIG. 27 is an explanatory diagram of a relationship of the number of fed sheets, the printing rate, and the degraded toner proportion and shows results of the evaluation tests. FIG. 27 shows a graph in which the horizontal axis represents the number of fed sheets [×1000 sheets] and the vertical axis represents the degraded toner proportion [%], and the number of fed sheets and the proportion of the degraded toner on the developing roller 22 are shown.

In the process of the feeding of 1000 sheets, the toner on the developing roller 22 was collected, and the proportion of the deformed degraded toner was calculated. In order to calculate the proportion of the degraded toner, average circularity (aspect ratio) of the collected toner was checked by a flow-based particle image analyzer “FPIA-3000” (manufactured by Sysmex Corporation). As described above, the case where the average circularity is less than 0.90 is defined as “degraded”.

As illustrated in FIG. 27, it was possible to confirm that the proportion of the degraded toner decreased as the printing rate increased. In a case where the printing rate is high, the toner with which the surface of the developing roller 22 is coated moves to the photosensitive drum 1 before changing from the fresh toner to the degraded toner, further moves to the intermediate transfer belt 10, and is then transferred to and fixed on the sheet. Therefore, in a case where the printing rate is high, the number of opportunities of degradation of the toner is small, and the proportion of the degraded toner is thus considered to be low. Conversely, in a case where the printing rate is low, the number of opportunities of movement of the toner, with which the surface of the developing roller 22 is coated, to the sheet is small. Therefore, the number of times the developing roller 22 and the photosensitive drum 1 rub against each other and the frequency of the rubbing are high, and it is thus considered that the proportion of the degraded toner is high.

Furthermore, the printing rate and the degraded toner proportion were not proportional to each other. A consideration will be given on the fact that the printing rate and the degraded toner proportion were not proportional to each other. In a case where the printing rate is low, a region outside the printing region is wide. Also, a fogging toner is ejected to the region. However, the printing rate is not a numerical value taking the fogging toner into consideration. The amount of fogging toner differs depending on the printing rate. It is considered that the printing rate and the degraded toner proportion were thus not proportional to each other.

### Degraded Toner Level and Toner Ejection Pattern

As described above, it was possible to ascertain that as the average printing rate was lower, the degraded toner proportion was higher, as a result of checking the relationship between the average printing rate and the degraded toner. Although the toner ejection control can be executed even with the same density pattern as the toner ejection pattern for all the regions, it is desirable to perform the toner ejection control with toner ejection patterns in accordance with a proportion in a case where it is possible to calculate the degraded toner proportion.

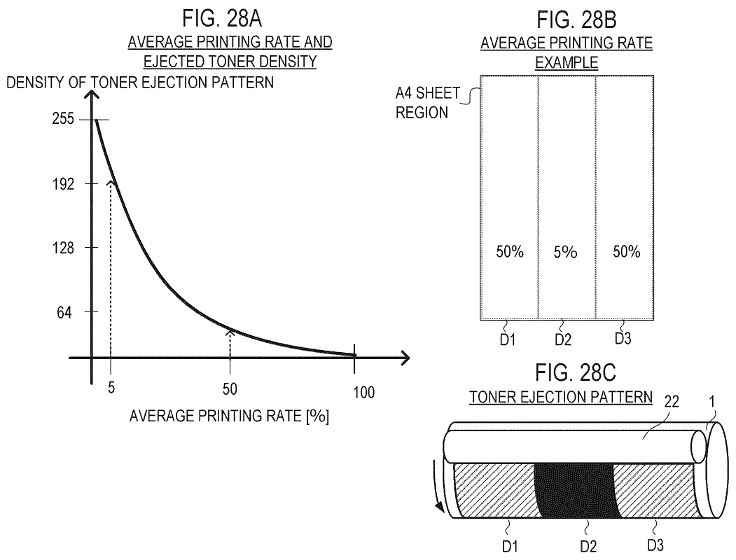

Thus, in Example 13, the ejection control is executed on the basis of the average printing rate acquired from a printing history of the image forming operation before the execution of the ejection control using the relationship of the average printing rate and the density of the toner ejection pattern defined in advance. FIGS. 28A to 28C are explanatory diagrams of the ejection control according to Example 13 and illustrate the relationship between the average printing rate and the density of the toner ejected in the toner ejection control.

FIG. 28A is a diagram illustrating the relationship between the average printing rate and the density of the toner ejection pattern. FIG. 28A shows a graph in which the horizontal axis represents the average printing rate [%] and the vertical axis represents the density of the toner ejection pattern (maximum value is 255). FIG. 28A shows the relationship in which the average printing rate is inversely proportional to the density of the toner ejection pattern. In Example 13, the density of the toner ejection pattern in each divided region at the time of the ejection control is determined on the basis of the average printing rate in each divided region by utilizing such a relationship. Specifically, the density of the ejection pattern is controlled to be high in a case where the average printing rate is low and the amount of degraded toner is large, and the density of the ejection pattern is controlled to be low in a case where the average printing rate is high and the amount of degraded toner is small. In other words, it is possible to state that the amount of ejected toner (the amount of toner to be moved from the developing roller 22 to the photosensitive drum 1) at the time of the ejection control is determined on the basis of the average printing rate instead. The density of the ejection, that is, the amount of ejected toner is adjusted by controlling various applied voltages and the amount of exposure.

FIG. 28B is a diagram illustrating average printing rates in the three divided regions D1, D2, and D3. FIG. 28B illustrates an example in which the average printing rate in the D1 region is 50%, the average printing rate in the D2 region is 5%, and the average printing rate in the D3 region is 50%.

FIG. 28C is a diagram illustrating the toner ejection patterns determined on the basis of the average printing rates in the example illustrated in FIG. 28B. The ejection patterns at the positions corresponding to the D1 region and the D3 region are expressed by the hatched portions, and the ejection pattern at the position corresponding to the D2 region is expressed by the black portion. Density information of the hatched portions is 40, and density information of the black portion is 194. In this manner, the sheet region is divided in the ejection control, and the toner ejection pattern (density) is determined on the basis of the average printing rate in each sheet region in Example 13.

The reason that the toner ejection pattern density adjustment is executed in accordance with the average printing rate will be described. Although it is basically attempted to move only the degraded toner to the intermediate transfer belt 10 at the time of the toner ejection control, a small amount of fresh toner may also move to the intermediate transfer belt 10 at the same time. If the amount of degraded toner is small in the ejected toner image, it is desirable to control the density of the toner ejection pattern to be low in view of a risk of losing the fresh toner. On the other hand, it is necessary to remove a large amount of degraded toner in one toner ejection control in a case where the fact that the amount of degraded toner is large in the toner ejection pattern is known. Therefore, it is desirable to control the density of the toner ejection pattern to be high. Therefore, in order to efficiently process the degraded toner while suppressing processing of the fresh toner, it is desirable to adjust the density of the toner ejection pattern on the basis of the average printing rates.

According to the above-described toner ejection control, the density of the toner ejection pattern can be changed in accordance with the degraded toner proportion, and it is possible to achieve both reduction of the risk of losing the fresh toner and removal of the degraded toner with high efficiency.

### Example 14

Next, Example 14 according to the present disclosure will be described. Hereinafter, only differences in configurations and effects of Example 14 from those of Example 1 will be described. In the configuration of Example 14, configurations similar to those in Example 1 will be denoted by the same reference signs, and description will be omitted.

In Example 1, 5000-sheet print tests were conducted on the basis of the standards ISO/IEC19798 for measurement of the cartridge printable number. The degraded toner was ejected by carrying out the toner ejection control at a frequency of once every 50 sheets from the 2500th printing, which corresponded to the latter half of the lifetime, and satisfactory images with no occurrence of development collection defects were obtained until 5000 sheets, which are the lifetime of the process cartridge.

However, in a case where the toner printing rate is low, the amount of toner consumed from the inside of the developing unit 4 is small, and there is thus a trend that the printable number increases as compared with a case where images with high printing rates are printed. For example, in a case where the printing rate of each toner is 1% in the printing tests based on ISO/IEC19798, the printable number increases, and it is thus possible to perform printing on about 5000 sheets or more as compared with the case of Example 1. In a case where the printable number increases, the time of toner rubbing caused between the developing roller 22 and the developing blade 23 increases, and the toner with promoted degradation thus occurs in the latter half of duration.

Accordingly, a method of reducing development collection defects that is particularly suitable for a case where the printing rate is low and the number of prints increases will be described in Example 14. In this example, control performed on the assumption of a case where the printing rate of each color toner for the LETTER size is lower than that of ISO/IEC19798, specifically, an example in which the printing rate of each color toner is 1% will be described.

In this example, a control method in which an execution interval of the ejection control is adjusted in accordance with the degree of toner degradation in order not to cause image defects even in a case of a low printing rate, such as a printing rate of 1% for each color, will be described.

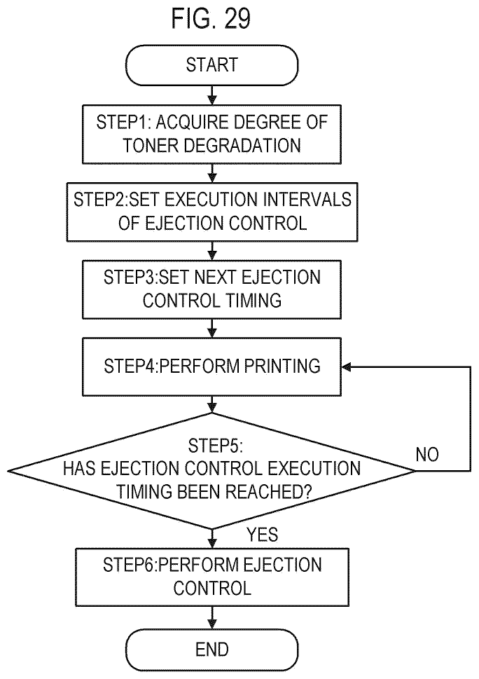

FIG. 29 is a flow chart of the pre-ejection control performed before the ejection control according to Example 14. Operations until the ejection control in this example is performed will be described using FIG. 29. In this example, a case where a print operation is performed using only a yellow station will be described as an example. Furthermore, it is possible to cause the control portion such as an engine control portion 210 to perform calculation, drive control, and the like in the following STEPS.

The pre-ejection control can be started using a start of a print job, for example, as a trigger. Once the pre-ejection control is started, the engine control portion 210 first acquires (calculates) the degree of toner degradation in STEP 1. Although the number of prints is used as an indicator indicating the degree of toner degradation in this example, other indicators may be used. As other indicators, it is possible to use, for example, the number of toners consumed from the inside of the developing unit 4 (the amount of toner developed on the photosensitive drum 1), the number of rotations and the drive time of the developing roller 22, the number of rotations and the drive time of the photosensitive drum 1, and the like. It is only necessary to set the indicator to narrow the execution interval with a progress of toner degradation irrespective of the indicators.

Next, in STEP 2, the engine control portion 210 sets the execution interval of the ejection control on the basis of the degree of toner degradation acquired in STEP 1. In this example, the interval of the number of prints at which the ejection control is performed is defined as the execution interval of the ejection control. Note that the function of the interval determining portion that determines the execution interval of the ejection control on the basis of the indicator indicating the degree of toner degradation may be provided in the engine control portion 210, or another control portion functioning as the interval determining portion may be provided.

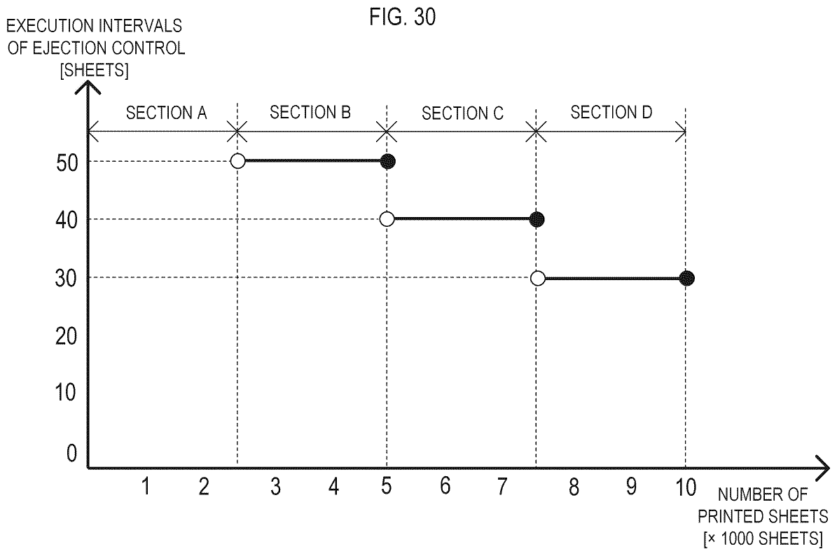

Example 14 is configured to change the execution interval of the ejection control in accordance with the cumulative number of prints. A method of determining the execution interval of the ejection control in this example will be described using FIG. 30. FIG. 30 is an explanatory diagram of a method of setting an execution interval of ejection control according to Example 14. FIG. 30 shows a graph in which the horizontal axis represents the number of printed sheets [×1000 sheets] and the vertical axis represents the ejection control interval [number of sheets].

FIG. 30 shows a plurality of sections in accordance with the number of printed sheets. The section A is a section where the number of printed sheets is 0 to 2,500 and the ejection control is not performed. The section B is a section where the number of printed sheets is 2,500 to 5,000 and ejection control is performed at an interval of once every 50 sheets. The section C is a section where the number of printed sheets is 5,000 to 7500 and ejection control is performed at an interval of once every 40 sheets. The section D is a section where the number of printed sheets is 7,500 to 10,000 and ejection control is performed at an interval of once every 30 sheets. As described above, control is performed such that the ejection control interval decreases in a stepwise manner with an increase in number of printed sheets in Example 14.

Next, in STEP 3, the engine control portion 210 sets a timing at which the next ejection control is performed. In this example, the number of printed sheets for performing the next ejection control is defined. The timing at which the next ejection control is performed is determined on the basis of the execution interval of the ejection control determined in STEP 2.

Next, in STEP 4, the engine control portion 210 performs the print operation. Then, in STEP 5, the engine control portion 210 determines whether or not the execution timing of the ejection control has been reached every time printing is performed on one sheet. In a case where the execution timing is not reached, the processing returns to STEP 4, and the engine control portion 210 performs the next print operation. In a case where the execution timing has been reached, the processing proceeds to STEP 6, and the engine control portion 210 performs the ejection control. Once the ejection control is performed, the series of operations are ended. Then, once a new print job is received, the processing returns to START again, and the calculation of the degree of toner degradation in STEP 1 is performed according to the flow.

Note that in a case where a print job includes a plurality of instructions for image forming operation and the ejection control execution timing in STEP 5 is reached during execution of the print job, the print job is interrupted, the processing proceeds to STEP 6, and the engine control portion 210 performs the ejection control. After the ejection control is ended, the rest part of the print job is performed. Then, after the ejection control is ended, the rest part of the print job is executed. Note that a configuration in which whether or not the print job has been ended is determined after STEP 6 and the processing returns to STEP 4 on the basis of the determination result may be adopted.

Note that although the processing returns to STEP 4 and printing is continued in the case where the ejection control execution timing is not reached in STEP 5 in the example in FIG. 29, the processing may be returned to STEP 1, and the degree of toner degradation may be calculated again. As a reason that the degree of toner degradation is calculated again in the process of the print job, a case where the printing rate is included as a calculation parameter for the degree of toner degradation, for example, is conceivable. In a case where a print job of various printing rates is performed, progress degrees of toner degradation differ depending on each print, and it is thus possible to perform the ejection control at a timing suitable for actual toner degradation by calculating the degree of toner degradation again every time printing is performed on one sheet.

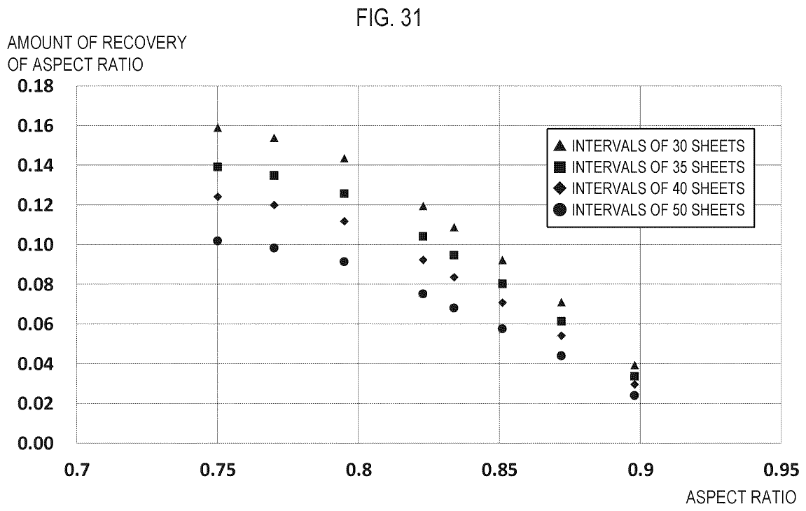

Next, influences of a change in execution interval of the ejection control on the aspect ratio will be described using FIG. 31. FIG. 31 is an explanatory diagram of a relationship between the execution interval of the ejection control and the aspect ratio. FIG. 31 shows the amount of recovery of the aspect ratio of the toner when printing is performed on 1000 sheets by changing the execution interval of the ejection control in a case where printing is performed a printing rate of 1% for each color. FIG. 31 shows a graph in which the horizontal axis represents the aspect ratio before the ejection control is performed and the vertical axis represents the amount of recovery of the aspect ratio. In FIG. 31, results obtained when the execution interval of the ejection control is set to an interval of every 30 sheets, an interval of every 35 sheets, an interval of every 40 sheets, and an interval of every 50 sheets are plotted. Note that the amount of recovery of the aspect ratio is an amount indicating how much the average aspect ratio has been recovered (improved). For example, in a case where the execution interval of the ejection control is an interval of every 50 sheets as illustrated in FIG. 31, the amount of recovery of the aspect ratio when the aspect ratio is 0.75 is about 0.10. This means that the aspect ratio 0.75 is recovered by 0.10 and becomes 0.85.

As illustrated in FIG. 31, a trend that the amount of recovery of the aspect ratio increased as the execution interval of the ejection control decreased was observed. Also, there was a trend that the amount of recovery of the aspect ratio when the ejection control was performed decreased as the aspect increased irrespective of the execution interval. This is because, in a state where the aspect ratio is large, the proportion of the degraded toner in the developing unit 4 is small, and substantially no degraded toner is ejected to the photosensitive drum 1 even if the ejection control is performed.

In view of this point, it is desirable to change the execution interval of the ejection control in accordance with the degree of toner degradation as in Example 14. In other words, it is desirable that the ejection control be not performed until the degradation of the toner progresses to some extent from the new product state when the number of printed sheets is small and the execution interval of the ejection control be narrowed in the latter half of the lifetime when the degradation of the toner is likely to progress. It is possible to maintain satisfactory image quality while minimizing occurrence of the downtime by executing such control.

Note that although the trend in FIG. 30 is an example, and the amount of recovery of the aspect ratio differs depending on various toner properties and the like such as the shape of the developing device, the amount of filling of the toner inside the developing device, and hardness of the toner, the trend that the amount of recovery of the aspect ratio increases as the execution interval of the ejection control decreases does not change.

### Evaluation Tests

Table 6 shows the transition of the image rank and the aspect ratio of the toner with respect to the durable number of sheets when the print tests were conducted, as results of various print tests. Note that evaluation criteria for the image rank, that is, presence or absence of image defects are similar to those in the evaluation tests in Example 1, and cases where development collection defects (image defects) that are more serious than those evaluated as the rank C were evaluated as D.

Table 6 shows results of tests similar to the evaluation tests in Example 1 first, which is a print tests based on ISO/IEC19798. In the tests, the maximum number of fed sheets is 5,000. Table 6 further shows results obtained when printing tests at the printing rate of 1% for each color was conducted up to 10,000 fed sheets in the configuration of Example 1, as Comparative Example 4. In Example 1 and Comparative Example 4, the ejection control was conducted at a frequency of once every 50 sheets on and after the 2500th sheet in each print test. Table 6 further shows results obtained when the print tests at the printing rate of 1% for each color were conducted up to 10,000 fed sheets, as Example 14. In Example 14, the frequency of the ejection control is changed in accordance with the number of printed sheets as illustrated in FIG. 30.

TABLE 6

| | | First | 1000th | 2000th | 3000th | 4000th | 5000th | 6000th | 7000th | 8000th | 9000th | 10000th |
|---|---|---|---|---|---|---|---|---|---|---|---|---|
| | | sheet | sheet | sheet | sheet | sheet | sheet | sheet | sheet | sheet | sheet | sheet |
| Example 1 | Image rank | A | A | A | A | A | A | — | — | — | — | — |
| (ISO/IEC19798) | Aspect ratio | 0.953 | 0.942 | 0.925 | 0.920 | 0.912 | 0.903 | — | — | — | — | — |
| Comparative | Image rank | A | A | A | A | A | A | B | C | D | D | D |
| Example 4 | Aspect ratio | 0.953 | 0.942 | 0.925 | 0.920 | 0.912 | 0.903 | 0.895 | 0.890 | 0.875 | 0.854 | 0.825 |
| (printing rate of | | | | | | | | | | | | |
| 1% for each color) | | | | | | | | | | | | |
| Example 14 | Image rank | A | A | A | A | A | A | A | A | A | A | A |
| (printing rate of | Aspect ratio | 0.953 | 0.942 | 0.925 | 0.920 | 0.912 | 0.903 | 0.910 | 0.905 | 0.913 | 0.908 | 0.902 |
| 1% for each color) | | | | | | | | | | | | |

As shown in Table 6, the image rank transitioned as the rank A up to the 5,000th fed sheet, which corresponds to the lifetime of the developing unit 4, in the print tests based on ISO/IEC19798 in Example 1. This is because the speed of decrease in aspect ratio is reduced by performing the ejection control and the aspect ratio of equal to or greater than 0.9 is kept even at the timing of the 5,000th sheet.

In Comparative Example 4, that is, in a case where the printing rate for each color is 1%, all the image ranks up to the 5,000th fed sheet are evaluated as the rank A, and no image defects occurred. Also, the transition of the aspect ratio is approximately equivalent to that in the case of ISO/IEC19798. This is because the amount of remaining toner inside the developing unit 4 is large and the likelihood that the toner rubs against the developing roller 22 and the developing blade 23 is low.

On the other hand, image defects of the rank B occurred when the number of fed sheets was 6,000, and image defects of the rank C and image defects of the rank D occurred when the number of fed sheets was 7,000 and when the number of fed sheets was 8000 or more, respectively, in Comparative Example 4. Note that the lifetime of the process cartridge S in the case where the print tests at the printing rate of 1% for each color were conducted was defined as 10,000 sheets in this example. It is not always necessary to determine the definition of the lifetime of the process cartridge S on the basis of the amount of remaining toner inside the developing unit 4, and the lifetime may be defined by degrees of degradation of various members, such as the amount of wear of the surface layer of the photosensitive drum 1 or a decrease in surface properties due to deposition of adhering substances to the surface of the developing roller 22 or rotation. In this example, 10,000 sheets are defined as the lifetime in view of the amount of wear of the surface layer of the photosensitive drum 1.

As shown in Table 6, no image defects occurred even after the number of fed sheets reached 10,000 and the image rank was evaluated as A in the feeding duration at the printing rate of 1% for each color in Example 14 in which the ejection control was performed at the execution interval illustrated in FIG. 30. Also, it was possible to maintain the aspect ratio to be equal to or greater than 0.9 throughout the duration.

As described above, according to the control method of Example 14, it is possible to suppress image defects by adjusting the execution interval of the ejection control in accordance with the toner degradation state even in a case where the printing rate of the toner is low and the toner degradation progresses over a long period of time.

### Modification 7

Although the execution interval of the ejection control was changed for every 2,500 fed sheets as illustrated in FIG. 31 in Example 14, the present disclosure is not limited to such a configuration. Hereinafter, a control example in which the method of setting the execution interval of the ejection control is changed will be described as Modification 7 according to Example 14. Hereinafter, parts (configurations, effects, and the like) similar to those in Example 14 will be denoted by the same reference signs, and description will be omitted.

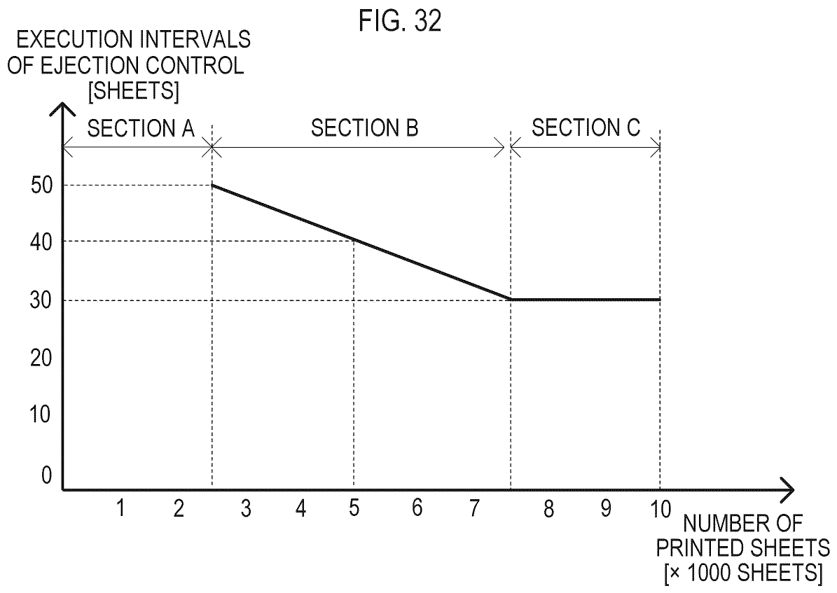

FIG. 32 is an explanatory diagram of a method of setting an execution interval of ejection control according to Modification 7. FIG. 32 shows a graph in which the horizontal axis represents the number of printed sheets [×1000 sheets] and the vertical axis represents the ejection control interval [number of sheets].

FIG. 32 shows a plurality of sections in accordance with the number of printed sheets. The section A is a section where the number of printed sheets is 0 to 2,500 and the ejection control is not performed. The section B is a section where the number of printed sheets is 2,500 to 7,500 and the execution interval of the ejection control gradually decreases with an increase in number of printed sheets. In the section B, the number of printed sheets and the execution interval of the ejection control are in a proportional relationship such that the ejection control is performed at an interval of once every 50 sheets when the number of printed sheets is 2,500 and the ejection control is performed at an interval of once every 30 sheets when the number of printed sheets is 7,500. The section C is a section where the number of printed sheets is 7,500 to 10,000 and ejection control is performed at an interval of once every 30 sheets.

Thus, the control is performed such that the ejection control interval successively decreases with an increase in number of printed sheets in a specific section in Modification 7. Even with such a control method, it is possible to suppress image defects by adjusting the execution interval of the ejection control in accordance with the toner degradation state even in a case where the toner printing rate is low and the degradation of the toner progresses over a long period of time.

### Modification 8

Furthermore, although the print job is interrupted in a stage in which the ejection control execution timing is reached and the ejection control is performed as illustrated in FIG. 29 in Example 14, the present disclosure is not limited to such a configuration. Hereinafter, a control example in which the ejection control is performed after a series of print job is ended without interrupting the print job in the middle will be described as Modification 8 according to Example 14. Hereinafter, parts (configurations, effects, and the like) similar to those in Example 14 will be denoted by the same reference signs, and description will be omitted.

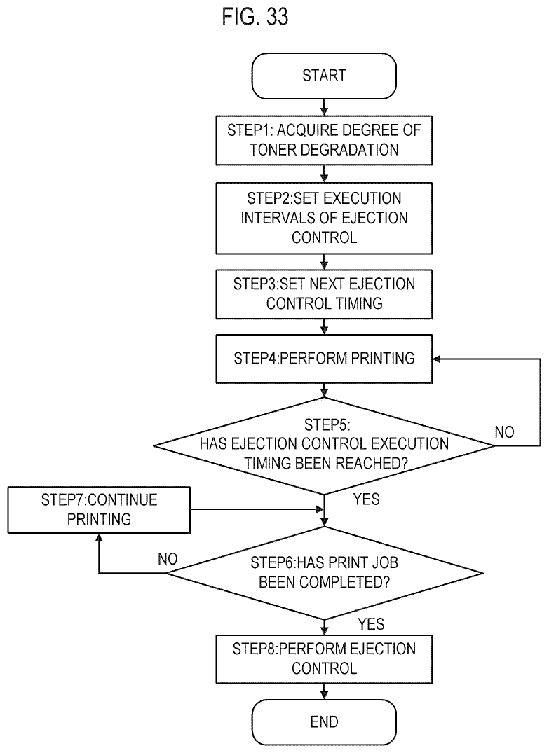

FIG. 33 is a flowchart of pre-ejection control performed before the ejection control according to Modification 8. The pre-ejection control of Modification 8 is different from the pre-ejection control of Example 14 in that whether or not a print job has been ended is determined in STEP 6.

In Modification 8, in a case where it is determined in STEP 6 that the print job is being executed and the print job has not been completed, the processing proceeds to STEP 7, and the printing is continued. Once the printing is completed, the processing returns to STEP 6 again, and the determination is made. On the other hand, in a case where it is determined in STEP 6 that the print job has been completed, the processing proceeds to STEP 8, and the ejection control is performed.

Even with such a control method, it is possible to suppress image defects by adjusting the execution interval of the ejection control in accordance with the toner degradation state even in a case where the toner printing rate is low and the degradation of the toner progresses over a long period of time. Furthermore, the print job is not interrupted in the middle, and it is thus possible to suppress an increase in execution time of the print job.

Note that the case where the print operation is performed in one station has been described as an example in Example 14 and Modification 8. In a case where the print operation is performed in the four stations, the ejection control may be performed for all the stations, and the counts of the number of printed sheets until the next execution may be reset, when any of the four stations has reached the execution timing of the ejection control.

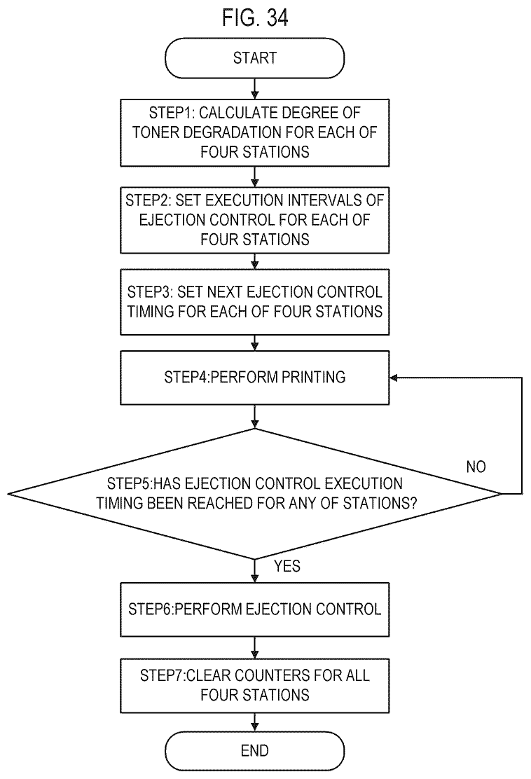

A control example of the pre-ejection control when the print operation is performed by all the four stations will be described using FIG. 34. FIG. 34 is a flowchart of the pre-ejection control according to Example 14, and illustrates operations of the pre-ejection control when all the four stations perform the print operation.

First, STEPS 1 to 4 are substantially similar to those in the flowchart illustrated in FIG. 29. In other words, the degree of toner degradation of each of the four stations is calculated in STEP 1, the ejection control interval is set for each of the four stations in STEP 2, and the timing of the next ejection control for each of the four stations is set in STEP 3. Then, printing is performed in all the four stations in STEP 4.

Next, whether or not the execution timing of the ejection control has been reached in any of the stations is determined in STEP 5. When the execution timing of the ejection control is not reached at any station, the process returns to the STEP 4 to execute the print operation again. On the other hand, in a case where the execution timing has been reached, the processing proceeds to STEP 6, and the ejection control is performed. At this time, the ejection control in STEP 6 is performed for all the stations.

Next, the number of printed sheets until the next ejection is cleared for the stations other than the station that has reached the execution timing of the ejection control in STEP 7.

Once the ejection control is performed, the series of operations end, the processing returns to START, and the calculation of the degree of toner degradation is performed in STEP 1 according to the flow.

It is possible to prevent the downtime from frequently occurring due to the ejection control, by performing the ejection control for all the stations when the ejection control execution timing is reached for any of the stations. However, in a case where it is not necessary to take account of the influences of the downtime that much, such as a case where the execution interval of the ejection control is long, the ejection control may be performed only for the station that has reached the execution timing of the ejection control.

In that case, the ejection control in STEP 6 is performed only for the station that has reached the ejection control timing, and the counter of the number of printed sheets until the next ejection may be cleared only for the station for which the ejection control has been performed in STEP 7.

### Modification 9

Next, a method of setting the potential of the photosensitive drum 1 and the developing voltage Vdc when the ejection control is performed will be described.

The execution of the ejection control described in this example has been described on the assumption that the same potential of the photosensitive drum 1 and primary transfer voltage are set irrespective of the interval of the ejection control. However, even if the aspect ratio is the same, there is a likelihood that toners of various degrees of degradation are present together and the ejection performance from the photosensitive drum 1 to the intermediate transfer belt 10 is degraded with a progress of the lifetime of the process cartridge S. Accordingly, the setting of the primary transfer voltage Vtr may be controlled to change in accordance with the lifetime of the process cartridge S and the degree of toner degradation in each of the aforementioned examples. Hereinafter, an example in which the setting of the primary transfer voltage Vtr is changed in accordance with the lifetime of the process cartridge S will be described as Modification 9. Hereinafter, parts (configurations, effects, and the like) similar to those in Example 1 will be denoted by the same reference signs, and description will be omitted.

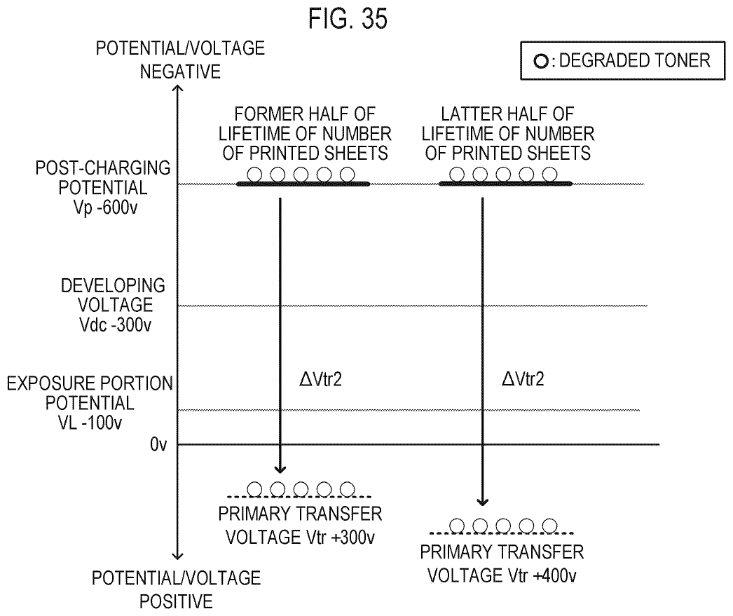

FIG. 35 is an explanatory diagram of a relationship between the lifetime of the process cartridge S (cartridge lifetime) and the primary transfer voltage Vtr according to Modification 9. As illustrated in FIG. 35, the setting of the primary transfer voltage Vtr is changed in accordance with the lifetime of the process cartridge S in Modification 9. In this example, the lifetime of the process cartridge S is determined by the number of printed sheets.

In Modification 9, the primary transfer voltage Vtr is set to satisfy Vtr=+300 V in the former half of the lifetime of the number of printed sheets, and the primary transfer voltage Vtr is set to satisfy Vtr=+400 V in the latter half of the lifetime of the number of printed sheets in the toner ejection control. Since the post-charging potential Vp is −600 V and does not change, the transfer contrast ΔVtr2 in the former half of the lifetime of the number of printed sheets is 900 V, and the transfer contrast ΔVtr2 in the latter half of the lifetime of the number of printed sheets is 1000 V.

In this manner, the absolute value of the transfer contrast ΔVtr2 is increased in the latter half of the lifetime of the process cartridge S, that is, with a progress of the degree of toner degradation in this modification. The proportion at which even the toner with an advanced degree of degradation can be ejected to the intermediate transfer belt 10 with an electrostatic force increases by performing such control. Consequently, it is possible to maintain satisfactory ejection control throughout the lifetime of the process cartridge S.

Note that the configurations of the above-described examples and modifications can be arbitrarily combined.

### Example 15

Hereinafter, an image forming apparatus according to Example 15 to which the present invention can be applied will be described. In the following description, a case where the present invention is applied to an image forming apparatus of an electrophotographic image formation scheme of forming an image on a recording medium using an electrophotographic image formation process will be described. Examples of the image forming apparatus of the electrophotographic image formation scheme include an electrophotographic copy machine, an electrophotographic printer (such as an LED printer and a laser beam printer), and an electrophotographic facsimile apparatus.

### Image Forming Apparatus

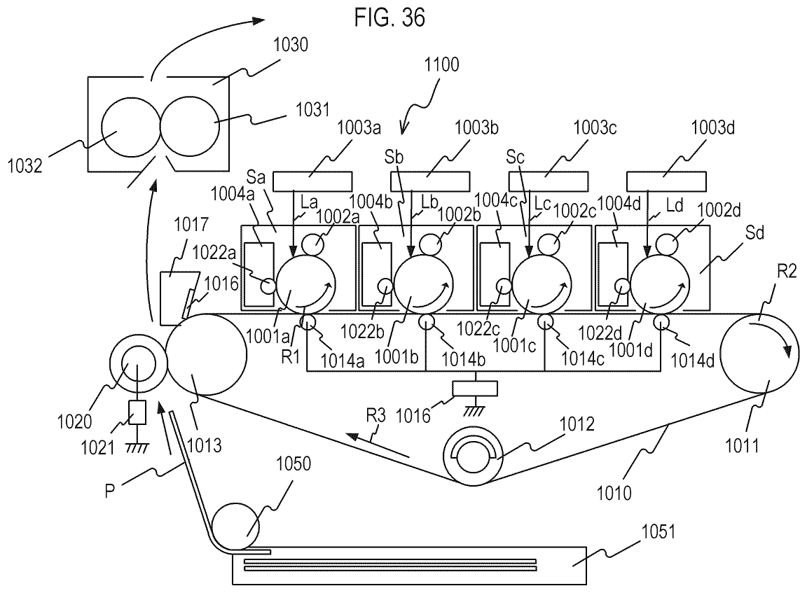

First, an overview of an entire configuration of a laser printer engine as the image forming apparatus according to Example 15 will be described using FIG. 36. FIG. 36 is a schematic sectional view illustrating an overview configuration of a printer engine 1100 of this example. A configuration, operations, and control of the printer engine 1100 of this example will be described using FIG. 36.

The printer engine 1100 of this example is a full-color laser printer employing an inline system or an intermediate transfer system.

The printer engine 1100 can form a full-color image on a recording material P (for example, recording paper or a plastic sheet) in accordance with image information. The image information is input to the printer engine 1100 from an image reading device or a host computer 1000 such as a personal computer communicably connected to the printer engine 1100.

The printer engine 1100 includes, as a plurality of image forming portions, first, second, third, and fourth process cartridges Sa, Sb, Sc, and Sd for forming images of yellow (Y), magenta (M), cyan (C), and black (K) colors, respectively. In this example, the first to fourth process cartridges Sa, Sb, Sc, and Sd are disposed in one line in a direction intersecting the vertical direction. Note that in this example, the configurations and operations of the first to fourth process cartridges Sa, Sb, Sc, and Sd are substantially the same other than that colors of the images to be formed are different. Therefore, in a case where no special distinction is needed, the indexes a, b, c, and d attached to the reference signs to represent that the elements are provided for some of the colors will be omitted, and comprehensive description will be given below.

In this example, the printer engine 1100 includes, as a plurality of image bearing members, four drum-type electrophotographic photoreceptors, that is, four photosensitive drums 1001 (1001a, 1001b, 1001c, and 1001d) aligned in a direction intersecting the vertical direction. The photosensitive drums 1001 are image bearing members that are rotationally driven by a photosensitive drum drive source 1085, which is a drive mechanism. In the periphery of the photosensitive drums 1001, charging rollers 1002 (1002a, 1002b, 1002c, and 1002d), scanner units (exposure devices) 1003 (1003a, 1003b, 1003c, and 1003d), and developing units (developing devices) 1004 (1004a, 1004b, 1004c, and 1004d) are disposed.

The charging rollers 1002 are rotatable charging mechanisms (charging members) that uniformly charge the surfaces of the photosensitive drums 1001. The scanner units 1003 are exposure devices (exposure mechanisms) that form electrostatic images (electrostatic latent images) on the photosensitive drums 1001 through irradiation with laser beams on the basis of an output calculated by a CPU 1207 from the image information input from a host computer 1000 such as a personal computer. When electrostatic latent images corresponding to image signals are formed by the exposure mechanisms, non-image regions on the surfaces of the photosensitive drums 1001 are uniformly and weakly exposed, thereby stabilizing the surface potentials of the photosensitive drums 1001. Hereinafter, formation of electrostatic images by exposure mechanisms will be distinguished as exposure and uniform exposure of the non-image regions will be distinguished as weak exposure. The developing units 1004 are developing mechanisms for developing the electrostatic images as developer (hereinafter referred to as toner) images.

The photosensitive drums 1001, the charging rollers 1002 as the process mechanisms acting on the photosensitive drums 1001, and the developing units 1004 are integrated to thereby form the process cartridges S. The process cartridges S are cartridges that can be attached to and detached from the printer engine 1100 via mounting mechanisms such as mounting guides and positioning members provided in the printer engine 1100.

An intermediate transfer belt 1010 as an intermediate transfer member for transferring the toner images on the photosensitive drums 1001 to the recording material P is disposed to face the four photosensitive drums 1001. The intermediate transfer belt 1010 formed of an endless belt abuts on all the photosensitive drums 1001 and circulates (rotates) in the direction of arrow R3 (clockwise direction) in FIG. 36. The intermediate transfer belt 1010 is stretched over, as a plurality of support members, a drive roller 1011, a tension roller 1012, and a secondary transfer counter roller 1013. The drive roller 1011 as a drive member is a rotation drive member that rotationally drives the intermediate transfer belt 1010 in the direction of the arrow R3 by rotating in the direction of the arrow R2 (clockwise direction) in FIG. 36.

On the side of the inner peripheral surface of the intermediate transfer belt 1010, four primary transfer rollers 1014 (1014a, 1014b, 1014c, and 1014d) as primary transfer mechanisms are aligned to face the photosensitive drums 1001, respectively. The primary transfer rollers 1014 are (primary) transfer members that come into contact with the intermediate transfer belt 1010 and presses the intermediate transfer belt 1010 toward the photosensitive drums 1001 to form a primary transfer portion (primary transfer nip) where the intermediate transfer belt 1010 and the photosensitive drums 1001 abut on each other. A voltage having a polarity opposite to the normal charge polarity of the toner is applied to the primary transfer roller 1014 from a primary transfer high-voltage power source circuit 1015 as a primary transfer voltage applying mechanism. In this manner, the toner images on the photosensitive drums 1001 are primarily transferred to the intermediate transfer belt 1010. When a full-color image is formed, the aforementioned processes are sequentially performed in the first to fourth process cartridges Sa, Sb, Sc, and Sd, the toner images of the colors are primarily transferred to the intermediate transfer belt 1010 with the toner images of the respective colors overlapping with each other.

A secondary transfer roller 1020 as a secondary transfer mechanism is disposed at a position facing the secondary transfer counter roller 1013 on the side of the outer peripheral surface of the intermediate transfer belt 1010. The secondary transfer roller 1020 is a (secondary) transfer member that comes into pressure contact with the secondary transfer counter roller 1013 via the intermediate transfer belt 1010 to form a secondary transfer portion (secondary transfer nip) where the intermediate transfer belt 1010 and the secondary transfer roller 1020 abut on each other.

A voltage having a polarity opposite to the normal charge polarity of the toner is applied to the secondary transfer roller 1020 from a secondary transfer high-voltage power source circuit 1021 as a secondary transfer voltage applying mechanism. In this manner, the toner images of the four colors on the intermediate transfer belt 1010 are collectively and secondarily transferred to the recording material P by an action of the secondary transfer roller 1020 abutting on the intermediate transfer belt 1010 via the recording material P. The recording material P accommodated in a cassette 1051 is conveyed to the secondary transfer portion by a feeding mechanism 1050 in synchronization with the movement of the intermediate transfer belt 1010.

On the secondary transfer counter roller 1013, an intermediate transfer belt cleaning device 1016 cleans up and removes a secondary transfer residual toner remaining on the intermediate transfer belt 1010 via the intermediate transfer belt 1010 and accommodates the secondary transfer residual toner in a waste toner accommodating container 1017.

The recording material P bearing the toner images of the four colors after the secondary transfer ends is conveyed to a fixing device 1030, that is, a fixation nipping portion formed by a fixing roller 1031 and a pressurizing roller 1032. The recording material P is heated and pressurized such that the toners of the four colors are melt, mixed, and fixed on the recording material P, and is then discharged from the printer engine 1100. An environment sensor 1070 capable of detecting the temperature and the humidity of an apparatus installation environment is included in the device of the printer engine 1100.

Note that the printer engine 1100 is also configured to be able to form a single-color or multi-color image using only one desired image forming portion or only some (not all) of the image forming portions.

### Process Cartridge

Next, an overall configuration of each process cartridge S attached to the printer engine 1100 of this example will be described.

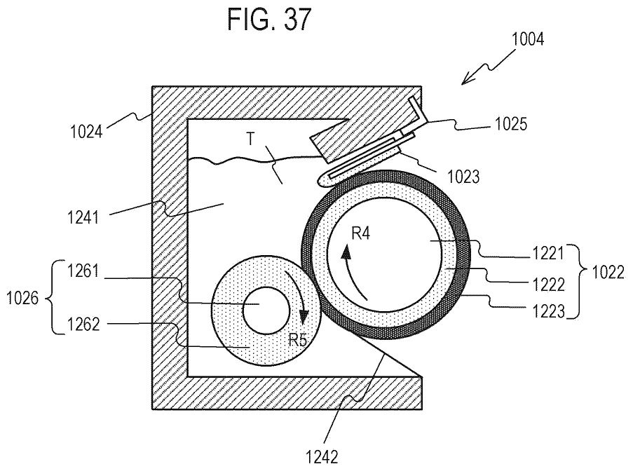

The process cartridge S is configured by integrating a photoreceptor unit that includes the photosensitive drum 1001 and the charging roller 1002 and a developing unit (developing device) 4 that includes the developing roller 1022 and the like. A device configuration of the developing unit 1004 will be described using FIG. 37. FIG. 37 is a schematic sectional view illustrating an overview configuration of each developing unit 1004.

The photosensitive drum 1001 is rotatably supported by an apparatus main body of the printer engine 1100 via a bearing, which is not illustrated. The photosensitive drum 1001 is configured to be rotationally driven in the direction of the arrow R1 (counter clockwise direction) in FIG. 36 in accordance with an image forming operation by a drive force of a driving mechanism (drive source), which is not illustrated, being transmitted to the photoreceptor unit. The charging roller 1002 is configured such that a roller portion of a conductive rubber comes into pressure contact with the photosensitive drum 1001 and performs driven-rotation. Although the charging roller 1002 that comes into pressure contact with the photosensitive drum 1001 is used as a charging member that charges the photosensitive drum 1001 in this example, the present disclosure is not limited thereto, and a non-contact charging scheme such as a corona charger may be adopted.

As illustrated in FIG. 37, the developing unit 1004 includes a developing roller 1022 (developer bearing member) that bears the toner T, a developing blade 1023 (regulating member), and a developing frame body 1024 that fixes these. The developing frame body 1024 includes a developing chamber 1241 where the developing roller 1022 is disposed and a blowing-out prevention sheet 1242 that seals a developing opening (opening portion) that is connected from the developing chamber 1241 to outside. The developing chamber 1241 is a toner accommodating portion that accommodates the toner therein.

One end portion of the developing blade 1023 is fixed to a fixing member 1025. The developing blade 1023 and the developing frame body 1024 are integrated by the fixing member 1025 being fixed to the developing frame body 1024. The other end portion of the developing blade 1023 on the side opposite to the one end portion is caused to abut on the developing roller 1022 and is configured to be able to regulate the amount of coating of the developing roller 1022 with the toner T and imparting of a charge. The developing roller 1022 is disposed in the developing opening portion and is disposed to be able to abut on the photosensitive drum 1001.

As illustrated in FIG. 37, the developing roller 1022 is a roller having an outer diameter of φ10 mm and having a configuration in which a metal core 1221, a base layer 1222, and a surface layer 1223 are sequentially stacked. The metal core 1221 has a size of φ6.0 mm. The base layer 1222 has a thickness of 2.0 mm and is made of conductive silicone rubber. The surface layer 1223 is made of urethane. The developing roller 1022 is disposed to be rotationally driven in the direction of the arrow R4 (clockwise direction) in FIG. 37. The developing roller 1022 rotates with a speed difference with respect to the photosensitive drum 1001 in order to control the amount of development of the toner T on the photosensitive drum 1001.

As illustrated in FIG. 37, the developing blade 1023 abuts such that the developing blade 1023 faces the counter direction with respect to the rotation direction of the developing roller 1022, and regulates the amount of coating of the toner T and imparts a charge through triboelectric charging. In other words, the direction from the end portion of the developing blade 1023 on the side of the fixing member 1025 toward the end portion on the side of portion abutting on the developing roller 1022 is a direction opposite to the rotation direction of the developing roller 1022 at the abutting portion between the developing blade 1023 and the developing roller 1022. Furthermore, the amount of coating of the toner T and the amount of charging of the toner are controlled by applying a predetermined DC voltage to the developing blade 1023 and controlling a potential difference from the voltage to be applied to the developing roller 1022.

The supply roller 1026 is configured by providing a urethane foam layer 1262 around a core electrode 1261 which is a conductive support and has an outer diameter of φ5.5 mm. The outer diameter of the entire supply roller 1026 including the urethane foam layer 1262 is φ11 mm. The supply roller 1026 rotates in the direction of the arrow R5 (clockwise direction) in FIG. 37 in a direction such that the supply roller 1026 and the developing roller 1022 have speeds in opposite directions at the abutting portion therebetween. A powder pressure of the toner T that is present around the urethane foam layer 1262 acts on the urethane foam layer 1262, and the toner T is taken into the urethane foam layer 1262 by the supply roller 1026 further rotating.

The supply roller 1026 containing the toner T supplies the toner T to the developing roller 1022 at the portion abutting on the developing roller 1022 and imparts a preliminary triboelectric charging charge to the toner T through further rubbing. On the other hand, the supply roller 1026 that supplies the toner T to the developing roller 1022 also serves to peel off the toner T remaining on the developing roller 1022 without being developed at the developing portion.

A predetermined DC voltage is applied to the supply roller 1026. The amount of supplied toner and the amount of preliminary triboelectric charging are controlled by controlling the potential difference between the voltage to be applied to the supply roller 1026 and the voltage to be applied to the developing roller 1022.

The toner T according to Example 15 is a non-magnetic toner manufactured by suspension polymerization and having a negative normal charge polarity, and is charged to a negative polarity when the developing roller 1022 bears the toner T.

The toner shape itself of the toner T may be deformed, or an external additive on the surface of the toner surface may peel off or may be embedded, due to rubbing against the developing blade 1023 for a long period of time. The deformation of the shape of the toner leads to an increase in contact area between the toner T and the photosensitive drum 1001. Furthermore, the resin component of the toner comes into contact with the photosensitive drum 1001 by the external additive on the surface of the toner peeling off, and the contact area between the toner and the photosensitive drum 1001 increases by the eternal additive being embedded in the toner. As a result, a non-electrostatic adhesion force to the photosensitive drum 1001 becomes higher than that in a state of a new product. Such a phenomenon will be referred to as degradation of the toner T in the following description.

A cartridge nonvolatile memory 1027 as a cartridge information storage portion that stores specific information of the cartridge of each color is mounted in the process cartridge S. The printer engine 1100 determines the amount of toner consumption at the time of image formation and the amount of remaining toner in the process cartridge S using the cartridge information stored in the cartridge nonvolatile memories 1027 (1027a, 1027b, 1027c, and 1027d).

### Hardware Configuration

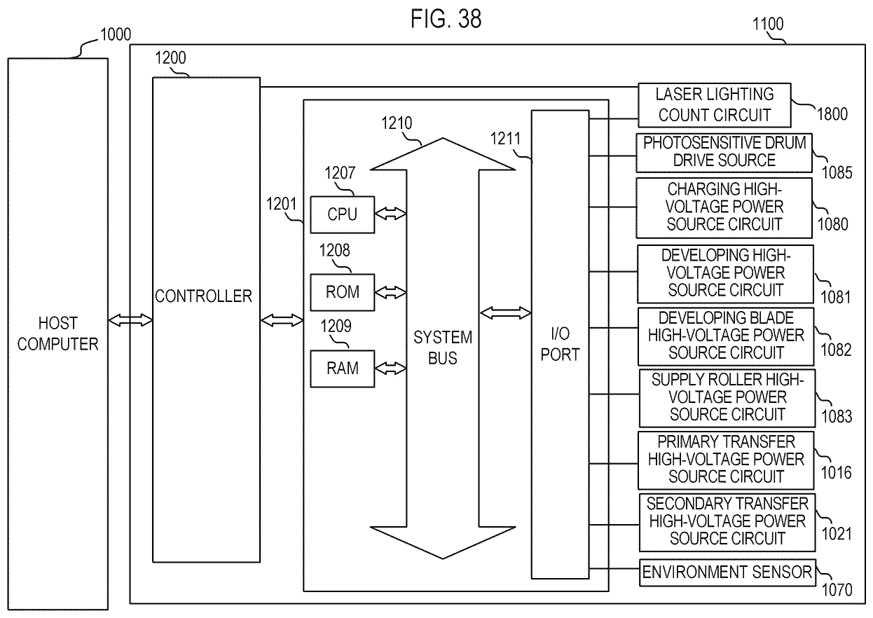

Next, a hardware configuration of this example will be described using FIG. 38. FIG. 38 is an explanatory diagram of the hardware configuration according to this example.

The printer engine 1100 is configured of a controller 1200 and an engine control portion 1201. The controller 1200 receives image information and a print command from the host computer 1000, which is an external device. The controller 1200 analyzes the received image information, converts it into bit data, and sends a print booking command, a print start command, and a video signal for each page to the engine control portion 1201 via a video interface portion 1330.

The engine control portion 1201 is a control integrated circuit (IC) configured of a CPU 1207, a ROM 1208, a RAM 1209, and I/O ports 1211. The CPU 1207 loads a program and various kinds of data to the ROM 1208 and executes the program by using the RAM 1209 as a work area. The aforementioned components can access the I/O ports 1211 via a system bus 1210 that is accessible in both directions.

A laser lighting count circuit 1800, a photosensitive drum drive source 1085, a charging high-voltage power source circuit 1080, a developing high-voltage power source circuit 1081, a developing blade high-voltage power source circuit 1082, a supply roller high-voltage power source circuit 1083, a primary transfer high-voltage power source circuit 1015, a secondary transfer high-voltage power source circuit 1021, and a laser driver 1062 of the scanner unit 1003 are connected to the I/O ports 1211. The engine control portion 1201 is a control portion that controls each actuator that realizes the image forming operation and the ejecting operation via these I/O ports 1211. Also, the environment sensor 1070 is connected to the I/O ports 1211 to detect an installation environment temperature and an installation environment humidity of the printer engine 1100.

### Functional Blocks

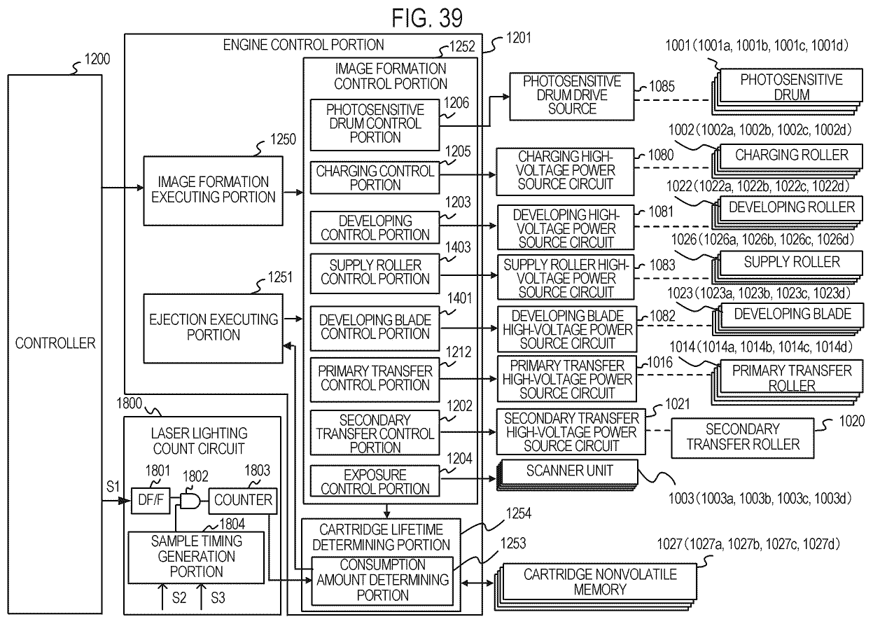

A configuration of the engine control portion 1201 that controls the entire printer engine will be described using FIG. 39. FIG. 39 is an explanatory diagram of a configuration of the engine control portion 1201 according to the Example 15.

The engine control portion 1201 collectively controls an image formation executing portion 1250, an ejection executing portion 1251, an image formation control portion 1252, and a cartridge lifetime determination portion 1254 as illustrated in FIG. 39. Also, the image formation control portion 1252 collectively controls a photosensitive drum control portion 1206, a primary transfer control portion 1212, a secondary transfer control portion 1202, a developing control portion 1203, an exposure control portion 1204, a charging control portion 1205, a developing blade control portion 1401, and a supply roller control portion 1403. The cartridge lifetime determination portion 1254 collectively controls a consumption amount determination portion 1253 that determines (acquires) the amount of toner consumption by various operations.

The photosensitive drum control portion 1206 controls the photosensitive drum drive source 1085 to control operations of the photosensitive drum 1001 such as a rotation speed. The charging control portion 1205 controls the charging high-voltage power source circuit 1080 to control the charging voltage to be applied to the charging roller 1002. The developing control portion 1203 controls the developing high-voltage power source circuit 1081 to control the developing voltage to be applied to the developing roller 1022. The supply roller control portion 1403 controls the supply roller high-voltage power source circuit 1083 to control the voltage to be applied to the supply roller 1026. The developing blade control portion 1401 controls the developing blade high-voltage power source circuit 1082 to control the voltage to be applied to the developing blade 1023. The primary transfer control portion 1212 controls the primary transfer high-voltage power source circuit 1015 to control the transfer voltage (primary transfer voltage) to be applied to the primary transfer roller 1014. The secondary transfer control portion 1202 controls the secondary transfer high-voltage power source circuit 1021 to control the transfer voltage (secondary transfer voltage) to be transferred to the secondary transfer roller 1020. The exposure control portion 1204 controls the amount of exposure of the scanner unit 1003. As described above, the engine control portion 1201 (image formation control portion 1252) is configured to be able to control voltages to be applied to the various members such as a charging voltage, a developing voltage, and a transfer voltage, the amount of exposure, and the like.

Once the controller 1200 receives print information and a print command from the host computer 1000, the controller 1200 provides an instruction to start printing to the engine control portion 1201. Once the image formation executing portion 1250 receives the instruction to start printing from the controller 1200, the image formation executing portion 1250 provides an instruction for a print operation (image forming operation) to the image formation control portion 1252. The image formation control portion 1252 executes an image forming operation necessary for the print operation once the instruction for the print operation is received. The ejection executing portion 1251 provides an instruction for an ejecting operation to the image formation control portion 1252 when ejection executing conditions are satisfied. The image formation control portion 1252 executes an image forming operation necessary for the ejecting operation when the instruction for the ejecting operation is received. The ejection executing portion 1251 carries out counting-up and clearing of a page counter used for the ejection execution conditions.

The consumption amount determination portion 1253 (consumption amount acquisition unit) determines (acquires) the amount of consumption of the toner on the basis of a laser lighting count value obtained from the laser lighting count circuit 1800 and the cartridge information stored in the cartridge nonvolatile memory 1027. The consumption amount determination portion 1253 changes a method of calculating the amount of toner consumption in response to an operation instruction from the image formation control portion 1252. The cartridge lifetime determination portion 1254 determines the amount of remaining toner on the basis of cumulative values of the amount of toner consumption determined by the consumption amount determination portion 1253 and the amount of toner consumption stored in the cartridge nonvolatile memory 1027. Furthermore, the cartridge lifetime determination portion 1254 notifies the ejection executing portion 1251 of the amount of remaining toner to use is for the ejection execution conditions.

As the amount of toner consumption in this example, an image dot type detection method for measuring the number of image dots formed on the surface of the photosensitive drum 1001 as a photoreceptor is adopted. As illustrated in the block diagram in FIG. 39, the controller 1200 receives an image signal S1 in response to an instruction from the host computer 1000 and converts the image signal S1 into a control signal for the amount of laser lighting and the lighting timing. The controller 1200 transmits the image signal S1 to the laser lighting count circuit 1800. The laser lighting count circuit 1800 detects the amount of laser lighting in the image signal S1 of a corresponding page transmitted from the controller 1200 and acquires and stores pixels to which the toner is to be caused to adhere.

The laser lighting count circuit 1800 is configured of a synchronous digital circuit. However, illustration of a system block is omitted in FIG. 39. As illustrated in FIG. 39, the laser lighting count circuit 1800 is configured to include at least a flip-flop (hereinafter, a DF/F) 1801, a gate 1802, a counter 1803, and a sample timing generation portion 1804.

The image signal S1 input from the controller 1200 is received by the flip-flop (DF/F) 1801 and is changed into a synchronous signal.

A horizontal enable signal S2 indicating an image region in the scanning direction of the laser and a vertical enable signal S3 indicating an image printing region in the direction perpendicular to the scanning direction of the laser are input to the sample timing generation portion 1804. The horizontal enable signal S2 can be generated by a control logic circuit (not illustrated) inside the printer engine on the basis of a horizontal synchronous signal, which is not illustrated. Also, the vertical enable signal S3 can be generated by a control logic circuit (not illustrated) inside the printer engine 1100 in accordance with a timing of image formation.

The gate 1802 becomes high (HIGH) in a case where the signal obtained by synchronizing the image signal S1 is ON at a timing determined by the sample timing generation portion 1804. The counter 1803 counts the number of times the gate 1802 becomes high (HIGH) in a predetermined image region, that is, the number of times the image signal S1 turns on. The number of times the image signal S1 is turned on that is counted by the counter 1803 will be referred to as a count value Tcnt.

The count value Tcnt is sent to the consumption amount determination portion 1253 of the CPU 1207 at the timing when all image signals S1 corresponding to the page have been received from the controller 1200. The consumption amount determination portion 1253 determines the amount of toner consumption on the basis of the count value Tcnt. The amount of remaining toner in this example is determined from a ratio between an integrated value obtained by the cartridge lifetime determination portion 1254 multiplying the amount of toner consumption determined by the consumption amount determination portion 1253 and a toner lifetime reaching determination threshold value.

Note that although the aforementioned example has been described on the assumption that the various kinds of processing is performed on the basis of the processing of the CPU 1207, it is a matter of course that an ASIC which is an integrated circuit may be caused to perform a part or entirety of the processing performed by the CPU 1207.

### Weak Exposure of Non-image Region

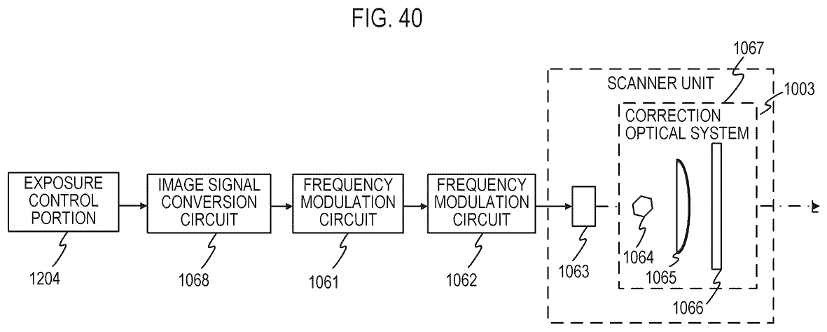

Control of weak exposure of a non-image region performed in this example will be described using FIG. 40. FIG. 40 is an explanatory diagram of weak exposure control of a non-image region in an image forming process. In FIG. 40, an image signal sent from the controller 1200 is a multi-value signal (0 to 255) having a depth direction of 8 bits=256 gradations, a laser beam is turned off when the signal is zero, the laser beam is completely turned on when the signal is 255, and the laser beam has a value gradually changing between on and off when the signal is between 1 to 254.

A non-image portion exposure level can be arbitrarily set by the level of the aforementioned multi-value signal. In the following description, it is assumed that non-image portion exposure is performed using 32 as the level of the multi-value signal. The non-image portion where the image signal sent from the controller 1200 to the exposure control portion 1204 is zero is converted to 32 by the image signal conversion circuit 1068, and the non-image portions when the image signals are values of 1 to 255 are compression-converted to 33 to 255. Thereafter, the signals are converted into signals in a serial time axis direction by a frequency modulation circuit 1061 and are used for pulse width modulation of each dot pulse with a resolution of 600 dots/inch in this example.

With this signal, the laser driver 1062 is driven, the laser diode 1063 emits light, and the laser beam L is emitted. The laser beam L passes through a correction optical system 1067 including a polygon mirror 1064, a lens 1065, and a returning mirror 1066, and is used to irradiate the photosensitive drums 1001 as scanning light. Note that the frequency modulation circuit 1061 may be spaced apart from the laser driver 1062 and may be provided on the side of the controller.

### Development of Toner and Collection of Transfer Residual Toner

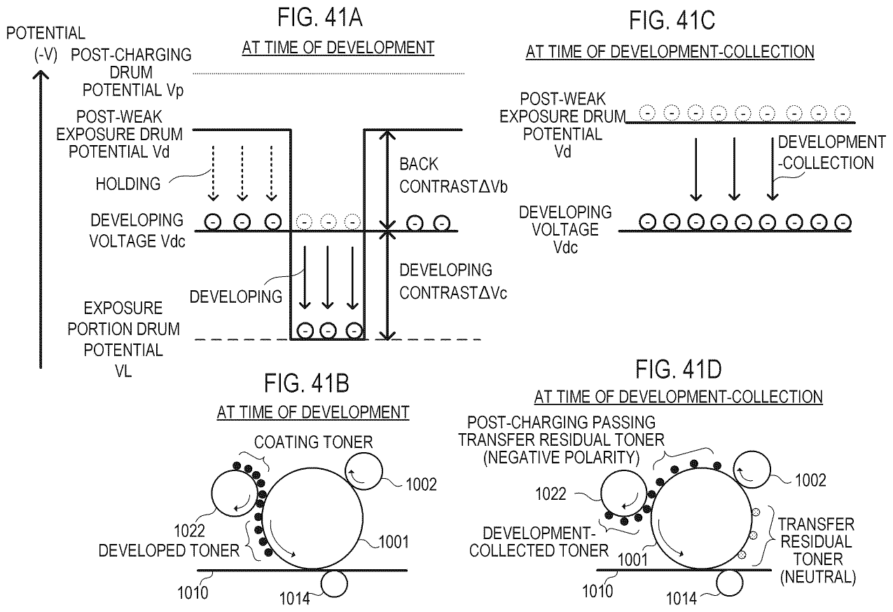

The development of the toner and the collection of the transfer residual toner at the developing portion will be described using FIGS. 41A to 41D. FIGS. 41A to 41D are explanatory diagrams of a method of collecting the transfer residual toner. Note that the circle of the solid line in FIGS. 41A and 41C indicates the toner after movement, and the circle of the dashed line indicates the toner before movement.

First, the development of the toner will be described using FIGS. 41A and 41B. FIG. 41A is a schematic diagram of a potential relationship when the toner is developed. FIG. 41B is a schematic diagram in the vicinity of the developing portion when the toner is developed.

The charging voltage Vpri applied to the charging roller 1002 during image formation of this example is −1200 V, and the surface potential (post-charging potential Vp; post-charging drum potential) of the photosensitive drum 1001 after charging is approximately −700 V. The post-weak exposure potential Vd (post-weak exposure drum potential) formed in the non-image region on the photosensitive drum 1001 by weak exposure is approximately −480 V. The developing voltage Vdc applied to the developing roller 1022 is −300 V, and the post-exposure potential VL (post-exposure drum potential) of the photosensitive drum 1001, the charge of which has been attenuated by the exposure, is approximately −150 V.

The primary transfer is performed with a transfer contrast ΔVtr7 which is a potential difference between the post-exposure potential VL and the primary transfer voltage Vtr. As illustrated in FIGS. 41A and 41B, an electrostatic latent image is visualized at the developing portion where the toner charged to a negative polarity comes into contact with the photosensitive drum 1001 with the potential difference (hereinafter, referred to as a developing contrast ΔVc) between the developing voltage Vdc and the post-exposure potential VL, to thereby form a toner image. Also, the toner on the developing roller 1022 is electrically held so as not to be transferred to the non-image region with the potential difference (hereinafter, referred to as a back contrast ΔVb) between the developing voltage Vdc and the post-weak exposure potential Vd formed by the weak exposure.

Next, a method of processing the toner (hereinafter, referred to as a transfer residual toner) remaining on the surface of the photosensitive drum 1001 without being transferred to the intermediate transfer belt 1010 in the primary transfer process will be described.

In this example, the transfer residual toner is collected by the developing roller 1022 and is then recycled. A method of collecting (hereinafter, referred to as development collection) the transfer residual toner by the developing roller 1022 will be described using FIGS. 41C and 41D. FIG. 41C is a schematic diagram of a potential relationship at the time of the development collection. FIG. 41D is a schematic diagram in the vicinity of the developing portion at the time of the development collection.

The toner having a substantially neutral polarity with a small amount of charging in the toner developed on the photosensitive drum 1001 cannot be transferred to the intermediate transfer belt 1010 in the primary transfer process and remains on the surface of the photosensitive drum 1001 as a transfer residual toner. As illustrated in FIGS. 41C and 41D, the transfer residual toner is charged to the normal charge polarity by the charging voltage Vpri when the transfer residual toner passes through the portion abutting on the charging roller 1002. At this time, the post-charging potential Vp is formed on the surface of the photosensitive drum 1001 with the charging voltage Vpri at the same time, and the post-weak exposure potential Vd is then formed through weak exposure.

A potential difference (back contrast ΔVb) occurs between the potential (developing voltage Vdc) of the developing roller 1022 formed by applying a DC voltage to the developing roller 1022 and the post-weak exposure potential Vd. The transfer residual toner on the drum surface where the post-weak exposure potential Vd is formed is collected to the developing roller 1022 by the electric field due to the potential difference (back contrast ΔVb). The toner collected by the developing roller 1022 is then recycled. At this time, the transfer residual toner on the drum surface where the post-weak exposure potential Vd is formed is charged to the normal charge polarity.

### Degraded Toner Ejection

The printer engine 1100 according to Example 15 is configured to efficiently eject and process the degraded toner generated in association with utilization of the process cartridge S from the developing container without ejecting a large amount of non-degraded toner. In the following description, the toner that has not yet been degraded will be referred to as a fresh toner, and the degraded toner generated in association with utilization of the process cartridge S will be referred to as a degraded toner.

In this example, the toner in the developing container (including both the degraded toner and the fresh toner) is ejected onto the photosensitive drum 1001. Thereafter, the fresh toner is selectively collected by the developing unit, and the degraded toner is collected into the waste toner accommodating container 1017 by the intermediate transfer belt cleaning device 1016. Hereinafter, such operation control of the toner ejecting operation (toner supplying operation) will be referred to as degraded toner ejection control.

The printer engine 1100 according to Example 15 can selectively eject the degraded toner from the inside of the developing container while collecting a part of the fresh toner into the developing container by the degraded toner ejection control. It is thus possible to realize efficient ejection and to curb unnecessary toner consumption.

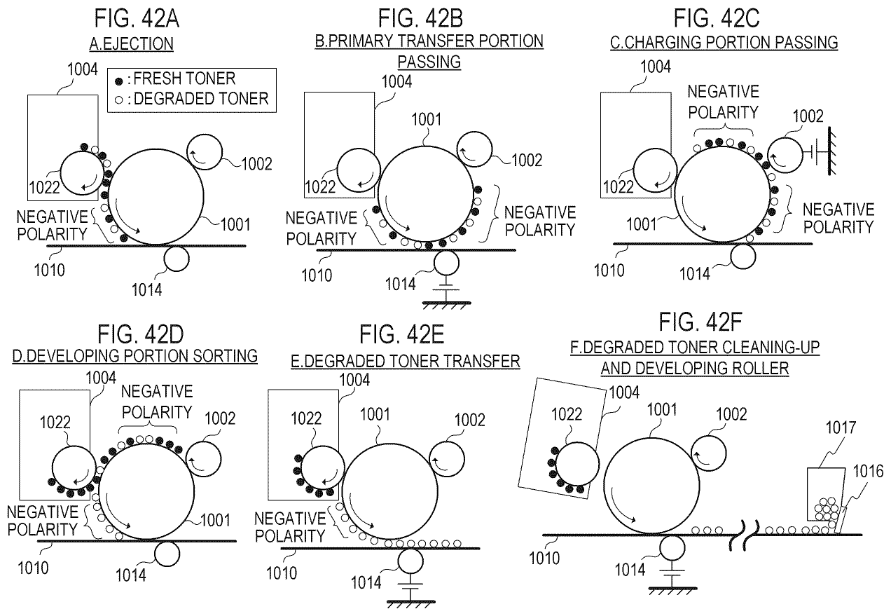

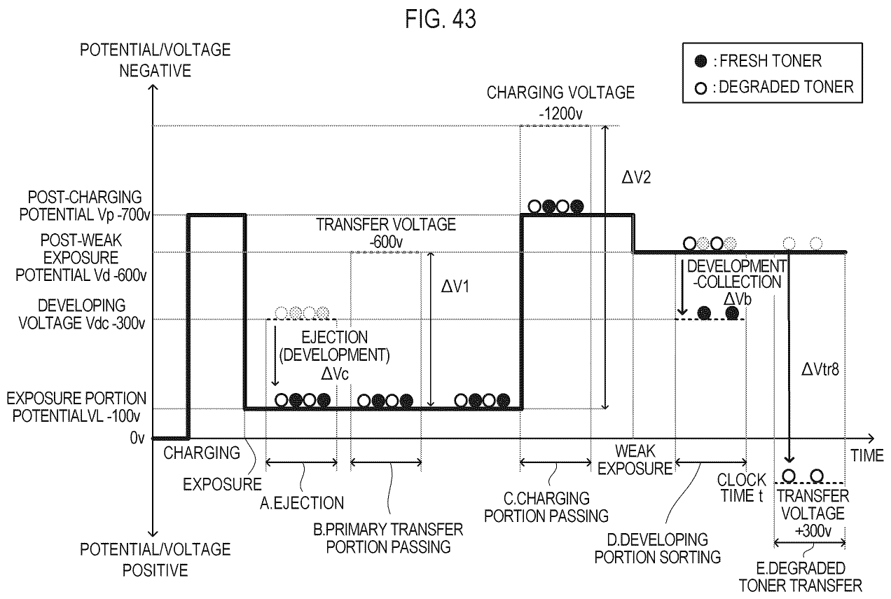

Hereinafter, the degraded toner ejection control (toner ejecting operation) will be described in more detail using FIGS. 42A to 42F and FIG. 43. Hereinafter, the toner ejected from the developing container will be referred to as an ejected toner. FIGS. 42A to 42F are explanatory diagrams of the degraded toner ejecting operation, and are schematic diagrams illustrating movement of the ejected toner when the degraded toner ejection control is executed. FIG. 43 is an explanatory diagram of voltage and potential control in the degraded toner ejection control, and is a diagram schematically illustrating a potential of the photosensitive drum 1001, a developing voltage, a primary transfer voltage, and movement of the toner in the degraded toner ejection control along a time axis. FIG. 43 shows a graph in which the vertical axis represents potential/voltage and the horizontal axis represents the time, a surface potential at a predetermined location moving with rotation of the photosensitive drum 1001 is illustrated by the thick line, and the toner adhering to the part is also illustrated together. In FIGS. 42A to 42F and FIG. 43, the fresh toner is illustrated by the black circle, and the degraded toner is illustrated by the white circle. The circle of the solid line in FIG. 43 represents the toner after movement, and the circle of the dashed line represents the toner before movement.

This control is roughly categorized into processes: A. ejection of the toner inside the developing device; B. primary transfer portion passing of the ejected toner; C. charging portion passing of the ejected toner; D. toner sorting at the developing portion; E. degraded toner transfer; and F. degraded toner processing. Each process will be described below. Note that the processes A to E correspond to FIGS. 42A to 42E, respectively, and the ranges corresponding to the processes are also illustrated in FIG. 43 as well.

A. Ejection of Toner inside Developing Unit 1004

FIG. 42A is a diagram illustrating a state of the ejection process of the toner inside the developing unit 1004. The ejection process of the toner is a process in which the toner is supplied from the developing roller 1022 to the photosensitive drum 1001. Once the operation of the degraded toner ejection control is started, the photosensitive drum 1001 is uniformly charged to a predetermined potential with a negative polarity by the charging roller 1002 in the process of rotation and is then exposed by the scanner unit 1003. In this manner, a latent image potential of the post-exposure potential VL is formed on the photosensitive drum 1001. In this example, it is assumed that the post-charging potential Vp=−700 V and the post-exposure potential VL=−100 V.

Thereafter, as illustrated in FIG. 42A, the toner that the developing roller 1022 bears is ejected to the photosensitive drum 1001 by the potential difference (developing contrast ΔVc) between the developing voltage Vdc and the post-exposure potential VL at the position where the developing roller 1022 and the photosensitive drum 1001 abut on each other. At this time, the ejected toner contains both a degraded toner and a fresh toner. In this example, the developing voltage Vdc=−300 V. In other words, an absolute value of developing contrast ΔVc is 200 V. In this example, the developing control portion 1203 illustrated in FIG. 38 can change the rotation speed of the developing roller 1022 with respect to the rotation speed of the photosensitive drum 1001. In the ejection control of this example, the developing roller 1022 rotates at a speed of 140% (1.4 times) relative to the photosensitive drum 1001.

Note that in this ejection control, the amount of exposure by the scanner unit 1003 is made different from that in the image forming operation, the post-exposure potential VL is set to be greater (from −150 V to −100 V) (caused to approach a positive value) and the absolute value of the developing contrast ΔVc is set to be greater (from 150 V to 200 V) as compared with those in the image forming operation. The post-exposure potential VL is used to firmly develop the toner on the developing roller 1022 onto the photosensitive drum 1001.

In the rotation direction of the photosensitive drum 1001, the length of the ejected toner ejected at a time is preferably equal to or greater than the length of one turn of the developing roller 1022, and is preferably within the length of one turn of the photosensitive drum 1001. Since it is assumed that the toner in the vicinity of the developing roller 1022 is consumed, it is preferable that the length of the ejected toner be equal to or greater than the length of one turn of the developing roller 1022 in order to eject all the toners with which the developing roller 1022 is coated immediately before the ejection control. On the other hand, there is a concern that collection efficiency may be lowered if the ejection of the toner inside the developing device and the collection of the fresh toner in the developing portion, which will be described later, are performed at the same time due to a relationship of the photosensitive drum potential. Accordingly, it is preferable that the length of the ejected toner in the rotation direction of the photosensitive drum 1001 be within one turn of the photosensitive drum 1001.

In this example, the toner corresponding to a length of 44.8 mm (=10 mm×3.14÷1.4×2) of two turns of the developing roller 1022 is ejected in the ejection control. The length of one turn of the photosensitive drum 1001 is 62.8 mm (=20 mm×3.14), and the length, by which the toner is ejected, in the rotation direction of the photosensitive drum 1001 is less than the length of one turn of the photosensitive drum 1001. Note that although there is a limitation on the length of the toner to be ejected at a time in the rotation direction of the photosensitive drum 1001, the total amount of toner to be ejected may be adjusted by repeating this ejection control.

### B. Passing of Ejected Toner Through Primary Transfer Portion

FIG. 42B is a diagram illustrating the primary transfer portion passing process of the ejected toner. The primary transfer portion passing process is a process in which the toner supply portion of the photosensitive drum 1001 supplied with the toner from the developing roller 1022 passes through the primary transfer portion which is an abutting portion between the photosensitive drum 1001 and the intermediate transfer belt 1010 for the first time. When the ejected toner passes through the primary transfer portion, a voltage of −600 V is applied to the primary transfer roller 1014 from the primary transfer high-voltage power source circuit 1015. As illustrated in FIG. 42B, a potential difference ΔV1 is formed between the post-exposure potential VL and the potential formed between the photosensitive drum 1001 and the intermediate transfer belt 1010 at the primary transfer portion such that the ejected toner (normal charge polarity) remains on the photosensitive drum 1001. As a result, the toner ejected onto the toner supply portion passes through the primary transfer portion while the photosensitive drum 1001 bears the toner as illustrated in FIG. 42B.

If the potential formed on the intermediate transfer belt 1010 is a negative potential and has an absolute value greater than the absolute value of the post-exposure potential VL of the photosensitive drum 1001, it is possible to cause the ejected toner to remain on the photosensitive drum 1001. This is because the ejected toner is charged with a normal charge polarity (negative polarity) by rubbing against the developing blade 1023. In other words, the toner is electrostatically attracted to the photosensitive drum 1001 by the intermediate transfer belt 1010 where the negative potential with an absolute value greater than the absolute value of the potential (post-exposure potential VL) of the photosensitive drum 1001 is formed. If the potential difference is approximately equal to or greater than the primary transfer contrast ΔVtr7 at the time of image formation, it is possible to cause the ejected toner to remain on the photosensitive drum 1001. Note that if the potential difference ΔV1 is excessively large, there is a concern that abnormal discharge may occur at the primary transfer portion, the ejected toner polarity may be inverted, and the potential difference ΔV1 is preferably less than 1500 V in the configuration of this example. In this example, a potential of −600 V is formed on the intermediate transfer belt 1010 by the primary transfer high-voltage power source circuit 1015 such that the absolute value of the potential difference ΔV1 becomes 500 V.

C. Passing of Ejected Toner through Charging Portion

FIG. 42 C is a diagram illustrating the charging portion passing process of the ejected toner. The charging portion passing process is a process in which the toner supply portion of the photosensitive drum 1001 supplied with the toner from the developing roller 1022 passes through the charging portion which is an abutting portion between the photosensitive drum 1001 and the charging roller 1002. The ejected toner that has passed through the primary transfer portion passes through the position (charging portion) where the charging roller 1002 and the photosensitive drum 1001 come into contact with each other. As illustrated in FIG. 43, a voltage with a negative polarity of −1200 V is applied to the charging roller 1002 when the ejected toner passes through the charging portion. As a result, the ejected toner passes without adhering to the charging roller 1002 by the potential difference (hereinafter, referred to as a charging contrast ΔV2 between the potential of the photosensitive drum 1001 and the potential of the charging roller 1002. At this timing, formation of the post-charging potential Vp and imparting of a charge to the ejected toner are performed at the same time.

Note that the charging contrast ΔV2 is preferably large to some extent from any of the above viewpoints and it is sufficient for the charging contrast ΔV2 to be equal to or greater than the charging contrast in the image forming operation. On the other hand, if the charging contrast ΔV2 is excessively large, there is a concern that abnormal discharge may occur at the charging portion, and the toner polarity may be inverted, which may lead to adhesion to the charging roller 1002. For this reason, the charging contrast ΔV2 is set to 1100 V in this example.

### D. Toner Sorting at Developing Portion

FIG. 42D is a diagram illustrating the toner sorting process at the developing portion. The toner sorting process is a process in which a part of the toner on the surface of the photosensitive drum 1001 supplied from the developing roller 1022, that is, a part of the toner of the toner supply portion is collected by the developing roller 1022. After the ejected toner passes through the charging portion, the degraded toner and the fresh toner at the position (hereinafter, referred to as a developing portion) where the developing roller 1022 and the photosensitive drum 1001 come into contact with each other are sorted. The ejected toner that has passed through the charging portion then passes through the developing portion with the rotation of the photosensitive drum 1001. At this time, a developing voltage Vdc=−300 V is applied to the developing roller 1022, and Vd=−600 V is formed on the surface of the photosensitive drum by weak exposure, as illustrated in FIG. 43. The ejected toner is collected by the back contrast ΔVb which is the potential difference between the post-weak exposure potential Vd and the developing voltage Vdc.

The ejected toner contains both the fresh toner and the degraded toner. The degraded toner is a toner with the shape itself deformed, or with the external additive on the surface thereof having peeled off or having been embedded, due to rubbing against the developing blade 1023 for a long period of time. The deformation of the shape of the toner increases the contact area between the toner and the photosensitive drum 1001. For example, the contact area between the toner and the photosensitive drum 1001 may increase by the resin component in the toner and the photosensitive drum 1001 coming into contact with each other and the exterior additive being embedded in the toner due to peeling off of the external additive from the toner surface. As a result, the degraded toner has a higher non-electrostatic adhesion force to the photosensitive drum 1001 as compared with the fresh toner. On the other hand, since the fresh toner has been less degraded, the non-electrostatic adhesion force to the photosensitive drum 1001 is low contrary to the degraded toner.

As described above, since there is a difference in non-electrostatic adhesion forces between the degraded toner and the fresh toner, the fresh toner is more likely to be collected while the degraded toner is less likely to be collected when the ejected toner is collected in the developing unit. In Example 15, such a difference in the non-electrostatic adhesion forces between the degraded toner and the fresh toner is used to selectively collect the fresh toner in the developing unit (not to selectively collect the degraded toner) as illustrated in FIG. 42D. With such a configuration, since a large amount of fresh toner with less degradation in the ejected toner can be collected, the lifetime of the developing unit 1004 can be prolonged without unnecessarily consuming the toner. Note that according to the toner sorting process, it is possible to sort the toner from the initial utilization state (a state close to a new product) of the process cartridge S. On the other hand, as the service time of the process cartridge S increases and the lifetime of the process cartridge S becomes closer to its end, the proportion of the degraded toner increases. Accordingly, it is more effective to perform the toner sorting in the latter half of the lifetime of the process cartridge S in which the proportion of the degraded toner is high.

Ejected toner collection efficiency when the ejected toner is collected at the developing roller 1022 can be controlled by the back contrast ΔVb. First, as an absolute value of the back contrast ΔVb increases within a range below a discharge threshold value, an electric field for moving the ejected toner toward the side of the developing roller 1022 becomes stronger, and the collection efficiency is thus improved. Note that in a case where the back contrast ΔVb is greater than the discharge threshold value between the developing roller 1022 and the photosensitive drum 1001, the polarity of the ejected toner is inverted through the discharge, resulting in a decrease in collection efficiency.

On the other hand, in a case where the absolute value of the back contrast ΔVb is small, not only collection efficiency is reduced, but also the toner with which the developing roller 1022 is coated cannot be held on the developing roller 1022, and the toner is developed onto the photosensitive drum 1001. Such unintended development is referred to as fogging. Accordingly, it is necessary to set the back contrast ΔVb to be less than the discharge threshold value, within a range in which no fogging occurs, and to allow the developing roller 1022 to selectively collect the fresh toner. Specifically, it is only necessary for the back contrast ΔVb to be 100 V or more and less than 500 V, and to appropriately adjust the back contrast ΔVb in accordance with characteristics (an adhesion force, the amount of charging, the shape, a degree of degradation) of the used toner.

In this example, the voltage (developing voltage Vdc) applied to the developing roller 1022 is set to −300 V such that the absolute value of the back contrast ΔVb becomes 300 V. Note that although the back contrast ΔVb is formed by weak exposure in this example, the present disclosure is not limited to such a configuration. For example, in a case of an image forming apparatus that does not have weak exposure (cannot be performed), it is only necessary to secure appropriate charging contrast ΔV2 and back contrast ΔVb by adjusting the charging voltage.

Most of the fresh toner can be collected at the developing roller 1022, and most of the degraded toner can be caused to remain on the photosensitive drum 1001, by controlling various voltages and the amount of exposure as described above.

### E. Degraded Toner Transfer

FIG. 42E is a diagram illustrating the degraded toner transfer process. The degraded toner transfer process is a process in which the toner supply portion of the photosensitive drum 1001 supplied with the toner from the developing roller 1022 passes through the transfer portion again, and the toner moves from the photosensitive drum 1001 to the intermediate transfer belt 1010. In other words, after the sorting process at the developing portion ends, the degraded toner remaining on the photosensitive drum 1001 is transferred to the intermediate transfer belt 1010. The degraded toner that has passed through the developing portion is charged to a negative polarity (normal charge polarity). Accordingly, the degraded toner is transferred to the intermediate transfer belt 1010 by applying the positive primary transfer voltage to the primary transfer roller 1014 as illustrated in FIG. 42E. At this time, the potential on the surface of the photosensitive drum 1001 where the degraded toner remains is the post-weak exposure potential Vd as illustrated in FIG. 43. Then, the degraded toner is transferred to the intermediate transfer belt 1010 by a potential difference ΔVtr8 between the post-weak exposure potential Vd and the primary transfer voltage Vtr.

As described above, the degraded toner has a higher adhesion force to the photosensitive drum 1001 than the fresh toner. Accordingly, the degraded toner is unlikely to be transferred to the intermediate transfer belt 1010 with the same potential difference similar to that during ordinary image formation in the transfer of the degraded toner to the intermediate transfer belt 1010. Therefore, it is necessary to set the potential difference ΔVtr8 such that the degraded toner can be transferred to the intermediate transfer belt 1010.

The degraded toner remaining on the photosensitive drum 1001 is a toner that has not been collected by the developing roller 1022 with the back contrast ΔVb at the time of the right previous collection at the developing roller 1022. Accordingly, it is preferable that the potential difference ΔVtr8 be set to be equal to or greater than the back contrast ΔVb at the time of the development collection of the fresh toner. As described above, the degraded toner is a toner that has a high adhesion force to the photosensitive drum 1001 and is difficult to transfer. Therefore, the potential difference ΔVtr8 is preferably greater than the transfer contrast ΔVtr7 at the time of the ordinary image forming operation. In other words, the potential difference ΔVtr8 is preferably greater than a larger one out of the back contrast ΔVb at the time of the development collection of the fresh toner and the transfer contrast ΔVtr7 at the time of the ordinary image forming operation. However, if the potential difference ΔVtr8 is excessively large, there is a concern that abnormal discharge may occur at the primary transfer portion, and the potential difference ΔVtr8 is thus preferably less than about 2000 V.

In this example, the potential difference ΔVtr8 between the post-weak exposure potential Vd=−600 V and the primary transfer voltage Vtr=+300 V is set to satisfy ΔVtr8=900 V in the transfer of the degraded toner to the intermediate transfer belt 1010.

### F. Cleaning of Degraded Toner

FIG. 42F is a diagram illustrating a degraded toner cleaning-up process. The degraded toner transferred to the intermediate transfer belt 1010 is sent to the intermediate transfer belt cleaning device 1016 by the rotation of the intermediate transfer belt 1010, and is collected and processed in the waste toner accommodating container 1017.

In this example, once the ejected toner finishes passing through the developing portion (between FIG. 42E and FIG. 42F), the developing roller 1022 is immediately separated from the photosensitive drum 1001, and the rotation of the developing roller 1022 is stopped. This is for the purpose of avoiding unnecessary rubbing by immediately performing disengagement at a timing at which it becomes unnecessary for the developing roller 1022 to be in contact with the photosensitive drum 1001 because the toner on the developing roller 1022 rubs against the developing blade 1023 with rotation of the developing roller 1022.

In this example, when the degraded toner charged to a negative polarity on the intermediate transfer belt 1010 is sent to the intermediate transfer belt cleaning device 1016, a voltage with a negative polarity is applied to the secondary transfer roller 1020. In this manner, the degraded toner on the intermediate transfer belt 1010 passes without adhering to the secondary transfer roller 1020.

If the absolute value of the voltage applied to the secondary transfer roller 1020 when the degraded toner on the intermediate transfer belt 1010 passes through the portion abutting on the secondary transfer roller 1020 is excessively small, the degraded toner will adhere to the secondary transfer roller 1020. Even if the absolute value of the applied voltage is excessively high, the polarity of the toner is inverted due to abnormal discharge, and the degraded toner will adhere to the secondary transfer roller 1020. Therefore, the voltage applied to the secondary transfer roller 1020 is preferably about −300 to −1000 V. In this example, a voltage of −500 V is applied to the secondary transfer roller 1020. Note that although the secondary transfer roller 1020 is in contact with the intermediate transfer belt 1010 in this example, the secondary transfer roller 1020 may be separated from the intermediate transfer belt 1010 to prevent the degraded toner from adhering to the secondary transfer roller 1020 in a case where the disengagement/engagement mechanism of the secondary transfer roller 1020 is included.

It should be noted that it is not always necessary to send the degraded toner transferred onto the intermediate transfer belt 1010 to the intermediate transfer belt cleaning device 1016 during the ejection control. For example, the ejection control may be terminated at the timing right after the degraded toner is transferred to the intermediate transfer belt 1010. At this time, the degraded toner remaining on the intermediate transfer belt 1010 may be sent to the intermediate transfer belt cleaning device 1016 by the rotating operation of the intermediate transfer belt 1010 in the next ordinary image forming operation and may be collected and processed. It is thus possible to execute the ejection control without generating an unnecessary down time.

Note that the ejection mode is made to operate with the developing voltage Vdc of −300 V, which is the same as that in the image forming operation, with different charging voltage, amount of exposure, and the like from those in the image forming operation in this example, the present disclosure is not limited to such a configuration. For example, the developing voltage Vdc may be changed to change the back contrast ΔVb and the developing contrast ΔVc.

### Description of Methods of Determining Amount of Toner Consumption and Amount of Remaining Toner

Next, methods of determining the amount of toner consumption and the amount of remaining toner in this example will be described. First, a method of determining the amount of toner consumption in this example will be described. In the degraded toner ejection control in this example, a part of the fresh toner in the ejected toner is development-collected. Therefore, it is necessary to consider the amount of development-collected toner with respect to the amount of ejected toner as the amount of toner consumption at the time of the degraded toner ejection. Hereinafter, the amount of toner to be consumed in the degraded toner ejection control will be referred to as the amount Tcon of toner consumption. The amount Tcon of toner consumption in this example can be calculated by (Equation 1) below.

Tcon=(1−K)×Tcnt (Equation 1)

In (Equation 1), Tcnt is the count value by the counter 1803 as described above, and is the count value based on which the image signal is turned on by the amount of ejected toner. In other words, the count value Tcnt is the same as the amount of toner supplied from the developing unit 1004 to the surface of the photosensitive drum 1001. Also, K in (Equation 1) is a correction coefficient representing the estimated amount of toner to be development-collected. Specifically, the correction coefficient Kk is a proportion of the amount of toner to be collected in the developing roller 1022 with respect to the amount of toner to be supplied from the developing roller 1022 to the photosensitive drum 1001 in the degraded toner ejecting operation. The amount Tcon of toner consumption when the toner ejecting operation is performed is smaller than the count value Tcnt because the amount of toner to be collected by the developing unit 1004 is taken into consideration.

Note that although the count value Tcnt corresponding to the amount of toner to be supplied from the developing unit 1004 is multiplied by the correction coefficient Kk corresponding to the toner collection proportion to acquire the amount Tcon of toner consumption in the toner ejecting operation in Example 15, the present disclosure is not limited to such a configuration. For example, another value related to the amount of toner may be used instead of the count value Tcnt, or another correction coefficient related to the amount of collected toner and the collection proportion may be used instead of the correction coefficient Kk. Here, the value related to the amount of toner includes the amount of toner itself, a value corresponding to the amount of toner, a value in a proportional relationship with the amount of toner, and the like. In other words, the count value Tcnt and the correction coefficient Kk are just examples, and it is only necessary to acquire the amount Tcon of toner consumption on the basis of the value related to the amount of toner supplied from the developing roller 1022 to the photosensitive drum 1001 and the correction coefficient related to the amount of toner to be collected by the developing roller 1022 in the toner ejecting operation.

Next, a method of determining the amount Trem of remaining toner, which is the amount of toner remaining inside the process cartridge S in this example will be described. The amount Trem of remaining toner in this example is determined from a cumulative value of the amount Tcon of toner consumption and the toner remaining amount reaching count threshold value. In this example, the amount Trem of remaining toner is calculated using a current cumulative value of the amount Tcon of toner consumption. Specifically, the amount Trem of remaining toner is calculated such that the amount Trem of remaining toner when the cumulative value of the amount Tcon of toner consumption reaches the toner remaining amount reaching count threshold value is 0% and the amount Trem of remaining toner when the cumulative value of the amount Tcon of toner consumption is zero is 100%. Since the cumulative value of the amount Tcon of toner consumption in this example is stored in the cartridge nonvolatile memory 1027, it is possible to take over the amount Trem of remaining toner even if the process cartridge S is replaced.

### Control Flow in Example 15

Next, a method of determining the amount Tcon of toner consumption in Example 15 will be described. In Example 15, the correction coefficient Kk representing the estimated value of the amount of collected toner (collection proportion) in the degraded toner ejecting operation is a fixed value determined in advance. The correction coefficient Kk in Example 15 is set to 0.7, and it is estimated that 70% of the ejected toner is development-collected. Furthermore, the correction coefficient Kk in Example 15 is the value stored in the cartridge nonvolatile memory 1027, and a value corresponding to properties of the toner may be stored in the cartridge nonvolatile memory 1027 at the time of manufacturing of the cartridge.

Next, an execution frequency of the degraded toner ejection control in Example 15 will be described. The purpose of the degraded toner ejection control is to selectively eject most of the degraded toner from the inside of the developing device. For this reason, it is preferable to execute the ejection control in the latter half of the lifetime of the process cartridge S in which the proportion of the degraded toner increases. The correction coefficient Kk in Example 15 is a value determined as a result of intensive studies by the inventors of the present invention, and is a parameter determined on the assumption that the degraded toner ejection control is performed for every 100 sheets. Therefore, the degraded toner ejection control is performed for every 100 sheets starting at the time when the amount of remaining toner becomes less than 50% in the latter half of the lifetime of the process cartridge S in Example 15. Note that although the latter half of the lifetime of the process cartridge S is determined on the basis of the amount of remaining toner in the execution determination of the degraded toner ejection control in this example, the present disclosure is not limited to such a configuration. For example, the start timing of the degraded toner ejection control may be determined on the basis of the rotation distance of the photosensitive drum 1001, the amount of wear of the surface of the photosensitive drum 1001, or the like.

The degraded toner ejection control is preferably executed at the time of rotation following the image forming operation, after the image forming operation ends, or between recording materials P when images are continuously formed on the plurality of recording materials P to prevent the start of the image forming operation from being delayed.

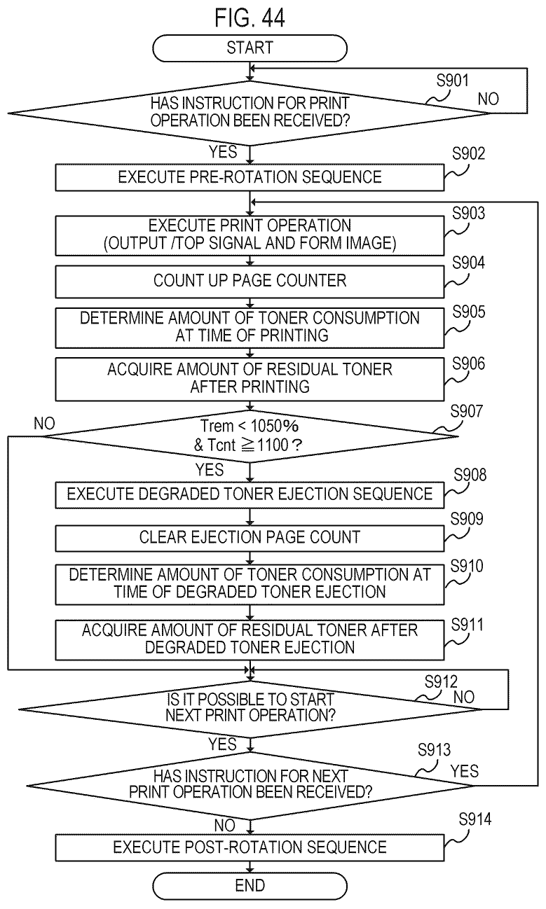

Next, the control flow of the print operation and the degraded toner ejecting operation in Example 15 will be described using the flowchart illustrated in FIG. 44. FIG. 44 is a flowchart illustrating the control flow of the print operation (image forming operation) and the degraded toner ejecting operation according to Example 15. In Example 15, the engine control portion 1201 of the printer engine 1100 is configured to be able to execute the print operation and the degraded toner ejecting operation by controlling operations of each portions.

First, in Step (hereinafter, S) 901, the image formation executing portion 1250 determines whether or not an instruction for a print operation has been received. Specifically, in a case where a print booking command and a print start command have not been received, the image formation executing portion 1250 determines that the instruction for a print operation has not been received and waits for receiving the print booking command and the print start command. On the other hand, when the image formation executing portion 1250 has received the print booking command and the print start command, and conditions are satisfied, the image formation executing portion 1250 provides an instruction to start the image forming operation for the print operation to the image formation control portion 1252.

Once the image forming operation is started, the image formation control portion 1252 executes pre-processing (hereinafter, referred to as a “pre-rotation sequence) to perform the print operation in S902. After the pre-rotation sequence ends, the image formation control portion 1252 outputs a/TOP signal in S903 and starts the print operation in accordance with the print booking command for the first page.

In S904, the ejection executing portion 1251 counts up a page counter (count value Tcnt). Then, the consumption amount determination portion 1253 determines the amount of toner consumption per page at the time of the printing in S905. Furthermore, in S906, the cartridge lifetime determination portion 1254 acquires (determines) the latest amount Trem of remaining toner after the printing on the basis of the amount of toner consumption determined in S905. Note that although the determination of the amount of toner consumption in S905 and the determination of the amount Trem of remaining toner in S906 are performed for each print page in this example, the present disclosure is not limited to such a configuration. For example, a configuration in which the amount of toner consumption and the amount Trem of remaining toner corresponding a plurality of printed page are collectively determined after printing of the plurality of pages is completed may be adopted.

Next, in S907, the ejection executing portion 1251 determines whether or not to execute the degraded toner ejection sequence (operation). The ejection executing portion 1251 determines to execute the degraded toner ejection sequence in a case where the amount Trem of remaining toner is less than 50% (Trem<50%) and the page counter is equal to or greater than 100 pages (Tcnt≥100). On the other hand, the ejection executing portion 1251 determines not to execute the degraded toner ejection sequence in a case where the amount Trem of remaining toner is equal to or greater than 50% (Trem≥50%) and the page counter is less than 100 pages (Tcnt<100).

In a case where determination of YES (to execute the degraded toner ejection sequence) is made in S907, the processing proceeds to S908, and the degraded toner ejection sequence is executed. On the other hand, in a case where determination of NO (not to execute the degraded toner ejection sequence) is made in S907, the processing proceeds to S912 without executing the degraded toner ejection sequence.

After the degraded toner ejection sequence is executed in S908, the ejection executing portion 1251 clears the page counter (sets the value of the count value Tcnt to zero) in S909. Next, the consumption amount determination portion 1253 determines the amount Tcon of toner consumption at the time of the degraded toner ejection in S910. Then, in S911, the cartridge lifetime determination portion 1254 acquires (determines) the latest amount Trem of remaining toner after the degraded toner ejection on the basis of the amount of toner consumption determined in S910. After the acquisition of the amount Trem of remaining toner, the processing proceeds to S912.

In S912, the image formation executing portion 1250 determines whether or not it is possible to start the print operation for the next page. In a case where it is determined that the print operation for the next page cannot be started yet, the image formation executing portion 1250 waits for the timing at which it becomes possible to start the print operation. On the other hand, in a case where it is determined that the print operation for the next page can be started, the processing proceeds to S913.

In S913, the image formation executing portion 1250 determines whether or not an instruction for the next print operation (a print booking command and a print start command) has been received. In a case where the instruction for the next print operation has been received, the processing returns to Step S903, and the print operation for the next page is started. On the other hand, in a case where the instruction for the next print operation has not been received, the processing proceeds to S914. Then, the image formation control portion 1252 executes post-processing (hereinafter, referred to as a “post-rotations sequence”) of the print operation and ends the print operation in S914.

As described above, according to the configuration in Example 15, it is possible to realize efficient ejection by selectively ejecting the degraded toner from the inside of the developing container while collecting a part of the fresh toner in the developing container by executing the degraded toner ejection control. Furthermore, it is possible to acquire the amount of remaining toner in consideration of the toner to be collected in the toner ejecting operation. Accordingly, it is possible to provide an image forming apparatus that suppresses unnecessary toner consumption and also suppresses deviation of the amount of remaining toner by the development collection.

### Example 16

Next, Example 16 according to the present invention will be described. Example 16 differs from Example 15 in a method of determining the correction coefficient Kk. Hereinafter, only different points in the configuration in Example 16 from the configuration in Example 15 will be described. Configurations in Example 16 similar to the configurations in Example 15 will be denoted by the same reference signs, and description will be omitted.

In Example 15, the method of suppressing unnecessary toner consumption and suppressing deviation of the amount of remaining toner by the development collection by executing the degraded toner ejection control using the correction coefficient Kk, which is a predetermined fixed value, has been described. In Example 16, a method of further suppressing the deviation of the amount of remaining toner by development collection by executing degraded toner ejection control using a correction coefficient Kk suitable for the installation environment of the printer and utilization conditions of the printer by a user will be described.

### Functional Blocks

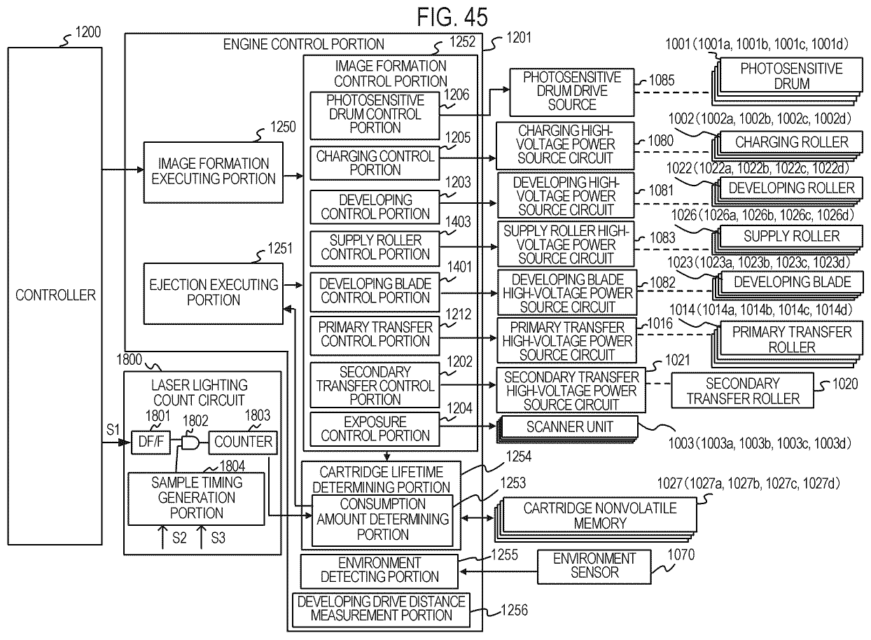

A configuration of an engine control portion 1201 in Example 16 will be described using FIG. 45. FIG. 45 is an explanatory diagram of a configuration of the engine control portion 1201 according to Example 16.

The engine control portion 1201 collectively controls an environment detection portion 1255 and a development drive distance measurement portion 1256 in addition to an image formation control portion 1252 and a cartridge lifetime determination portion 1254. The environment detection portion 1255 obtains temperature information on the installation environment from an environment sensor 1070 and notifies a consumption amount determination portion 1253 of the temperature information. The development drive distance measurement portion 1256 measures the rotation distance of a developing roller 1022 and notifies the consumption amount determination portion 1253 of the rotation distance. The development drive distance measurement portion 1256 measures a drive time of a motor, which is not illustrated, for rotationally driving the developing roller 1022.

Further, the consumption amount determination portion 1253 according to Example 16 determines the amount of toner consumption on the basis of the laser lighting count value obtained from the laser lighting count circuit 1800 and information regarding a degree of toner degradation. The information regarding a degree of toner degradation in the consumption amount determination portion 1253 is, for example, temperature information and developing rotation distance information.

Description of Control Flow in Example 16 Next, a method of determining the amount of toner consumption in Example 16 will be described. The correction coefficient Kk representing the estimated amount of toner to be development-collected in Example 16 is determined on the basis of the information regarding the degree of toner degradation. Specifically, the correction coefficient Kk is calculated by (Equation 2) below.

$$Kk = Ek \times Dk \qquad ( Equation 2 )$$

In (Equation 2), Ek is a correction coefficient based on the temperature information, and Dk is a correction coefficient based on a developing rotation distance (development traveling distance). As indicated by (Equation 2), the correction coefficient Kk is determined on the basis of the correction coefficient Ek based on the temperature information and the correction coefficient Dk based on the developing rotational distance in Example 16. The correction coefficient Ek based on the temperature information is a value obtained by linear complementation based on the values shown in Table 7 (correction coefficient Ek based on temperature (environmental) information) below.

TABLE 7

| | Temperature information | | |
|---|---|---|---|
| | 10° C. | 23° C. | 32° C. |
| Correction coefficient Ek | 0.56 | 0.70 | 0.77 |
| based on temperature information | | | |

The toner is more likely to be degraded in a low-temperature environment and less likely to be degraded in a high-temperature environment. Accordingly, the correction coefficient Ek in the environment information is set to be higher as the temperature of the environment where the printer engine 1100 is placed is higher in Example 16. Specifically, the correction coefficient Ek is set to 0.56 when the environment temperature is 10° C., 0.7 when the environment temperature is 23° C., and 0.77 when the environment temperature is 32° C. in Example 16.

The temperature information is fixed to an upper limit (32° C. in this example) in a case where the temperature information at the time of calculating the correction coefficient Kk is greater than the upper limit, and the correction coefficient Kk is fixed to the lower limit (10° C. in this example) in a case where the temperature information is smaller than the lower limit. The values shown in Table 7 in Example 16 are values determined in evaluation tests and studies of past achievements made in advance and stored in the cartridge nonvolatile memory 1027. The values for determining the correction coefficient Ek are not limited to the above-described values, and values in accordance with the toner properties and the like may be stored in the cartridge nonvolatile memory 1027 at the time of manufacturing of the cartridge.

The correction coefficient Dk based on the developing rotation distance, which is the rotation distance of the developing roller 1022, is a value obtained by linear complementation based on the values shown in Table 8 (correction coefficient Dk by the developing rotational distance) below.

TABLE 8

| | Developing rotation distance | |
|---|---|---|
| | 420000 mm | 210000 mm |
| | (corresponding to | (corresponding to |
| | feeding of 100 | feeding of 100 |
| | sheets of A3 paper) | sheets of A4 paper) |
| Correction coefficient Dk | 0.8 | 1.0 |
| based on developing | | |
| rotation distance | | |

The toner is more likely to be degraded when the time of rubbing against the developing blade 1023 is longer, and is less likely to be degraded as the rubbing time is shorter. Accordingly, Example 16 is configured such that the correction coefficient Dk based on the developing rotation distance becomes shorter as the rubbing time between the developing blade 1023 and the toner increases. Specifically, the correction coefficient Dk is set to 0.8 when the developing rotation distance is 420,000 mm, and 1.0 when the developing rotational distance is 210,000 mm in Example 16. Note that the developing rotation distance of 420,000 mm is a distance corresponding to 100 sheets of A3 paper, and the developing rotational distance of 210,000 mm is a distance corresponding to 100 sheets of A4 paper.

The developing rotation distance is fixed to the upper limit (420,000 mm in this example) in a case where the developing rotation distance when the correction coefficient Kk is calculated is greater than the upper limit, and is fixed to the lower limit (210,000 mm in this example) in a case where the developing rotation distance is smaller than the lower limit. The values shown in Table 8 in Example 16 are values determined in evaluation tests and studies of past achievements made in advance and stored in the cartridge nonvolatile memory 1027. The values for determining the correction coefficient Dk are not limited to the above-described values, and values in accordance with properties and the like of the toner may be stored in the cartridge nonvolatile memory 1027 at the time of manufacturing of the cartridge.

Although the case where the developing rotation distance and temperature information are used when the correction coefficient Kk representing the estimated amount of toner to be development-collected has been described in Example 16, the determination of the correction coefficient Kk is not limited to such a configuration. For example, the correction coefficient Kk may be determined on the basis of only either the developing rotation distance or the temperature information. Furthermore, the correction coefficient Kk may be determined on the basis of specific information of the process cartridge S other than the developing rotation distance, or may be determined on the basis of information regarding a degree of toner degradation other than the developing rotation distance and the temperature information. Alternatively, other parameters such as the amount of saturated water vapor determined by temperature information and humidity information or an average printing rate information at the time of print operation from which the utilization condition of the degraded toner can be estimated may be used.

As described above, it is possible to provide an image forming apparatus capable of further suppressing deviation of the amount of remaining toner by the development collection by executing the degraded toner ejection control using the correction coefficient Kk suitable for the installation environment of the printer and the utilization conditions of the printer.

Note that the processing described as being performed by one device in each of the above examples may be executed in a distributed manner by a plurality of devices in applications of the present invention. Alternatively, the processing described as being performed by different devices may be performed by one device. For example, the control of the image formation control portion 1252 and the control of the cartridge lifetime determination portion 1254 may be performed by different control portions.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-157547, filed on Sep. 11, 2024, and Japanese Patent Application No. 2024-157475, filed on Sep. 11, 2024, which are hereby incorporated by reference herein in their entirety.

What is claimed is:

1. An image forming apparatus comprising:
a rotatable photosensitive drum;
a charging member that charges a surface of the photosensitive drum;
a developing member that comes into contact with the photosensitive drum to form a developing portion and supplies, by the developing portion, a toner charged with a normal polarity to the surface of the photosensitive drum charged by the charging member;
a developing voltage application portion that applies a developing voltage to the developing member;
an intermediate transfer member that comes into contact with the photosensitive drum to form a transfer portion, the toner supplied to the surface of the photosensitive drum being transferred to the intermediate transfer member by the transfer portion;
a transfer voltage application portion that applies a transfer voltage to the intermediate transfer member; and
a control portion that performs control to be able to execute i) an image forming operation of forming an image on a recording material and ii) a toner supplying operation of supplying the toner from the developing member to the surface of the photosensitive drum, the toner supplying operation being an operation different from the image forming operation,
wherein in the toner supplying operation, a region on the photosensitive drum to which the toner is supplied from the developing member is defined as a first region,
wherein the control portion performs control to execute, by the photosensitive drum being rotated in the toner supplying operation,
i) a first process in which the first region forms the transfer portion in a state where the transfer voltage is applied such that a first potential difference is formed between the intermediate transfer member and the photosensitive drum, the first potential difference is a potential difference in a direction in which an electrostatic force in a direction from the intermediate transfer member to the photosensitive drum acts on the toner charged with the normal polarity at the transfer portion,
ii) a second process in which the first region forms the developing portion in a state where the developing voltage is applied such that a second potential difference is formed between the photosensitive drum and the developing member, after the first process, the second potential difference is a potential difference in a direction in which an electrostatic force in a direction from the photosensitive drum to the developing member acts on the toner charged with the normal polarity at the developing portion, and
iii) a third process in which the first region forms the transfer portion in a state where the transfer voltage is applied such that a third potential difference is formed between the photosensitive drum and the intermediate transfer member, after the second process, the third potential difference is a potential difference in a direction in which an electrostatic force in a direction from the photosensitive drum to the intermediate transfer member acts on the toner charged with the normal polarity at the transfer portion,
wherein in the image forming operation, a potential difference in a direction in which an electrostatic force in a direction from the photosensitive drum to the developing member acts on the toner charged with the normal polarity at the developing portion, which is a potential difference formed between the photosensitive drum and the developing member, is defined as a fourth potential difference, and
wherein the control portion performs control such that an absolute value of the second potential difference is greater than an absolute value of the fourth potential difference.

2. The image forming apparatus according to claim 1,
wherein in the image forming operation, a potential difference in a direction in which an electrostatic force in a direction from the photosensitive drum to the intermediate transfer member acts on the toner charged with the normal polarity at the transfer portion, which is a potential difference formed between the photosensitive drum and the intermediate transfer member, is defined as a fifth potential difference, and
wherein the control portion performs control such that an absolute value of the third potential difference is greater than an absolute value of the fifth potential difference.

3. The image forming apparatus according to claim 1,
wherein the control portion
performs control such that when the first region on the photosensitive drum passes through the transfer portion for a first time in the first process, a value of the transfer voltage is negative and an absolute value of the transfer voltage is greater than an absolute value of a post-exposure potential, which is a surface potential of the photosensitive drum exposed by an exposure device, and
performs control such that when the toner remaining on the surface of the photosensitive drum passes through the transfer portion again in the third process, the value of the transfer voltage is positive.

4. The image forming apparatus according to claim 1,
wherein the control portion exposes a non-image region on the photosensitive drum by an exposure device after the first process and before the second process in the toner supplying operation.

5. The image forming apparatus according to claim 1,
wherein the control portion controls each voltage and an amount of exposure such that an absolute value of a potential difference between a surface potential in the first region and the developing voltage is greater when the first region on the photosensitive drum passes through the developing portion in the toner supplying operation than in the image forming operation.

6. The image forming apparatus according to claim 5,
wherein the control portion controls each voltage such that a potential difference between the surface potential in the first region and the transfer voltage when the first region passes through the transfer portion in the toner supplying operation is greater than a potential difference between the surface potential in the first region and the developing voltage when the first region passes through the developing portion.

7. The image forming apparatus according to claim 1,
wherein the control portion controls each voltage and an amount of exposure such that a potential difference between a surface potential in the first region and the transfer voltage when the first region on the photosensitive drum passes through the transfer portion in the toner supplying operation is greater than a potential difference between the surface potential of the photosensitive drum exposed by an exposure device and the transfer voltage in the image forming operation.

8. The image forming apparatus according to claim 1, further comprising:
a static eliminating device that is disposed on a downstream side of a transfer member and on an upstream side of the charging member in a rotation direction of the photosensitive drum and eliminates static electricity from the surface of the photosensitive drum,
wherein the control portion eliminates static electricity from the first region by the static eliminating device before the first region on the photosensitive drum passes through a charging portion where the charging member charges the photosensitive drum in the toner supplying operation.

9. The image forming apparatus according to claim 1, further comprising:
a disengagement/engagement mechanism that moves the developing member such that the developing member is separated from and abuts on the photosensitive drum,
wherein the disengagement/engagement mechanism causes the developing member to be separated from the photosensitive drum after the first region on the photosensitive drum passes through the developing portion in the toner supplying operation.

10. The image forming apparatus according to claim 1, further comprising:
a regulating member that regulates a thickness of a toner that the developing member bears, the regulating member charging the toner that the developing member bears; and
a regulating voltage application portion that applies a regulating voltage to the regulating member,
wherein the control portion is configured to be able to control the regulating voltage and controls each voltage such that an absolute value of a potential difference between the developing voltage and the regulating voltage is greater when the toner moved from the developing member to the photosensitive drum by the regulating member is charged in the toner supplying operation than in the image forming operation.

11. The image forming apparatus according to claim 10,
wherein the control portion controls each voltage such that the absolute value of the potential difference between the developing voltage and the regulating voltage gradually increases in the toner supplying operation.

12. The image forming apparatus according to claim 11,
wherein the developing member is configured to be rotatable, and
wherein the control portion controls each voltage such that the absolute value of the potential difference between the developing voltage and the regulating voltage gradually increases in accordance with an increase in a rotation distance of the developing member in the toner supplying operation.

13. The image forming apparatus according to claim 1,
wherein the developing member is configured to be rotatable, and
wherein the control portion is configured to be able to control rotation speeds of the photosensitive drum and the developing member and controls each rotation speed such that a ratio of the rotation speed of the developing member to the rotation speed of the photosensitive drum is greater when the toner is moved from the developing member to the photosensitive drum in the toner supplying operation than in the image forming operation.

14. The image forming apparatus according to claim 1, further comprising:
a supply member that supplies the toner to the developing member, the supply member charging the toner that the developing member bears; and
a supply voltage application portion that applies a supply voltage to the supply member,
wherein the control portion is configured to be able to control the supply voltage and controls each voltage such that an absolute value of a potential difference between the supply voltage and the developing voltage is greater when the toner moved from the developing member to the photosensitive drum by the supply member is charged in the toner supplying operation than in the image forming operation.

15. The image forming apparatus according to claim 14,
wherein the control portion controls each voltage such that the absolute value of the potential difference between the supply voltage and the developing voltage gradually increases in the toner supplying operation.

16. The image forming apparatus according to claim 15,
wherein the developing member is configured to be rotatable, and
wherein the control portion controls each voltage such that the absolute value of the potential difference between the supply voltage and the developing voltage gradually increases in accordance with an increase in a rotation distance of the developing member in the toner supplying operation.

17. The image forming apparatus according to claim 14,
wherein the control portion controls each voltage such that the absolute value of the potential difference between the supply voltage and the developing voltage becomes smaller before the toner supplying operation starts than in the image forming operation.

18. The image forming apparatus according to claim 1, further comprising:
a regulating member that regulates a thickness of a toner that the developing member bears, the regulating member charging the toner that the developing member bears; and
a regulating voltage application portion that applies a regulating voltage to the regulating member,
wherein the control portion is configured to be able to control the regulating voltage and controls each voltage and an amount of exposure such that an absolute value of a potential difference between the regulating voltage and the developing voltage becomes smaller when the first region on the photosensitive drum passes through the developing portion in the toner supplying operation than in the image forming operation.

19. The image forming apparatus according to claim 1, further comprising:
a regulating member that regulates a thickness of a toner that the developing member bears, the regulating member charging the toner that the developing member bears; and
a regulating voltage application portion that applies a regulating voltage to the regulating member,
wherein the control portion is configured to be able to control the regulating voltage and controls each voltage and an amount of exposure such that an absolute value of a potential difference between the regulating voltage and the developing voltage becomes smaller when the first region on the photosensitive drum passes through the developing portion in the toner supplying operation than when the toner moved from the developing member to the photosensitive drum is charged by the regulating member.

20. The image forming apparatus according to claim 1,
wherein the developing member is configured to be rotatable, and
wherein the control portion is configured to be able to control rotation speeds of the photosensitive drum and the developing member and controls each rotation speed such that a ratio of the rotation speed of the developing member to the rotation speed of the photosensitive drum is greater when the first region on the photosensitive drum passes through the developing member in the toner supplying operation than in the image forming operation.

21. The image forming apparatus according to claim 1, further comprising:
a supply member that supplies the toner to the developing member, the supply member charging the toner that the developing member bears; and
a supply voltage application portion that applies a supply voltage to the supply member,
wherein the control portion is configured to be able to control the supply voltage and controls each voltage such that an absolute value of a potential difference between the supply voltage and the developing voltage becomes smaller when the first region on the photosensitive drum passes through the developing portion in the toner supplying operation than in the image forming operation.

22. The image forming apparatus according to claim 1,
wherein the control portion controls each voltage such that the toner remaining in the first region is recharged by a charging member after the first region on the photosensitive drum passes through the transfer portion twice in the toner supplying operation.

23. The image forming apparatus according to claim 22,
wherein the control portion controls the charging voltage and the transfer voltage such that the toner remaining in the first region and recharged is moved to the intermediate transfer member after the first region passes through the transfer portion twice in the toner supplying operation.

24. The image forming apparatus according to claim 22,
wherein the control portion controls each voltage such that an absolute value of a potential difference between a surface potential in the first region and the transfer voltage is greater at any of timings at which the first region passes through the transfer portion when the first region passes through the transfer portion for third times or later than when the first region passes through the transfer portion for a second time in the toner supplying operation.

25. The image forming apparatus according to claim 22,
wherein the control portion controls each voltage such that the potential difference between a surface potential in the first region and the charging voltage is greater when the first region passes through a charging portion where the charging member charges the photosensitive drum again than when the first region passes through the charging portion for a first time in the toner supplying operation.

26. The image forming apparatus according to claim 24,
wherein the image forming apparatus includes a plurality of image forming portions each including the photosensitive drum, the charging member, the developing member, and a transfer member, and
wherein each voltage is controlled such that an absolute value of a potential difference between a surface potential in the first region and the transfer voltage becomes smaller when the first region of a second image forming portion passes through the transfer portion for the third time than in the image forming operation in a case where a first image forming portion executes the toner supplying operation and the second image forming portion does not execute the toner supplying operation from among the plurality of image forming portions.

27. The image forming apparatus according to claim 1,
wherein the intermediate transfer member is configured to be rotatable, and
wherein the control portion is configured to be able to control a rotation speed of the intermediate transfer member and controls the rotation speed such that a speed difference between the photosensitive drum and the intermediate transfer member is greater when the first region on the photosensitive drum passes through the transfer portion for a third time than when the first region passes through the transfer portion for a second time in the toner supplying operation.

28. The image forming apparatus according to claim 1, further comprising:
a printing rate acquisition portion that divides a region of the developing member corresponding to a recording material into a plurality of regions in a longitudinal direction of the developing member and acquires an average printing rate in each of the plurality of regions on the basis of a printing history in the image forming operation,
wherein in the toner supplying operation, an amount of toner to be moved from the developing member to the photosensitive drum in each of the plurality of regions is determined on the basis of the average printing rate.

29. The image forming apparatus according to claim 1, further comprising:
a developing unit that includes the developing member and a toner accommodating portion that accommodates the toner; and
an interval determination portion that determines an execution interval of the toner supplying operation on the basis of an indicator indicating a degree of degradation of the toner accommodated in the toner accommodating portion, the interval determination portion narrowing the execution interval with a progress of the degradation of the toner.

30. The image forming apparatus according to claim 29,
wherein the indicator indicating the degree of degradation of the toner is a number of recording materials on which the image forming operation has been performed.

31. The image forming apparatus according to claim 29,
wherein the indicator indicating the degree of degradation of the toner is a drive time of the developing member.

32. The image forming apparatus according to claim 29,
wherein the indicator indicating the degree of degradation of the toner is an amount of toner that has been consumed by the developing unit.

33. The image forming apparatus according to claim 1,
wherein in a case where an execution timing of the toner supplying operation is reached during execution of a print job including a plurality of image forming operation commands, the control portion interrupts the print job and starts the toner supplying operation.

34. The image forming apparatus according to claim 1,
wherein in a case where an execution timing of the toner supplying operation is reached during execution of a print job including a plurality of image forming operation commands, the control portion starts the toner supplying operation after the print job is completed.

35. The image forming apparatus according to claim 1,
wherein the image forming apparatus includes a plurality of the developing members, and
wherein in a case where an execution timing of the toner supplying operation is reached for any of the plurality of developing members, the control portion executes the toner supplying operation for all of the developing members.

36. The image forming apparatus according to claim 1,
wherein the image forming apparatus includes a plurality of the developing members, and
wherein in a case where an execution timing of the toner supplying operation is reached for any of the plurality of developing members, the control portion executes the toner supplying operation only for the developing member that has reached the execution timing.

37. The image forming apparatus according to claim 1, further comprising:
a developing unit that includes the developing member and a toner accommodating portion that accommodates the toner,
wherein the control portion increases an absolute value of a potential difference between a surface potential of the photosensitive drum and the transfer voltage when the toner that has not been collected by the developing member and has been supplied to the photosensitive drum is moved to the intermediate transfer member with a progress of a degree of degradation of the toner accommodated in the toner accommodating portion in the toner supplying operation.

38. The image forming apparatus according to claim 37,
wherein the control portion increases the absolute value of the potential difference by changing the transfer voltage.

39. The image forming apparatus according to claim 1, further comprising:
a removing device that removes the toner moved to the intermediate transfer member from the intermediate transfer member.

40. The image forming apparatus according to claim 1, further comprising:
a detecting portion that detects a lifetime or a use time of at least one of the photosensitive drum, the charging member, and the developing member,
wherein the control portion executes the toner supplying operation on the basis of a result of the detection by the detecting portion.

41. The image forming apparatus according to claim 1,
wherein the control portion executes the toner supplying operation after the image forming operation ends.

42. The image forming apparatus according to claim 1,
wherein the control portion executes the toner supplying operation when the image forming operation is not being performed.

43. An image forming apparatus comprising:
a rotatable photosensitive drum;
a charging member that charges a surface of the photosensitive drum;
a charging voltage application portion that applies a charging voltage to the charging member;
an exposure device that exposes the surface of the photosensitive drum and forms an electrostatic latent image thereon;
a developing member that comes into contact with the photosensitive drum to form a developing portion and supplies, by the developing portion, a toner charged with a normal polarity to the surface of the photosensitive drum charged by the charging member;
a developing voltage application portion that applies a developing voltage to the developing member;
an intermediate transfer member that comes into contact with the photosensitive drum to form a transfer portion, the toner supplied to the surface of the photosensitive drum being transferred to the intermediate transfer member by the transfer portion;
a transfer member that comes into contact with the intermediate transfer member;
a transfer voltage application portion that applies a transfer voltage to the transfer member; and
a control portion that controls the charging voltage, an amount of exposure of the exposure device, the developing voltage, and the transfer voltage, the control portion being configured to be able to execute i) an image forming operation of forming an image on a recording material, and ii) a toner supplying operation in which toner is supplied from the developing member to the photosensitive drum such that, when a first region of the photosensitive drum to which toner has been supplied passes through a transfer portion, which is an abutting portion between the photosensitive drum and the intermediate transfer member, for a first time, a part of the toner supplied is moved to the intermediate transfer member, another part of the toner remains in the first region, and, when the residual toner passes through the transfer portion again, the residual toner is moved to the intermediate transfer member.

44. The image forming apparatus according to claim 43,
wherein the control portion controls each voltage and the amount of exposure to cause a toner with a polarity opposite to a normal charge polarity in the first region to move to the intermediate transfer member when the first region passes through the transfer portion for the first time, cause the photosensitive drum to hold the toner with the normal charge polarity in the first region, and cause the toner with the normal charge polarity to move to the intermediate transfer member when the toner with the normal charge polarity passes through the transfer portion again.

45. The image forming apparatus according to claim 43,
wherein the control portion exposes a non-image region on the photosensitive drum by the exposure device after the toner supplied to the photosensitive drum passes through the transfer portion for the first time and before the toner passes through a developing portion, which is an abutting portion between the photosensitive drum and the developing member, in the toner supplying operation.

46. The image forming apparatus according to claim 43,
wherein the control portion controls each voltage and the amount of exposure such that an absolute value of a potential difference between a surface potential of the photosensitive drum and the developing voltage is greater when the developing member supplies the toner to the photosensitive drum in the toner supplying operation than in the image forming operation.

47. The image forming apparatus according to claim 43,
wherein the control portion controls each voltage and the amount of exposure such that an absolute value of a potential difference between a surface potential in the first region and the transfer voltage is greater when the first region on the photosensitive drum passes through a transfer portion, which is an abutting portion between the photosensitive drum and the intermediate transfer member, in the toner supplying operation than in the image forming operation.

48. The image forming apparatus according to claim 43, further comprising:
a static eliminating device that is disposed on a downstream side of the transfer member and on an upstream side of the charging member in a rotation direction of the photosensitive drum and eliminates static electricity from the surface of the photosensitive drum,
wherein the control portion eliminates static electricity from the first region by the static eliminating device before the first region on the photosensitive drum passes through a charging portion where the charging member charges the photosensitive drum in the toner supplying operation.

49. The image forming apparatus according to claim 43,
wherein the control portion controls each voltage and the amount of exposure such that a potential difference between a surface potential in the first region and the transfer voltage when the residual toner passes through the transfer portion again in the toner supplying operation is greater than a potential difference between a surface potential of the photosensitive drum exposed by the exposure device and the transfer voltage in the image forming operation.

50. The image forming apparatus according to claim 43,
wherein the control portion controls each voltage and the amount of exposure to cause a toner with a normal charge polarity in the first region to move to the intermediate transfer member when the first region passes through the transfer portion for the first time, cause the photosensitive drum to hold the toner with a polarity opposite to the normal charge polarity in the first region, and cause the toner with the opposite polarity to move to the intermediate transfer member when the toner with the opposite polarity passes through the transfer portion again.

51. The image forming apparatus according to claim 50,
wherein the control portion controls the charging voltage to capture the toner with the opposite polarity in the first region by the charging member in the toner supplying operation.

52. The image forming apparatus according to claim 50, further comprising:
a capturing member that is disposed on an upstream side of the charging member and on a downstream side of the transfer member in a rotation direction of the photosensitive drum, the capturing member coming into contact with the photosensitive drum, charging the photosensitive drum, and temporarily capturing the toner in the first region,
wherein the control portion controls a voltage to be applied to the capturing member.

53. The image forming apparatus according to claim 43,
wherein the developing member is configured to be rotatable, and
wherein the control portion is configured to be able to control rotation speeds of the photosensitive drum and the developing member and controls each rotation speed such that a ratio of the rotation speed of the developing member to the rotation speed of the photosensitive drum is greater in the toner supplying operation than in the image forming operation.

54. The image forming apparatus according to claim 43, further comprising:
a supply member that supplies the toner to the developing member, the supply member charging the toner that the developing member bears; and
a supply voltage application portion that applies a supply voltage to the supply member,
wherein the control portion is configured to be able to control the supply voltage and controls each voltage such that an absolute value of a potential difference between the supply voltage and the developing voltage is greater when the toner moved from the developing member to the photosensitive drum by the supply member is charged in the toner supplying operation than in the image forming operation.

55. An image forming apparatus comprising:
a photosensitive drum;
a charging member that charges a surface of the photosensitive drum;
an exposure device that exposes the surface of the photosensitive drum and forms an electrostatic latent image thereon;
a developing member that comes into contact with the photosensitive drum to form a developing portion and supplies, by the developing portion, a toner charged with a normal polarity to the surface of the photosensitive drum charged by the charging member;
an intermediate transfer member that comes into contact with the photosensitive drum to form a transfer portion, the toner supplied to the surface of the photosensitive drum being transferred to the intermediate transfer member by the transfer portion;
a control portion that controls a surface potential of the photosensitive drum, the control portion being configured to be able to execute i) an image forming operation of transferring a toner image from the photosensitive drum to the intermediate transfer member and ii) a toner supplying operation of supplying a toner from the developing member to the photosensitive drum, collecting a part of the supplied toner by the developing member, and moving a part of the toner to the intermediate transfer member; and
a consumption amount acquisition portion being configured to be able to acquire an amount of consumed toner in the toner supplying operation on the basis of a value related to an amount of toner supplied from the developing member to the photosensitive drum in the toner supplying operation and a correction coefficient related to an amount of toner collected by the developing member in the toner supplying operation.

56. The image forming apparatus according to claim 55,
wherein the correction coefficient is a proportion of the amount of toner collected by the developing member with respect to the amount of toner supplied from the developing member to the photosensitive drum in the toner supplying operation, and
wherein the consumption amount acquisition portion acquires the amount of consumed toner by multiplying the value related to the amount of toner by the correction coefficient.

57. The image forming apparatus according to claim 55,
wherein the correction coefficient is a fixed value determined in advance.

58. The image forming apparatus according to claim 55,
wherein the correction coefficient is determined on the basis of information related to how the toner has been degraded.

59. The image forming apparatus according to claim 58,
wherein the information related to how the toner has been degraded is temperature information of an environment where the image forming apparatus is installed.

60. The image forming apparatus according to claim 58,
wherein the information related to how the toner has been degraded is a rotation distance of the developing member.

61. The image forming apparatus according to claim 58,
wherein the information related to how the toner has been degraded is an amount of saturated water vapor determined on the basis of temperature information and humidity information of an environment where the image forming apparatus is installed.

62. The image forming apparatus according to claim 58,
wherein the information related to how the toner has been degraded is an average printing rate in the image forming operation.

63. The image forming apparatus according to claim 55, further comprising:
a cartridge that is configured of the photosensitive drum, the charging member, and the developing member; and
a cartridge information storage portion that is mounted on the cartridge and stores specific information of the cartridge,
wherein the correction coefficient is determined on the basis of a value stored in the cartridge information storage portion.

64. The image forming apparatus according to claim 63,
wherein the control portion acquires an amount of residual toner stored in the cartridge on the basis of the amount of consumption acquired by the consumption amount acquisition portion.

65. The image forming apparatus according to claim 55, further comprising:
a transfer member that comes into contact with the intermediate transfer member,
wherein the control portion controls a surface potential of the photosensitive drum by controlling a charging voltage to be applied to the charging member, an amount of exposure of the exposure device, a developing voltage to be applied to the developing member, and a transfer voltage to be applied to the transfer member.

66. The image forming apparatus according to claim 65,
wherein in the toner supplying operation, the control portion
(i) performs control such that when the toner supplied to the photosensitive drum passes through a transfer portion, which is an abutting portion between the photosensitive drum and the intermediate transfer member, for a first time, a value of the transfer voltage is negative and an absolute value of the transfer voltage is greater than an absolute value of a surface potential of the photosensitive drum,
(ii) performs control such that the value of the transfer voltage is positive when the toner remaining on the surface of the photosensitive drum passes through the transfer portion again.
